(19) United States
(12) Patent Application Publication
(10) Pub. No.: US 2026/0255090 A1
(43) Pub. Date: Aug. 27, 2026

(54) WAVELENGTH DIVISION MULTIPLEXING (WDM) LANE SHUFFLING IN A NETWORK

(71) Applicant: Mellanox Technologies, Ltd., Yokneam (IL)

(72) Inventors: Paraskevas Bakopoulos, Argiroupoli (GR); Ioannis Patronas, Pireas (GR); Elad Mentovich, Tel Aviv (IL); Barak Gafni, Sunnyvale, CA (US); Eitan Zahavi, Zichron Yaakov (IL); Petr Lapukhov, New York, NY (US)

(21) Appl. No.: 19/082,023

(22) Filed: Mar. 17, 2025

(30) Foreign Application Priority Data
Feb. 26, 2025 (GR) 20250100151

(51) Int. Cl. H04Q 11/00; G02B 6/38; H04J 14/02; H04Q 1/02

(52) U.S. Cl. CPC H04Q 11/0005; G02B 6/3885; H04Q 1/155; H04J 14/023; H04Q 2011/0007

(57) ABSTRACT

A device comprises optical input ports to receive optical data signals via respective optical fibers, each optical data signal having a distinct wavelength. The device comprises optical routing components that connect the optical inputs to multiplexers, wherein each multiplexer is to receive an optical data signal originating from each of a first layer of network elements. The multiplexers are to combine optical data signals received by respective multiplexers into respective multiplexed optical data signals. The device comprises optical output ports connected to a respective multiplexer, to send a multiplexed optical data signal to a respective network element of a second layer of network elements.

### RELATED APPLICATION

This application claims the benefit of Greek Application No. 20250100151, filed Feb. 26, 2025, the entire contents of which are hereby incorporated by reference.

### TECHNICAL FIELD

At least one embodiment pertains to network management. In particular, aspects and implementations of the present disclosure relate to a wavelength division multiplexing (WDM) lane shuffling in a network.

### BACKGROUND

The number of servers connected within a datacenter is growing rapidly. These datacenters can be organized in a hierarchical structure resembling a tree with multiple network layers. As the datacenter scales, new network layers are added to increase the number of ports available to connect to servers of the datacenter.

### SUMMARY

In embodiments, a device comprising: a plurality of optical input ports to receive a plurality of optical data signals via a respective plurality of optical fibers, each optical data signal of the plurality of optical data signals having a distinct wavelength; a plurality of optical routing components that connect the plurality of optical input ports to a plurality of wavelength multiplexers, wherein the plurality of optical routing components are to distribute the plurality of optical data signals to the plurality of wavelength multiplexers, wherein each multiplexer of the plurality of wavelength multiplexers is to receive an optical data signal originating from each of a first plurality of network elements; the plurality of wavelength multiplexers, wherein each multiplexer of the plurality of wavelength multiplexers is to combine optical data signals received by the multiplexer into a multiplexed optical data signal, wherein a plurality of multiplexed optical data signals are to be generated; and a plurality of optical output ports, each connected to a multiplexer of the plurality of wavelength multiplexers, to send a multiplexed optical data signal of the plurality of multiplexed optical data signals to a respective network element of a second plurality of network elements. In some embodiments, the device is an optical shuffle box. In some embodiments the plurality of optical data signals are not multiplexed. In some embodiments, the device further includes a second plurality of optical input ports to receive a respective second plurality of optical data signals, each optical data signal of the second plurality of optical data signals having a distinct wavelength; a second plurality of optical routing components that connect the second plurality of optical input ports to a second plurality of multiplexers, wherein the second plurality of optical routing components are to distribute the second plurality of optical data signals to the second plurality of multiplexers, wherein each multiplexer of the second plurality of multiplexers is to receive an optical data signal originating from each of the second plurality of network elements; the second plurality of multiplexers, wherein each multiplexer of the second plurality of multiplexers is to combine optical data signals received by the multiplexer into a multiplexed optical data signal, wherein a second plurality of multiplexed optical data signals are to be generated; and a second plurality of optical output ports, each connected to a multiplexer of the second plurality of multiplexers, to send a multiplexed optical data signal of the second plurality of multiplexed optical data signals to a respective network element of the first plurality of network elements. In some embodiments the device is configured to receive a second plurality of multiplexed optical data signals at the plurality of optical output ports, the optical output ports each configured to send the second plurality of multiplexed optical data signals to the plurality of multiplexers, wherein each multiplexer of the plurality of multiplexers is to separate multiplexed optical data signals received at the multiplexer into a second plurality of optical data signals, each optical data signal of the second plurality of optical data signals having a different wavelength; and the plurality of optical routing components, wherein the plurality of optical routing components are to distribute the second plurality of optical data signals to the plurality of optical input ports, wherein a group of optical input ports corresponding to a respective network element of the first plurality of network elements is to receive optical data signals of the second plurality of optical data signals having distinct wavelengths.

In embodiments, a network architecture comprising: a first network layer comprising a first plurality of network devices; a second network layer comprising a second plurality of network devices; and an optical shuffle box that connects the first network layer to the second network layer, the optical shuffle box configured to: receive, from each network device of the first plurality of network devices, a plurality of optical data signals via a respective plurality of optical fibers, each optical data signal of the plurality of optical data signals having a distinct wavelength; distribute the plurality of optical data signals received from the plurality of network devices to a plurality of multiplexers of the optical shuffle box, wherein each multiplexer of the plurality of multiplexers is to receive an optical data signal originating from each of the first plurality of network devices; combine, at each multiplexer of the plurality of multiplexers, optical data signals received by the multiplexer into a multiplexed optical data signal, wherein a plurality of multiplexed optical data signals are to be generated; and send each multiplexed optical data signal of the plurality of multiplexed optical data signals to a respective network device of the second plurality of network devices. In some embodiments the second plurality of network devices comprise a plurality of optical network devices. In some embodiments, the second plurality of network devices comprise a plurality of electrical network devices. In some embodiments, the first network layer is a first switching layer, and wherein the second network layer is a second switching layer. In some embodiments, the second network layer is connected to a third network layer by a second optical shuffle box, the third network layer comprising a third plurality of network devices. In some embodiments the network architecture further comprising: one or more optical transceivers coupled to each network device of the first plurality of network devices, each optical transceiver of the one or more optical transceivers comprising: a transmitter to convert a first plurality of electrical data signals into the plurality of optical data signals; a plurality of optical output ports, each optical output of the plurality of optical output ports to output, to a respective optical fiber of the respective plurality of optical fibers, an optical data signal of the plurality of optical data signals having the distinct wavelength; an optical input to receive, from the optical shuffle box via a single optical fiber, a second plurality of optical data signals having a plurality of different wavelengths that are multiplexed; a demultiplexer to separate the second plurality of optical data signals; and a receiver to convert the separated second plurality of optical data signals into a second plurality of electrical data signals. In some embodiments, the transmitter of the network architecture comprises a plurality of light sources configured to generate the first plurality of optical data signals; and the receiver comprises a plurality of photodetectors configured to detect the second plurality of optical data signals. In some embodiments, the network architecture further comprising: one or more additional optical transceivers coupled to each network device of the second plurality of network devices, each optical transceiver of the one or more additional optical transceivers comprising: an optical input to receive, from the optical shuffle box via a single optical fiber, a multiplexed optical data signal of the plurality of multiplexed optical data signals; a demultiplexer to separate the multiplexed optical data signal into a third plurality of optical data signals; a receiver to convert the separated third plurality of optical data signals into a third plurality of electrical data signals; a transmitter to convert a fourth plurality of electrical data signals into a fourth plurality of optical data signals; a second plurality of optical output ports, each optical output of the second plurality of optical output ports to output, to the optical shuffle box via a respective optical fiber, an optical data signal of the fourth plurality of optical data signals. In some embodiments, the optical shuffle box comprises: a plurality of optical input ports to receive a plurality of optical data signals via a respective plurality of optical fibers, each optical data signal of the plurality of optical data signals having a distinct wavelength; a plurality of optical routing components that connect the plurality of optical input ports to a plurality of multiplexers, wherein the plurality of optical routing components are to distribute the plurality of optical data signals to the plurality of multiplexers, wherein each multiplexer of the plurality of multiplexers is to receive an optical data signal originating from each of a first plurality of network devices; the plurality of multiplexers, wherein each multiplexer of the plurality of multiplexers is to combine optical data signals received by the multiplexer into a multiplexed optical data signal, wherein a plurality of multiplexed optical data signals are to be generated; and a plurality of optical output ports, each connected to a multiplexer of the plurality of multiplexers, to send a multiplexed optical data signal of the plurality of multiplexed optical data signals to a respective network device of a second plurality of network devices. In some embodiments, the optical shuffle box further comprises: a second plurality of optical input ports to receive a respective second plurality of optical fibers, each optical data signal of the second plurality of optical data signals having a distinct wavelength; a second plurality of optical routing components that connect the second plurality of optical input ports to a second plurality of multiplexers, wherein the second plurality of optical routing components are to distribute the second plurality of optical data signals to the second plurality of multiplexers, wherein each multiplexer of the second plurality of multiplexers is to receive an optical data signal originating from each of the second plurality of network devices; the second plurality of multiplexers, wherein each multiplexer of the second plurality of multiplexers is to combine optical data signals received by the multiplexer into a multiplexed optical data signal, wherein a second plurality of multiplexed optical data signals are to be generated; and a second plurality of optical output ports, each connected to a multiplexer of the second plurality of multiplexers, to send a multiplexed optical data signal of the second plurality of multiplexed optical data signals to a respective network device of the first plurality of network devices. In some embodiments, the optical shuffle box is configured to receive a second plurality of multiplexed optical data signals at a plurality of optical output ports, the optical output ports each configured to send the second plurality of multiplexed optical data signals to the plurality of multiplexers, wherein each multiplexer of the plurality of multiplexers is to separate multiplexed signals received at the multiplexer into a second plurality of optical data signals, each optical data signal of the second plurality of optical data signals having a different wavelength; and the plurality of optical routing components, wherein the plurality of optical routing components are to distribute the second plurality of optical data signals to the plurality of optical input ports, wherein a group of optical input ports corresponding to a respective network device of the first plurality of network devices is to receive optical data signals of the second plurality of optical data signals having distinct wavelengths.

In embodiments, an optical transceiver comprising: a transmitter to convert a first plurality of electrical data signals into a first plurality of optical data signals; a plurality of optical output ports, each optical output of the plurality of optical output ports to output, to a respective optical fiber, an optical data signal of the first plurality of optical data signal having a distinct wavelength; an optical input to receive, from a single optical fiber, a second plurality of optical data signals having a plurality of different wavelengths that are multiplexed; a demultiplexer to separate the second plurality of optical data signals; and a receiver to convert the separated second plurality of optical data signals into a second plurality of electrical data signals. In some embodiments, the transmitter comprises a plurality of light sources configured to generate the first plurality of optical data signals; and the receiver comprises a plurality of photodetectors configured to detect the second plurality of optical data signals. In some embodiments, the plurality of different wavelengths are multiplexed according to wavelength division multiplexing (WDM), and wherein the demultiplexer is to separate the different wavelengths that are multiplexed according to WDM. In some embodiments, a first number of the first plurality of optical data signals generated by the transmitter is greater than a second number of the second plurality of optical data signals received at the optical input.

In embodiments a transceiver comprising: a transmitter to convert a first plurality of electrical data signals into a first plurality of optical data signals, wherein optical data signals of the first plurality of optical data signals each correspond to respective wavelengths of a plurality of wavelengths; a first optical connector coupled to the transmitter, wherein the first optical connector comprises a first plurality of optical ports and a second plurality of optical ports, wherein each optical port of the first plurality of optical ports is configured to transmit a respective optical data signal of a first subset of the first plurality of optical data signals, wherein each optical port of the second plurality of optical ports is configured to receive a respective optical data signal of a first subset of the second plurality of optical data signals, and wherein optical data signals of the second plurality of optical data signals each correspond to respective wavelengths of the plurality of wavelengths; and a receiver to convert the second plurality of optical data signals into a second plurality of electrical data signals. In some embodiments, the first plurality of optical ports comprises four optical ports; the second plurality of optical ports comprises four optical ports; and each optical data signal in the first subset of the first plurality of optical data signals has a wavelength that corresponds to a wavelength of an optical data signal in the second subset of the first plurality of optical data signals. In some embodiments, the first plurality of optical ports comprises four optical ports; the second plurality of optical ports comprises four optical ports; and each optical data signal in the first subset of the first plurality of optical data signals has a different wavelength from a wavelength of an optical data signal in the second subset of the first plurality of optical data signals. In some embodiments, a second optical connector coupled to the transmitter, wherein the second optical connector comprises a third plurality of optical ports and a fourth plurality of optical ports, wherein each optical port of the third plurality of optical ports is configured to transmit a respective optical data signal of a second subset of the first plurality of optical data signals, wherein each optical port of the fourth plurality of optical ports is configured to receive a respective optical data signal of a second subset of the second plurality of optical data signals. In some embodiments, the first plurality of optical data signals comprises eight optical data signals; and the second plurality of optical data signals comprises eight optical data signals. In some embodiments, the first plurality of optical ports and the second plurality of optical ports of the first optical connector correspond to a first subset of wavelengths of the plurality of wavelengths, and wherein the third plurality of optical ports and the fourth plurality of optical ports of the second optical connector correspond to a second subset of wavelengths of the plurality of wavelengths. In some embodiments, the transmitter comprises a plurality of light sources configured to generate the first plurality of optical data signals; and the receiver comprises a plurality of photodetectors configured to detect the second plurality of optical data signals.

In embodiments, a system comprising: an optical shuffle box; and a transceiver coupled to the optical shuffle box, the transceiver comprising: a transmitter to convert a first plurality of electrical data signals into a first plurality of optical data signals, each optical data signal having a distinct wavelength; a first plurality of optical ports, each optical port of the first plurality of optical ports to output, to a respective optical fiber, an optical data signal of the first plurality of optical data signals; a multiplex optical port to receive, from a single optical fiber, a second plurality of optical data signals having a plurality of different wavelengths that are multiplexed; a demultiplexer to separate the second plurality of optical data signals; and a receiver to convert the separated second plurality of optical data signals into a second plurality of electrical data signals. In some embodiments, the optical shuffle box comprises: a second plurality of optical ports configured to receive the first plurality of optical data signals; a first plurality of multiplexers optically coupled to the second plurality of optical ports, wherein each multiplexer of the first plurality of multiplexers is to receive an optical data signal originating from each of a first plurality of network elements; the first plurality of multiplexers, wherein each multiplexer is to combine optical data signals received by the multiplexer into a multiplexed optical data signal, wherein a first plurality of multiplexed optical data signals are to be generated; and a third plurality of optical ports, each connected to a respective multiplexer of the first plurality of multiplexers to send a multiplexed optical data signal of the first plurality of multiplexed optical data signals to a respective network element of a second plurality of network elements. In some embodiments, multiplexers of the first plurality of multiplexers are wavelength multiplexers. In some embodiments, the optical shuffle box further comprises: a fourth plurality of optical ports configured to receive a third plurality of optical data signals originating from the second plurality of network elements, each optical data signal of the third plurality of optical data signals having a distinct wavelength; a second plurality of multiplexers optically coupled to the fourth plurality of optical ports, wherein each multiplexer of the second plurality of multiplexers is to receive an optical data signal originating from each of the second plurality of network elements; the second plurality of multiplexers, wherein each multiplexer of the second plurality of multiplexers is to combine optical data signals received by the multiplexer into a multiplexed optical data signal, wherein a second plurality of multiplexed optical data signals are to be generated; and a fifth plurality of optical ports, each connected to a multiplexer of the second plurality of multiplexers, to send a multiplexed optical data signal of the second plurality of multiplexed optical data signals to a respective network element of the first plurality of network elements. In some embodiments, the optical shuffle box is configured to receive a second plurality of multiplexed optical data signals at the second plurality of optical ports, the optical ports each configured to send the second plurality of multiplexed optical data signals to the first plurality of multiplexers, wherein each multiplexer of the first plurality of multiplexers is to separate multiplexed signals received at the multiplexer into the second plurality of optical data signals, each optical data signal of the second plurality of optical data signals having a different wavelength, wherein a group of optical ports corresponding to a respective network element of the first plurality of network elements is to receive optical data signals of the second plurality of optical data signals having distinct wavelengths. In some embodiments, the transmitter comprises a plurality of light sources configured to generate the first plurality of optical data signals; and the receiver comprises a plurality of photodetectors configured to detect the second plurality of optical data signals. In some embodiments, the system further comprising: one or more additional optical transceivers coupled to the optical shuffle box, each optical transceiver of the one or more additional optical transceivers comprising: a respective first plurality of optical ports, each optical port of the respective first plurality of optical ports configured to receive, from the optical shuffle box via a respective optical fiber, an optical data signal of a third plurality of optical data signals having a distinct wavelength; a receiver to convert the third plurality of optical data signals into a third plurality of electrical data signals; a transmitter to convert a fourth plurality of electrical data signals into a fourth plurality of optical data signals having a distinct wavelength; and a respective second plurality of optical ports, each optical port of the respective second plurality of optical ports to output, to the optical shuffle box via a respective optical fiber, an optical data signal of the fourth plurality of optical data signals. In some embodiments, the system further comprising: a first network layer comprising a first plurality of network devices, the first plurality of network devices comprising the transceiver; and a second network layer comprising a second plurality of network devices, wherein the optical shuffle box connects the first network layer to the second network layer.

In embodiments, a system comprising: a first optical shuffle box; and a transceiver coupled to the optical shuffle box, the transceiver comprising: a transmitter to convert a first plurality of electrical data signals into a first plurality of optical data signals, wherein optical data signals of the first plurality of optical data signals each correspond to respective wavelengths of a plurality of wavelengths; a first optical connector coupled to the transmitter, wherein the first optical connector comprises a first plurality of optical ports and a second plurality of optical ports, wherein each optical port of the first plurality of optical ports is configured to transmit a respective optical data signal of a first subset of the first plurality of optical data signals, wherein each optical port of the second plurality of optical ports is configured to receive a respective optical data signal of a first subset of the second plurality of optical data signals, and wherein optical data signals of the second plurality of optical data signals each correspond to respective wavelengths of the plurality of wavelengths; and a receiver to convert the second plurality of optical data signals into a second plurality of electrical data signals. In some embodiments, the first plurality of optical ports comprises four optical ports; the second plurality of optical ports comprises four optical ports; and each optical data signal in the first subset of the first plurality of optical data signals has a wavelength that corresponds to a wavelength of an optical data signal in the second subset of the first plurality of optical data signals. In some embodiments, the first plurality of optical ports comprises four optical ports; the second plurality of optical ports comprises four optical ports; and each optical data signal in the first subset of the first plurality of optical data signals has a different wavelength from a wavelength of an optical data signal in the second subset of the first plurality of optical data signals. In some embodiments, the first optical shuffle box comprising: a third plurality of optical ports configured to receive the first plurality of optical data signals; a first multiplexer coupled to the third plurality of optical ports, wherein the first multiplexer is to combine the first plurality of optical data signals into a multiplexed optical data signal; and a second multiplexer coupled to a fourth plurality of optical ports, wherein the second multiplexer is to separate the multiplexed optical data signal received at the second multiplexer from the first multiplexer into the second plurality of optical data signals, and the fourth plurality of optical ports configured to output the second plurality of optical data signals. In some embodiments, the system further comprising: a second optical connector coupled to the transmitter, wherein the second optical connector comprises a third plurality of optical ports and a fourth plurality of optical ports, wherein each optical port of the third plurality of optical ports is configured to transmit a respective optical data signal of a second subset of the first plurality of optical data signals, wherein each optical port of the fourth plurality of optical ports is configured to receive a respective optical data signal of a second subset of the second plurality of optical data signals. In some embodiments, the first optical shuffle box comprising: a third plurality of optical ports configured to receive the first plurality of optical data signals; a first multiplexer coupled to the third plurality of optical ports wherein the first multiplexer is to combine the first plurality of optical data signals into a first multiplexed optical data signal; a second multiplexer coupled to a fourth plurality of optical ports, wherein the second multiplexer is to separate the first multiplexed optical data signal received at the second multiplexer from the first multiplexer into the second plurality of optical data signals, and the fourth plurality of optical ports configured to output the second plurality of optical data signals; a fifth plurality of optical ports configured to receive the second subset of the first plurality of optical data signals, the fifth plurality of optical ports coupled to the second multiplexer, wherein the second multiplexer is to combine the second subset of the first plurality of optical data signals into a second multiplexed optical data signal; and a sixth plurality of optical ports configured to output the second subset of the second plurality of optical data signals, the fourth plurality of optical ports coupled to the first multiplexer, wherein the first multiplexer is to separate the second multiplexed optical signal received at the first multiplexer from the second multiplexer into the second subset of the second plurality of optical data signals. In some embodiments, the system further comprising a second optical shuffle box, wherein the first optical shuffle box comprises: a third plurality of optical ports configured to receive the first plurality of optical data signals; a first multiplexer coupled to the third plurality of optical ports wherein the first multiplexer is to combine the first plurality of optical data signals into a first multiplexed optical data signal; a fourth plurality of optical ports configured to output the second subset of the second plurality of optical data signals, the fourth plurality of optical ports coupled to the first multiplexer, wherein the first multiplexer is to separate a second multiplexed optical signal into the second subset of the second plurality of optical data signals; the second optical shuffle box comprising: a fifth plurality of optical ports configured to receive the second subset of the first plurality of optical data signals; a second multiplexer coupled to the fifth plurality of optical ports, wherein the second multiplexer is to combine the second subset of the first plurality of optical data signals into the second multiplexed optical data signal; and a sixth plurality of optical ports configured to output the second plurality of optical data signals, the sixth plurality of optical ports coupled to the second multiplexer, wherein the second multiplexer is to separate the first multiplexed optical signal into the second plurality of optical data signals. In some embodiments, the system further comprising an optical switch coupled to the first optical shuffle box and the second optical shuffle box, the optical switch coupled to the first optical shuffle box to receive the first multiplexed optical signal from the first optical shuffle box and output the first multiplexed optical signal to the second optical shuffle box, and the optical switch coupled to the second optical shuffle box to receive the second multiplexed optical signal from the second optical shuffle box and output the second multiplexed optical signal to the first optical shuffle box. In some embodiments, the first plurality of optical data signals comprises eight optical data signals; and the second plurality of optical data signals comprises eight optical data signals, wherein the first plurality of optical ports and the second plurality of optical ports of the first optical connector correspond to a first subset of wavelengths of the plurality of wavelengths, and wherein the third plurality of optical ports and the fourth plurality of optical ports of the second optical connector correspond to a second subset of wavelengths of the plurality of wavelengths. In some embodiments, the first optical shuffle box comprising: a third plurality of optical ports configured to receive the first plurality of optical data signals; a first plurality of multiplexers coupled to the third plurality of optical ports to receive the first plurality of optical data signals, wherein each multiplexer of the first plurality of multiplexers is to combine optical data signals received by the multiplexer into a multiplexed optical data signal, wherein a first plurality of multiplexed optical data signals are to be generated; and a fourth plurality of optical ports, each connected to a multiplexer of the first plurality of multiplexers, to send a multiplexed optical data signal of the first plurality of multiplexed optical data signals to a respective network element of a first plurality of network elements. In some embodiments, the first optical shuffle box further comprising: a fifth plurality of optical ports configured to receive the second plurality of optical data signals; a second plurality of multiplexers coupled to the fifth plurality of optical ports to receive the second plurality of optical data signals, wherein each multiplexer of the second plurality of multiplexers is to receive an optical data signal originating from each of the first plurality of network elements, and wherein each multiplexer of the second plurality of multiplexers is to combine optical data signals received by the multiplexer into a multiplexed optical data signal, wherein a second plurality of multiplexed optical data signals are to be generated; and a sixth plurality of optical ports, each connected to a multiplexer of the second plurality of multiplexers, to send a multiplexed optical data signal of the second plurality of multiplexed optical data signals to a respective network element of a second plurality of network elements. In some embodiments, the second plurality of network elements comprises the transceiver. In some embodiments, the optical shuffle box configured to receive a second plurality of multiplexed optical data signals at the fourth plurality of optical ports, the optical ports each configured to output the second plurality of multiplexed optical data signals to the first plurality of multiplexers, wherein each multiplexer of the first plurality of multiplexers is to separate multiplexed signals received at the multiplexer into the second plurality of optical data signals, and wherein a group of optical ports corresponding to a respective network element of the first plurality of network elements is to receive optical data signals of the second plurality of optical data signals. In some embodiments, the system further comprising: a first network layer comprising a first plurality of network devices, the first plurality of network devices comprising the transceiver; and a second network layer comprising a second plurality of network devices, wherein the optical shuffle box connects the first network layer to the second network layer.

In embodiments, a system comprising: a first plurality of network elements; a bi-directional optical transceiver coupled to a network element of the first plurality of network elements and comprising a first plurality of optical ports and a circulator, wherein the circulator enables each optical port of the first plurality of optical ports to both transmit and receive optical data signals; and an optical shuffle box comprising: a second plurality of optical ports configured to receive a first plurality of optical data signals from the first plurality of optical ports of the bi-directional optical transceiver, each optical data signal of the first plurality of optical data signals having a distinct wavelength; a first plurality of multiplexers optically coupled to the second plurality of optical ports of the optical shuffle box, wherein each multiplexer of the first plurality of multiplexers is to combine optical data signals received by the multiplexer into a multiplexed optical data signal, wherein a first plurality of multiplexed optical data signals are to be generated; and a third plurality of optical ports, each connected to a multiplexer of the first plurality of multiplexers, to output a multiplexed optical data signal of the first plurality of multiplexed optical data signals. In some embodiments, multiplexers of the first plurality of multiplexers are wavelength multiplexers. In some embodiments, the optical shuffle box comprises: a fourth plurality of optical ports configured to receive the first plurality of optical data signals; a first plurality of multiplexers optically coupled to the fourth plurality of optical ports, wherein each multiplexer of the first plurality of multiplexers is configured to combine optical data signals received by the multiplexer into a multiplexed optical data signal, wherein a plurality of multiplexed optical data signals are to be generated; and a fifth plurality of optical ports, each connected to a multiplexer of the first plurality of multiplexers, to output a multiplexed optical data signal of the first plurality of multiplexed optical data signals. In some embodiments, the optical shuffle box further comprises: a sixth plurality of optical ports, configured to receive a second plurality of optical data signals; a second plurality of multiplexers optically coupled to the sixth plurality of optical ports, wherein each multiplexer of the second plurality of multiplexers is configured to combine optical data signals received by the multiplexer into a multiplexed optical data signal, wherein a second plurality of multiplexed optical data signals are to be generated; and a seventh plurality of optical ports, each connected to a multiplexer of the second plurality of multiplexers, to output a multiplexed optical data signal of the second plurality of multiplexed optical data signals. In some embodiments, the optical shuffle box is configured to receive a second plurality of multiplexed optical data signals at the fifth plurality of optical ports, the optical ports each configured to send the second plurality of multiplexed optical data signals to the first plurality of multiplexers, wherein each multiplexer of the first plurality of multiplexers is to separate multiplexed signals received at the multiplexer into the second plurality of optical data signals, and wherein a group of optical ports corresponding to a respective network element of the first plurality of network elements is to receive optical data signals of the second plurality of optical data signals having distinct wavelengths. In some embodiments, the system further comprising: a first network layer comprising a first plurality of network devices, the first plurality of network devices comprising the transceiver; and a second network layer comprising a second plurality of network devices, wherein the optical shuffle box connects the first network layer to the second network layer.

In embodiments, a device comprising: a plurality of optical input ports to receive a plurality of multiplexed optical data signals via a respective plurality of optical fibers; a plurality of optical routing components that connect the plurality of optical input ports to a plurality of wavelength demultiplexers, wherein the plurality of optical routing components are to distribute the plurality of multiplexed optical data signals to the plurality of wavelength demultiplexers, wherein each demultiplexer of the plurality of wavelength demultiplexers is to receive a multiplexed optical data signal originating from each of a first plurality of network elements; the plurality of wavelength demultiplexers, wherein each demultiplexer of the plurality of wavelength demultiplexers is to separate multiplexed optical data signals received at the demultiplexer into a plurality of optical data signals, each optical data signal of the plurality of optical data signals having a distinct wavelength; and a plurality of optical output ports connected to a demultiplexer of the plurality of wavelength demultiplexers, each optical output port to output a respective optical data signal of the plurality of optical data signals to a network element of a second plurality of network elements. In some embodiments, the device is an optical shuffle box. In some embodiments, the device further comprising: a second plurality of optical input ports to receive a respective second plurality of multiplexed optical data signals; a second plurality of optical routing components that connect the second plurality of optical input ports to a second plurality of wavelength demultiplexers, wherein the second plurality of optical routing components are to distribute the second plurality of multiplexed optical data signals to the second plurality of wavelength demultiplexers, wherein each demultiplexer of the second plurality of wavelength demultiplexers is to receive a multiplexed optical data signal originating from each of the second plurality of network elements; the second plurality of wavelength demultiplexers, wherein each demultiplexer of the second plurality of wavelength demultiplexers is to separate multiplexed optical data signals received at the demultiplexer into a second plurality of optical data signals, each optical data signal of the second plurality of optical data signals having a distinct wavelength; and a second plurality of optical output ports connected to a demultiplexer of the second plurality of wavelength demultiplexers, each optical output port to output a respective optical data signal of the second plurality of optical data signals to a respective network element of the first plurality of network elements. In some embodiments, the device is configured to receive a second plurality of optical data signals at the plurality of optical output ports, each optical data signal of the second plurality of optical data signals having a distinct wavelength, the optical output ports each configured to send the second plurality of optical data signals to the plurality of wavelength demultiplexers, wherein each demultiplexer of the plurality of wavelength demultiplexers is to combine optical data signals received at the demultiplexer into a respective multiplexed optical data, wherein a second plurality of multiplexed optical data signals are to be generated; and the plurality of optical routing components, wherein the plurality of optical routing components are to distribute the second plurality of multiplexed optical data signals to the plurality of optical input ports, wherein a group of optical input ports corresponding to a respective network element of the first plurality of network elements is to receive multiplexed optical data signals of the second plurality of multiplexed optical data signals.

### BRIEF DESCRIPTION OF DRAWINGS

Various embodiments in accordance with aspects of the disclosure will be described with reference to the drawings, in which:

FIGS. 1A-B illustrate a system, according to some aspects of the disclosure.

FIG. 2A illustrates a first example network architecture having a three layer fabric, according to some aspects of the disclosure.

FIG. 2B illustrates an example network architecture having a two layer fabric, according to some aspects of the disclosure.

FIG. 2C illustrates an example network architecture, including leaf nodes connected to a server.

FIG. 2D illustrates an example network architecture, including leaf nodes that connect a server to an IP fabric.

FIG. 3A illustrates an example system, according to some aspects of the disclosure.

FIG. 3B illustrates an example system, according to some aspects of the disclosure.

FIG. 3C illustrates an example system, according to some aspects of the disclosure.

FIG. 3D illustrates an example system, according to some aspects of the disclosure.

FIG. 3E illustrates an example system, according to some aspects of the disclosure.

FIG. 3F illustrates an example system, according to some aspects of the disclosure.

FIG. 3G illustrates an example system, according to some aspects of the disclosure.

FIG. 4 illustrates an example transceiver, according to some aspects of the disclosure.

FIG. 5 illustrates an example transceiver, according to some aspects of the disclosure.

FIG. 6A is a flow diagram of an example method for wavelength division multiplexing (WDM) optical shuffle box, according to some aspects of the disclosure.

FIG. 6B is a flow diagram of an example method for wavelength division multiplexing (WDM) optical shuffle box, according to some aspects of the disclosure.

FIG. 7A illustrates an example communication system, according to some aspects of the disclosure.

FIG. 7B is a block diagram that schematically illustrates a communication system, according to some aspects of the disclosure.

FIG. 8 is a block diagram of a computing system having two processing devices coupled to each other and multiple networks, according to some aspects of the disclosure.

FIG. 9 is a block diagram of a computing system having a CPU and a GPU in a single integrated circuit, according to some aspects of the disclosure.

FIG. 10 is a block diagram of a computing system having tensor core GPUs, according to some aspects of the disclosure.

FIG. 11 illustrates an example distributed system, according to some aspects of the disclosure.

FIG. 12 illustrates an exemplary data center, according to some aspects of the disclosure.

FIG. 13 illustrates a client-server network formed by a plurality of network server computers which are interlinked, according to some aspects of the disclosure.

FIG. 14 illustrates a computer network connecting one or more computing machines, according to some aspects of the disclosure.

FIG. 15A illustrates a networked computer system, according to some aspects of the disclosure.

FIG. 15B illustrates a networked computer system, according to some aspects of the disclosure.

FIG. 15C illustrates a networked computer system, according to some aspects of the disclosure.

FIG. 16 illustrates a fat tree topology for a datacenter, according to some aspects of the disclosure.

FIG. 17 illustrates an example datacenter, according to some aspects of the disclosure.

FIG. 18A illustrates a top view of a transceiver module that may be operatively coupled to a network adapter, according to some aspects of the disclosure.

FIG. 18B illustrates a perspective view of a transceiver module that may be operatively coupled to a network adapter, according to some aspects of the disclosure.

FIG. 19 is an example of a standard fiber connection configuration including a 2xFR4 type transceiver.

FIG. 20 is an example of a custom fiber connection configuration including a custom transceiver, according to some aspects of the disclosure.

FIG. 21 is an example of a custom fiber connection configuration including a custom transceiver, according to some aspects of the disclosure.

FIG. 22 is an example of a custom fiber connection configuration including a custom transceiver, according to some aspects of the disclosure.

FIG. 23 is an example of a custom fiber connection configuration including a custom transceiver, according to some aspects of the disclosure.

FIG. 24 is an example of a custom fiber connection configuration including a custom transceiver, according to some aspects of the disclosure.

FIG. 25 is an example of a custom fiber connection configuration including a custom transceiver, according to some aspects of the disclosure.

FIG. 26 illustrates an example of an optical shuffle box according to some aspects of the disclosure.

### DETAILED DESCRIPTION

Datacenters often include multiple switching layers to connect many servers. As datacenters grow, the number of connections needed for the data center can grow rapidly. Many datacenters are organized in a hierarchical set of network layers. Data flows in from the lower layers, and is aggregated with data that has a similar destination as it moves up through the network layers. A switching component in the top layer can then direct a batch of data with the same or similar destinations. Alternatively, switching components in the top layer can direct data to locations not-accessible by the lower network layers.

Each network layer in this type of network organization can add complexity and cost to setting up and maintaining the datacenter, while reducing the performance of the datacenter. Thus, the number of network layers may often be reduced to the fewest number of network layers possible to connect each component of the datacenter. However, the number of network layers is often restricted based on (i) the number of network switches in the network layer, and (ii) the radix of network switches (e.g., the number of ports or distinct signals that each network switch can manage). Moreover, in deployments with very dense rack connectivity, cabling bulk can block routing through the racks and cable trays.

One method to “flatten” a network (e.g., reduce the number of switching layers) is to break the network into multiple parallel networks. In this approach, the network is replicated into parallel network planes. Each connection between a server and switches of a first network layer are broken down into multiple lower speed connections that fan out to all parallel planes. This approach is facilitated by parallel lane optical transceivers broadly used in optical interconnects, such as short range 4-lane (SR4) and direct reach 4-lane (DR4) optical interconnects. Typically, all four fiber pairs are connected to a single destination, such as a switch in the first network layer. This connection uses four lanes of the switch controller, such as an application-specific integrated circuit (ASIC). However, by using the parallel plane method, these four fiber pairs can be connected to four different switches in the first network layer, thus consuming only a single lane per destination in the switch controller, while allowing for four times more network elements to connect to each network switch, thus increasing the radix of the network layer.

Another way to increase the bandwidth of each lane per destination (e.g., increase the radix of a network layer) is through multiplexing I/Os of multiple switch ASICs operating in parallel, in which multiple I/O or switch lanes that collectively make up a port are connected to a single destination, such as a switch. Since generally the I/O or switch lanes all have the same destination, all I/O or switch lanes can be switched together, resulting in power savings and reduced complexity in the network. The routing and distribution of these I/O or switch lanes can be managed using a shuffle box.

Optical circuit switches (OCSs) are being deployed in datacenters to save power and improve network availability. An OCS port pair is capable of connecting to a single fiber pair (transmit & receive). As a result, when WDM transceivers are used (e.g. FR4 transceivers), one OCS port pair can connect to a single transceiver. In case parallel optics transceivers are used (e.g. DR4), a single transceiver requires four OCS ports.

However, typical shuffle boxes work by taking advantage of a fiber-pair granularity provided by the transceiver. This makes these shuffle boxes incompatible with physical medium dependent (PMD) transceivers such as wavelength division multiplexing (WDM) transceivers that bundle multiple lanes into a single fiber pair.

Aspects of this disclosure address these and other challenges by implementing a wavelength division multiplexing (WDM) optical shuffle box. Using WDM enables use of connections longer than 500 meters. The WDM optical shuffle box is usable with PMD/WDM transceivers. The shuffle box may include a combination of WDM multiplexers and/or demultiplexers within the shuffle box. Additional aspects of the disclosure further include a new type of transceiver usable with the new shuffle box. The new type of transceiver may be a modified WDM transceiver that does not multiplex an outgoing optical data signal. In some embodiments, neither the outgoing optical data signal nor the incoming optical data signal for the transceiver is multiplexed.

Advantages of the disclosure include, but are not limited to, an increased radix of network layers, a reduction in the number of network layers to connect to multiple network endpoints, a reduction in the complexity of the network for a datacenter, and a reduction in optical cabling used for interconnects between network endpoints and network layers. Additional advantages of the disclosure may include increased network availability, reduced power consumption, and increased network performance.

As used herein, an “optical multiplexer” (also referred to herein as a “multiplexer”) can receive multiple optical signals and combine the multiple optical signals into a single multiplexed optical signal. The multiplexed optical signal can include all of the information that is carried on each received optical signal. Alternatively, the optical multiplexer can similarly receive a multiplexed optical signal and perform a demultiplexing operation to separate the multiplexed optical signal into multiple distinct optical signals. That is, the same optical multiplexer can either multiplex optical signals (e.g., when individual signals are provided as input) or demultiplex multiplexed optical signals (e.g., when a multiplexed signal is provided as input) depending on the configuration of the optical system that includes the optical multiplexer.

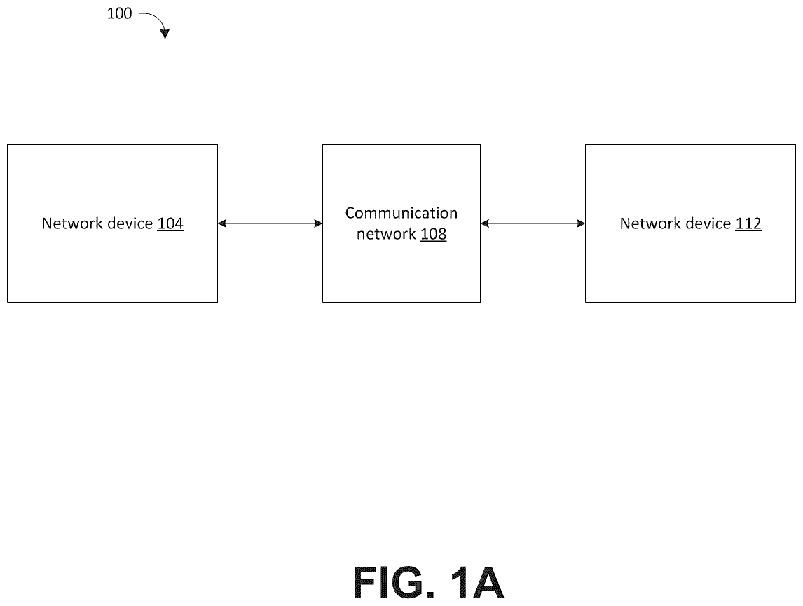

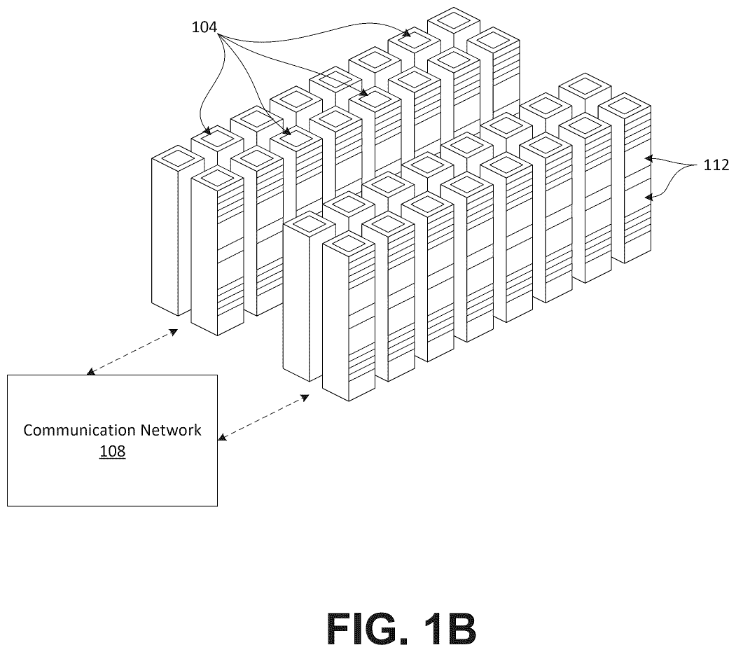

FIG. 1A illustrates a system 100 according to at least one example embodiment. The system 100 includes a network device 104, a communication network 108, and a network device 112 (also referred to hereinafter as a “network element”). In at least one example embodiment, network devices 104 and 112 may correspond to a network switch (e.g., an Ethernet switch), a network interface controller (NIC), or any other suitable device used to control the flow of data between devices connected to communication network 108. Each network device 104 and 112 may be connected to one or more of Personal Computer (PC), a laptop, a tablet, a smartphone, a server, a collection of servers, a GPU, or the like. In one specific, but non-limiting example, each network device 104 and 112 includes multiple network switches in a fixed configuration or in a modular configuration. The switches within each layer (e.g., edge layer, aggregation layer, core layer) may be 1U switches, where “1U” refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

In some embodiments, the network device 104 can be a rack in a datacenter, as illustrated in FIG. 1B. Datacenters may include multiple network switches in a particular topology, such as a fat tree topology, a slim fly topology, or indirect network topology (e.g. folded-Clos or a dragonfly topology), and/or the like. The specifications and makeup of the network switches in the topology affects the overall network performance (e.g., bandwidth capability) of the datacenter.

High performance computing clusters, and/or the like are often formed of various computing components or networked devices, and communication networks formed of electrical and/or optical devices may be used to enable communication between the networked devices forming these implementations.

For example, the network device 104 may be a centralized facility designed to house computing resources and related components. The network device 104 may operate to support the infrastructure required for advanced computational tasks, for efficient, secure, and reliable operations. The network device 104 may include the building and structural components, including power supplies, cooling systems, fire suppression systems, and physical security measures that are configured to maintain optimal operating conditions and/or protect the equipment from environmental hazards and unauthorized access. An example network device 104 may include high-performance servers or compute nodes, often arranged in racks, such as those illustrated in FIG. 1B, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The network device 104 may include high-speed network equipment, such as network switches, routers, firewalls, and/or the like to facilitate fast and secure data transmission within the network device 104 (e.g., between the servers or compute nodes) and between external networks. The network device 104 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the network device 104 may support high-performance computing tasks. Examples of various network topologies may include hierarchical networking topologies such as the fat tree topology, Slim Fly topology, Dragonfly topology, and/or the like.

Examples of the communication network 108 that may be used to connect the network devices 104 and 112 include an Internet Protocol (IP) network, an Ethernet network, an InfiniBand (IB) network, a Fibre Channel network, an NVLink fabric, the Internet, a cellular communication network, a wireless communication network, combinations thereof (E.g., Fibre Channel over Ethernet), variants thereof, and/or the like. In one specific, but non-limiting example, the communication network 108 is a network that enables communication between the network devices 104 and 112 using Ethernet technology.

As discussed in more detail below, each network device 104 and 112 may be connected to a communication network 108 that has multiple network switching layers. The number of network devices 104 and 112 that may be connected to the communication network 108 can be increased by increasing the radix of the communication network 108. The radix of the communication network 108 is increased by increasing the radix of each network layer in the communication network 108. The radix of each network layer is increased using optical shuffle boxes that implement wavelength division multiplexing as described herein below in embodiments. The communication network 108 can include one or more electrical switches, optical switches, electrooptical transceivers, or the like, as described herein below.

The communication network 108 may communicably couple the network device 104 with network device 112 and other external devices for data exchange and connectivity. Examples of the communication network 108 may include an Internet Protocol (IP) network, an Ethernet network, an InfiniBand (IB) network, a Fibre Channel network, an NVLink fabric, the Internet, a cellular communication network, a wireless communication network, combinations thereof (e.g., Fibre Channel over Ethernet), variants thereof, and/or the like. The ability of the communication network 108 to incorporate multiple network types and configurations may allow the network device 104 to adapt to diverse application needs, from general data communication to specialized HPC tasks. As described herein, the communication network 108 may leverage various optical components to establish communication links (e.g., communicably couple) between components in the computing system 100. As such, the communication network 108 may include various optical devices, transceivers, modules, and/or the like that are configured to generate optical data signals (e.g., provide optical transmitter functionality) and/or receive optical data signals (e.g., provide optical receiver functionality).

The network device 112 may include a variety of computing devices capable of transmitting and receiving signals over the communication network 108. The network device 112 may range from personal computing devices to complex server configurations. Examples include Personal Computers (PCs), laptops, tablets, smartphones, and servers. The network device 112 may facilitate user interactions with the network device 104, allowing for data input, retrieval, and processing from remote locations. In addition to individual computing devices, the network device 112 may also include collections of servers or additional datacenters. For instance, these could be other datacenters similar to or the same as network device 104. Such an interconnection may allow for the formation of a distributed computing environment for improved redundancy, load balancing, and disaster recovery capabilities. By linking multiple datacenters, the system 100 may leverage geographically dispersed resources, optimizing performance and ensuring high availability.

As described herein, the network device 104 and/or the network device 112 may include storage devices and processing circuitry for executing computing tasks, such as controlling the flow of data internally and over the communication network 108. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the network device 104 and network device 112 may include one or more communication interfaces for facilitating wired and/or wireless communication between one another and other unillustrated elements of the system 100. These communication interfaces may include a variety of technologies, including but not limited to Ethernet ports, fiber optic connections, Wi-Fi® transceivers, Bluetooth® modules, and cellular communication modules for integration and interoperability among the various components within the system 100.

Furthermore, the present disclosure contemplates that the system 100 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the system 100 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the system 100.

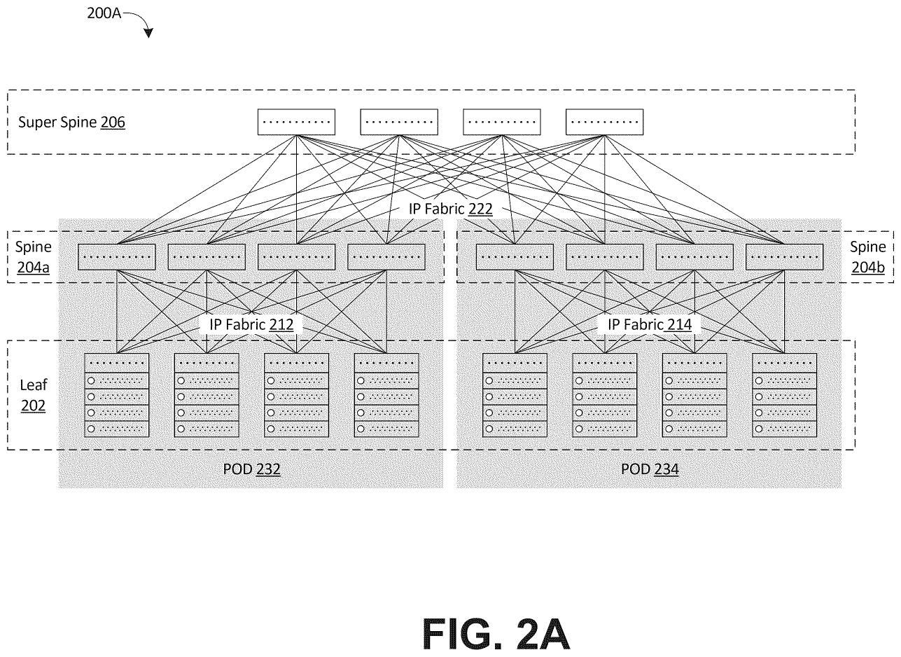

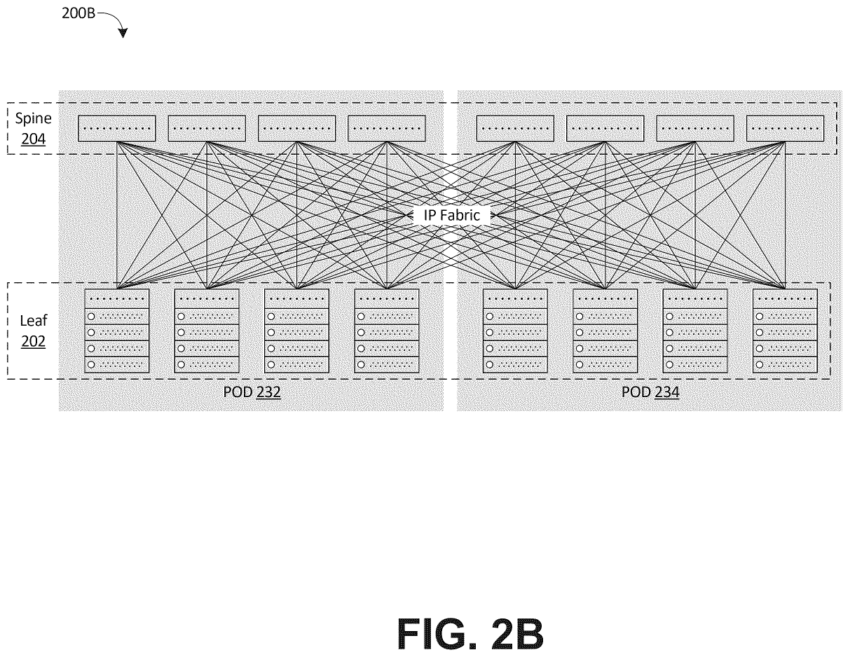

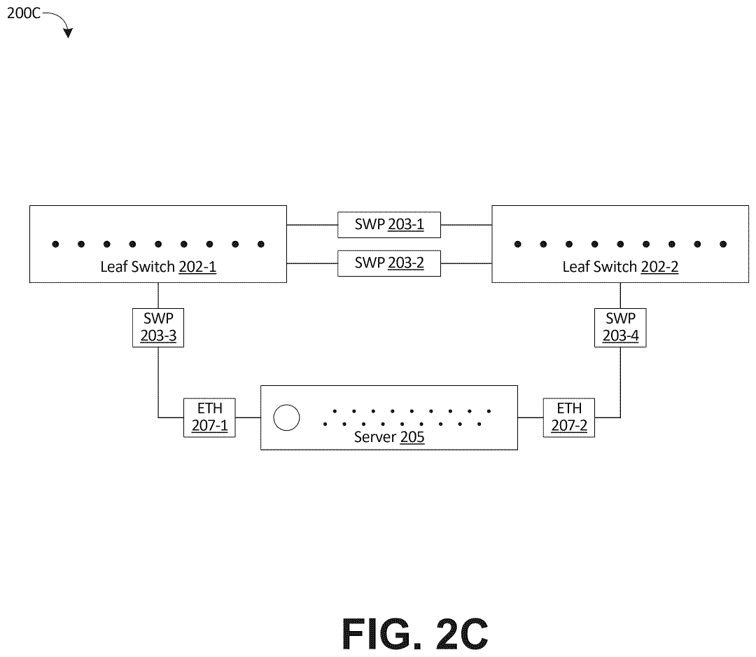

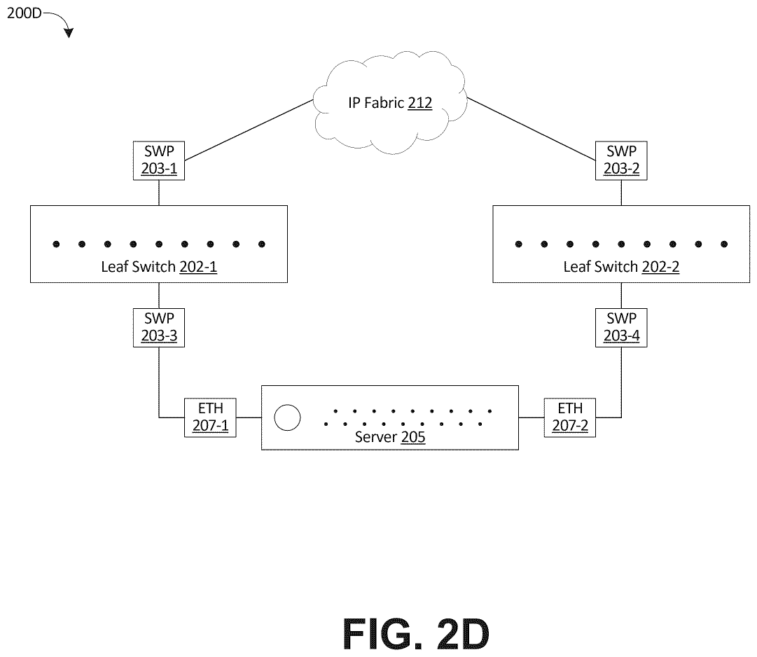

FIG. 2A illustrates a first example network architecture 200A having a three layer fabric, including a leaf layer comprising a plurality of leaves each comprising one or more data processing components, a spine layer comprising a first plurality of network devices (e.g., switches), and a super-spine layer comprising a second plurality of network devices. As shown, to connect a large number of data processing components, multiple layers of network switches are often needed. Embodiments increase a radix of network devices (e.g., network switches), and in turn reduce a number of layers used to connect the same number of underlying data processing devices that would typically require a greater number of switching layers to connect to one another.

The spine layer 202 can include multiple pods, such as pod 232 and pod 234. As used herein, a “pod” is a unit of network, storage, and compute that work together to deliver networking services. For example, a pod can include a group of servers connected by Leaf and Spine switches, such as spines 204a for pod 232, or spines 204b for pod 234, one or more transceivers, and network uplinks, such as network interface cards (NICs) to connect the pod to a communication network, such as the communication network 108 of FIG. 1. The first switch layer 204 can connect multiple servers together in an internet protocol (IP) fabric, such as IP fabric 212 with respect to pod 232 and spines 204a, or IP fabric 214 with respect to pod 234 and spines 204b. As used herein, “IP fabric” can refer to a network architecture in which multiple switches are interconnected with multiple networking components. The IP fabric architecture allows for data flow between servers, or between groups of servers, such as how the IP fabric 222 connects the group of servers in the pod 232 with the group of servers in the pod 234 via the super spine layer 206. The super spine layer 206 aggregates the traffic from spines 204a and spines 204b to connect the servers of the pod 232 to the servers of the pod 234.

FIG. 2B illustrates an example network architecture 200B having a two layer fabric, including a leaf layer comprising a plurality of leaves each comprising one or more data processing components and a spine layer comprising multiple respective network devices (e.g., switches). The respective network devices can include optical network devices and/or electrical network devices.

In network architecture 200B, each leaf (e.g., connected device or server) is connected to each spine (e.g., a network switch). In some embodiments, pods 232, 234 are eliminated. In network architecture 200B, load sharing can be accomplished through equal cost multipath (ECMP) load sharing between all spines of the first switch layer 204 (e.g., spine layer). Reducing the number of network layers can eliminate additional complexity, networking components, and/or protocols that are used in multilayer networks (e.g., 3+ layers of networking).

FIG. 2C illustrates an example network architecture 200C, including leaf nodes connected to a server. The leaf switches 202-1, 202-2 can be connected to each other by switch ports 203-1, 203-2 (“SWP”) as illustrated. The leaf switch 202-1 is connected to the server 205 via switch port 203-3 of the leaf switch 202-1 and ethernet port 207-1 (“ETH”) of the server 205. The leaf switch 202-2 is similarly connected to the server 205 via switch port 203-4 of the leaf switch 202-2 and ethernet 207-2 of the server 205.

The network architecture 200C can be an illustrated representation of multi-chassis link aggregation (MLAG). This allows for a pair of switches (e.g., leaf switches 202-1, 202-2) to act redundantly in an active-active architecture, but appear to a host (e.g., the server 205) as a single, logical switch. In some embodiments, the leaf switches 202-1, 202-2 are connected by a link aggregation control protocol (LACP) via the switch ports 203-1, 203-2. LACP is a dynamic protocol that can be used to create and manage aggregated links between switches that allows devices to negotiate and configure link aggregation automatically. LACP allows devices using the protocol to negotiate which links form the link aggregation, and automatically redistributes traffic across active links in the event of a link-failure. LACP can also allow ports (e.g., switch ports 203-1, 203-2) to be assigned priorities. In some embodiments, the leaf switches 202-1, 202-2 are connected by a static bond via the switch ports 203-1, 203-2. In contrast to LACP, a static bond requires manual configuration of ports (e.g., switch ports 203-1, 203-2) on connected devices (e.g., leaf switches 202-1, 202-2). This reduces the link traffic because there are no link negotiation communications between the leaf switches 202-1, 202-2, and can result in more stable links as the static link is not dependent on potential errors in link configuration protocols.

In some embodiments, virtual router-redundancy (VRR) can further enable the leaf switches 202-1, 202-2 to act as a single gateway for high availability (HA) and active-active server links.

FIG. 2D illustrates an example network architecture 200D, including leaf nodes that connect a server to an IP fabric. The leaf switches 202-1, 202-2 can be connected to the IP fabric 212 via the switch ports 203-1, 203-2 respectively (as illustrated). Each leaf switch 202-1, 202-2 can be connected to the server 205 via switch ports 203-3, 203-4 of respective leaf switches 202-1, 202-2 and respective ethernet ports 207-1, 207-2 of the server 205.

In some embodiments, the network architecture 200D can be an illustrated representation of Ethernet Virtual Private Network Multihoming (EVPN-MH). EVPN-MH is a standards-based replacement for the proprietary MLAG described above with reference to FIG. 2C. EVPN-MH can provide all-active server connectivity without the need for the peer links between top-of-rack (ToR) switches, described above with reference to FIG. 2C (e.g., the connection between leaf switches 202-1, 202-2 via the switch ports 203-1, 203-2, respectively). EVPN-MH can allow for wide interoperability between networking devices of various manufactures using a single border gateway protocol (BGP) EVPN (BGP-EVPN) control plane. Thus EVPN-MH can facilitate data center deployments without intimate knowledge of proprietary protocols such as MLAG.

In some embodiments, the network architecture 200D can be an illustrated representation of Redistribute Neighbor. A redistribute neighbor daemon can dynamically monitor address resolution protocol (ARP) table entries and redistribute IP addresses entered in the ARP table as necessary to maintain connectivity between servers (e.g., server 205). Redistribute neighbor can be a useful logical implementation when MLAG or EVPN-MH are not viable alternatives for server connectivity.

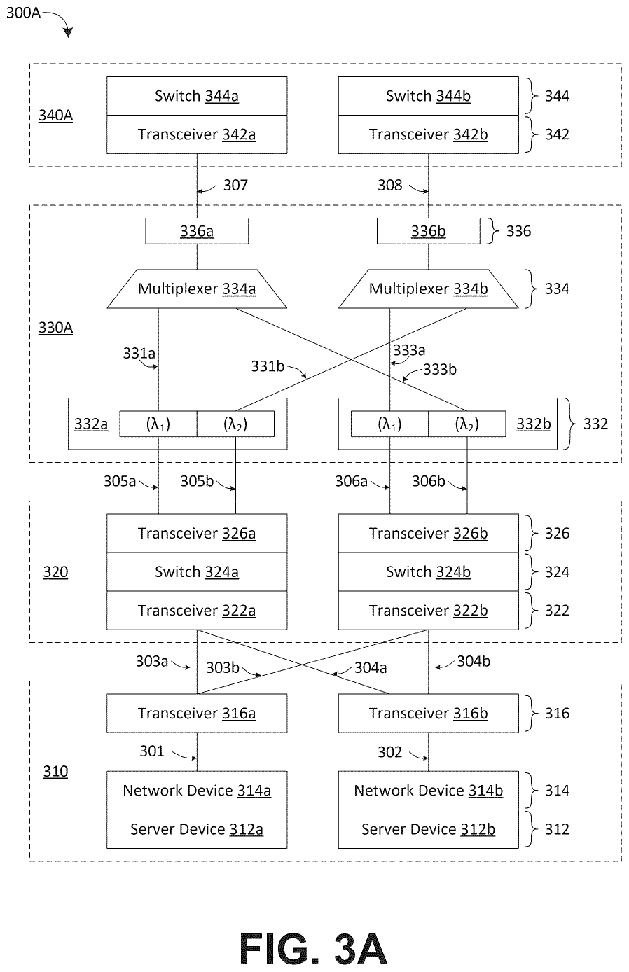

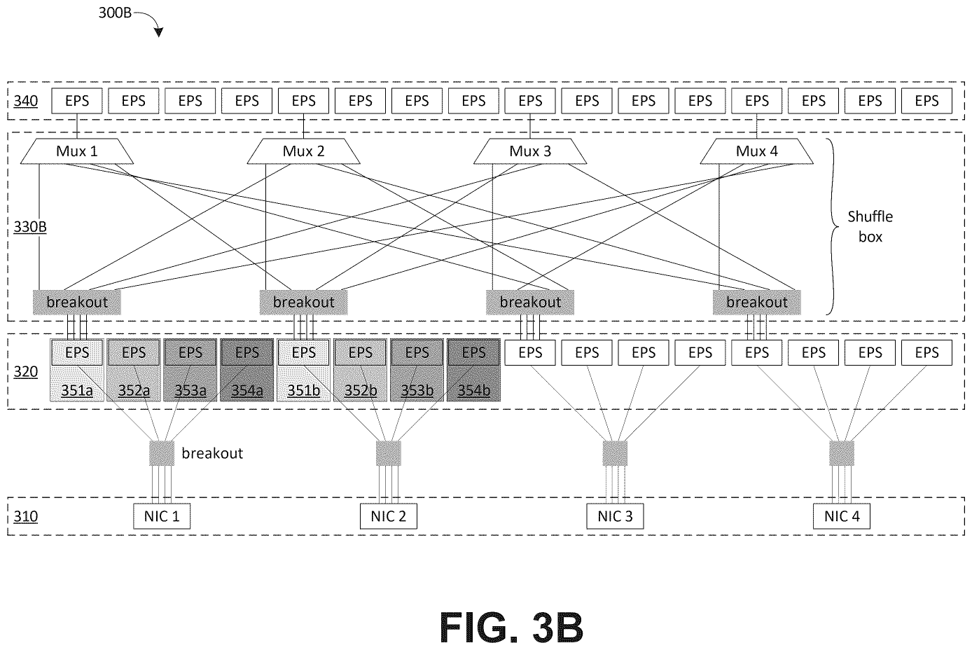

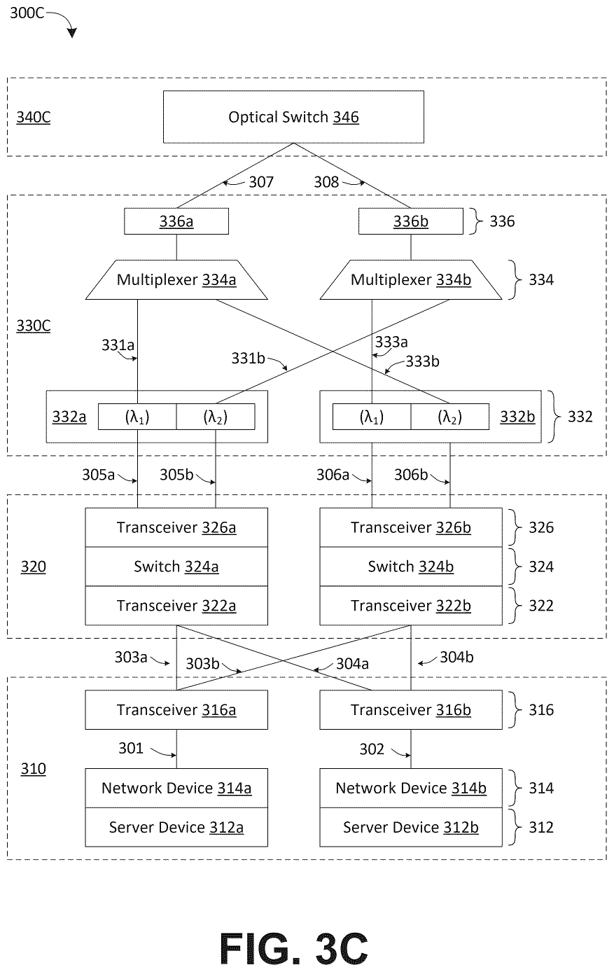

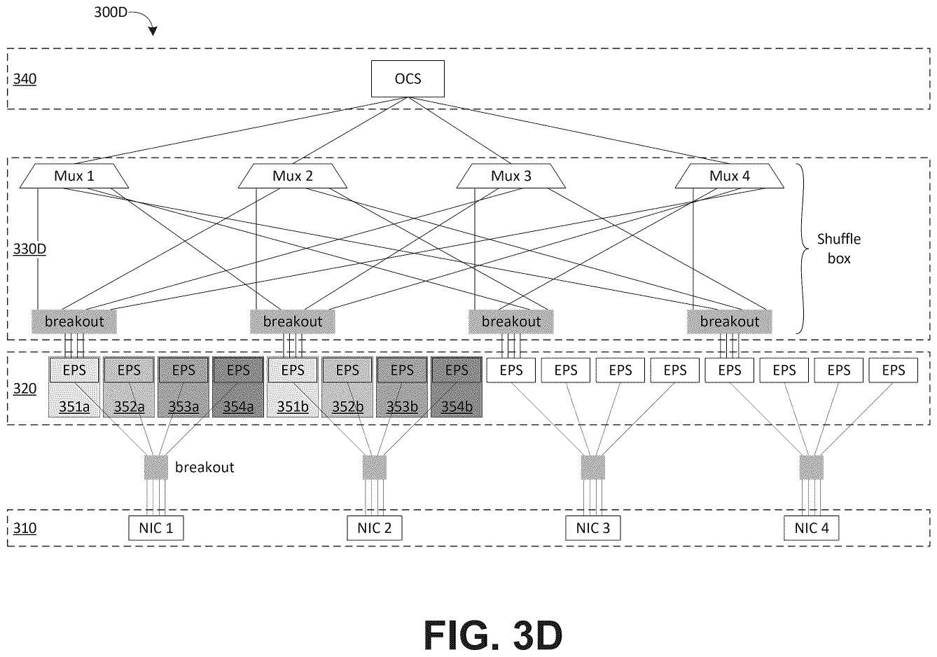

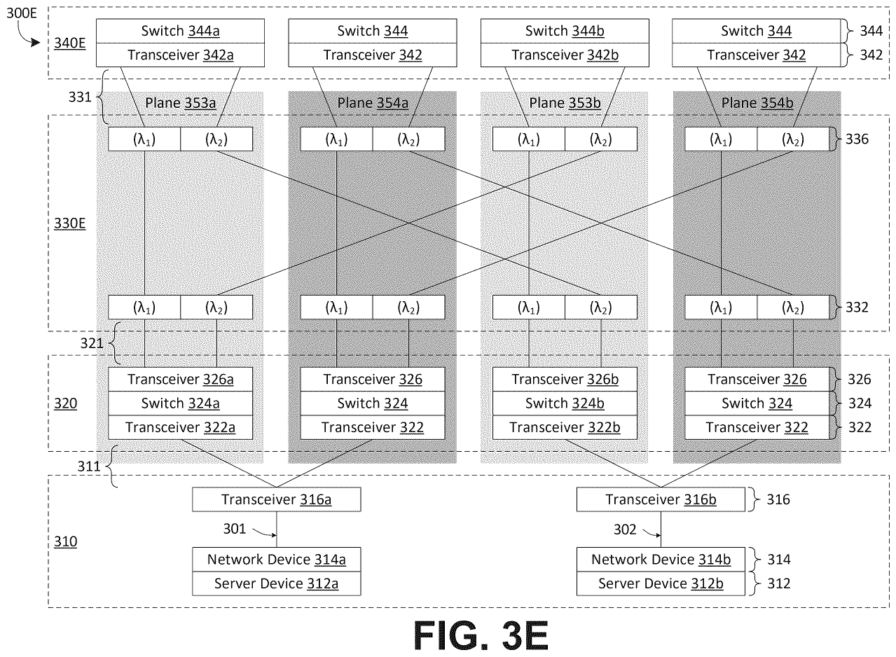

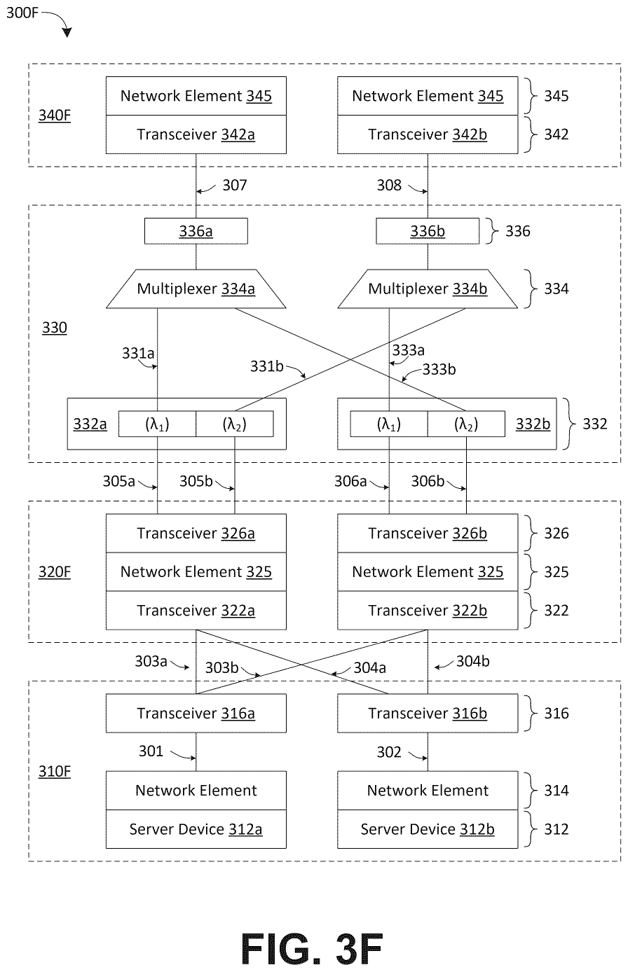

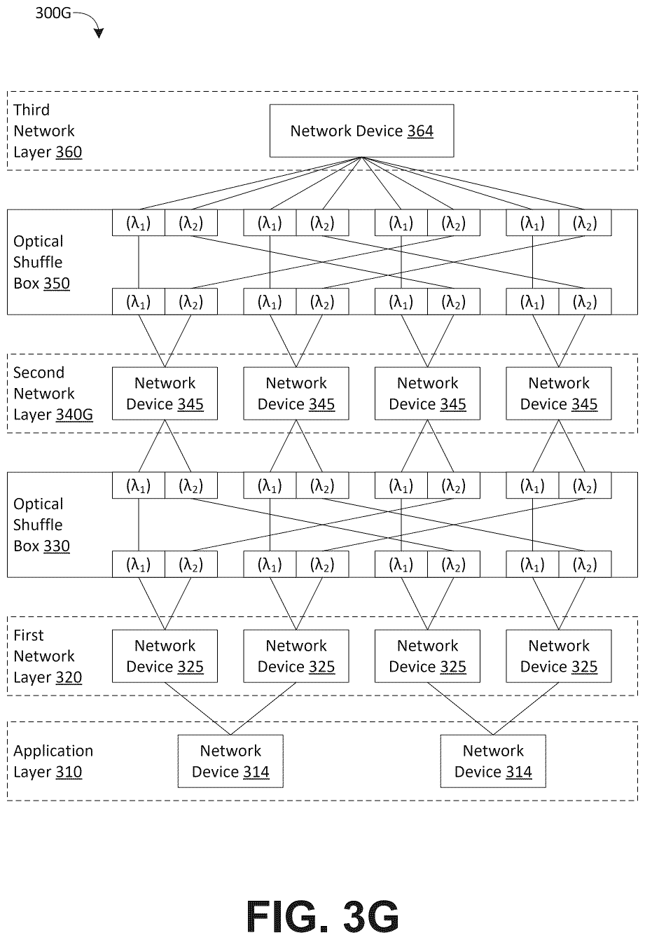

FIG. 3A illustrates an example system 300A, according to some aspects of the disclosure. The system 300A includes an application layer 310 connected to a first network layer 320, which is connected to a second network layer 340 via an optical shuffle box 330A. Due to inclusion of the optical shuffle box 330A, which is described in greater detail below, a large number of server devices 312 and associated network devices 314 can be connected using fewer layers of network components, such as shown in FIG. 2A.

The application layer 310 can include multiple server devices 312a-b (referred to collectively as server devices 312) that are respectively coupled to multiple network devices 314a-b (referred to collectively as network devices 314), which are respectively coupled to multiple transceivers 316a-b (referred to collectively as transceivers 316). Additional details regarding the components of the application layer 310 are described herein, below.

The first network layer 320 can include multiple transceivers 322a-b (referred to collectively as transceivers 322) respectively coupled to the input of multiple switches 324a-b (referred to collectively as switches 324), whose outputs are respectively coupled to multiple transceivers 326a-b (referred to collectively as transceivers 326). Additional details regarding the components of the first network layer 320 are described herein, below.

The optical shuffle box 330A can include groups of optical ports 332a-b (referred to collectively as optical ports 332) which are respectively coupled as illustrated to multiple multiplexers 334a-b (referred to collectively as multiplexers 334). The outputs from the multiplexers 334 are respectively coupled to optical outputs 336a-b (referred to collectively as optical outputs 336). Additional details regarding the components of the optical shuffle box 330A are described herein, below.

The second network layer 340 can include multiple transceivers 342a-b (referred to collectively as transceivers 342) respectively coupled to multiple switches 344a-b (referred to collectively as switches 344). Additional details regarding the components of the second network layer 340 are described herein, below.

The system 300A can route network requests across multiple network planes. Each network plane can handle a certain type of packet or network request, and may have similar network routing. In some embodiments, the system 300A can include multiple network planes/rails. Additional details regarding multiple network planes are described below with reference to FIG. 3B, FIG. 3D, and FIG. 3E.

Server devices 312 can send and receive network communications through the system 300A. For illustrative and explanatory purposes, “sending” a network communication is defined as data moving from a server device 312 in the application layer 310 “up” through the network layers to a switch 344 in the second network layer 340, and “receiving” a network communication is defined as data moving from a switch 344 in the second network layer 340 “down” through the network layers to a server device 312 in the application layer 310.

When server devices 312 send network communications in the system 300A, the network devices 314 send the network communications as one or more electrical data signals 301, 302. Transceivers 316 of the application layer 310 transmit the electrical data signals 301, 302 as data signals 303, 304, which are received at transceivers 322 of the first network layer 320. The transceivers 322 receive the data signals 303, 304 which are processed by the switches 324. In some embodiments, for example, the transceiver 322a can receive the data signal 303a from the transceiver 316a and the data signal 304a from the transceiver 316b, and the transceiver 322b can similarly receive the data signal 303b from the transceiver 316a and the data signal 304b from the transceiver 316b. The transceivers 326 transmit the data signals processed by the switches 324 as optical signals 305, 306. The optical data signals 305, 306 are received at optical input ports 332 of the optical shuffle box 330A. As used herein, “input ports” and “output ports” can be used interchangeably. The designation of “input” or “output” port as used for the optical shuffle box 330A are for ease of description only. That is, each input port can be configured to provide an output signal from the optical shuffle box 330, and each output port can be configured to receive an input signal into the optical shuffle box 330 (e.g., each optical port can be an optical input/output (I/O) port). The optical input ports 332 are optically coupled to the multiplexers 334, which produce multiplexed optical data signals 307, 308 at the optical ports 336 of the optical shuffle box 330A. The multiplexed optical data signals 307, 308 are received at the transceivers 342 of the second network layer 340 and provided the switches 344, at which point, the network communications (represented as data signals) are sent back down the network layers to the server devices 312 of the application layer 310.

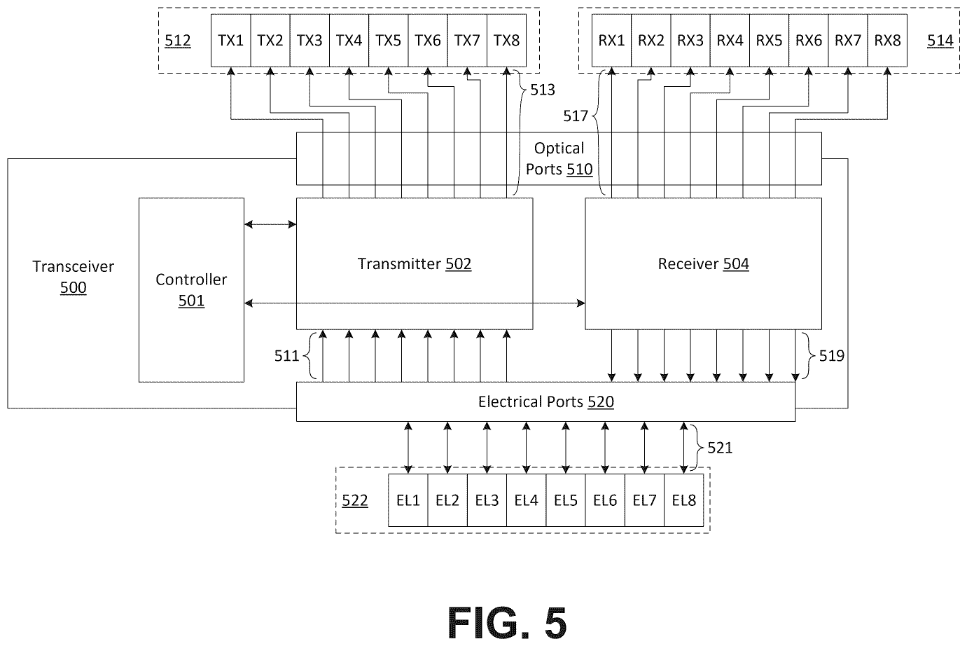

For server devices 312 to receive network communications, in one embodiment the transceivers 342 may transmit the data signals from the switches 344 as multiplexed optical data signals 307, 308, which may be received at optical ports 336 of the optical shuffle box 330A. In some embodiments, the multiplexers 334 demultiplex the multiplexed optical data signals 307, 308 into signals having distinct wavelengths (e.g., optical data signals 331, 333 of respective wavelengths), which are output from the optical ports 332 as optical data signals 305, 306. That is, the optical ports 332 are configured to output the optical data signals 331, 333 of respective wavelengths. The optical data signals 305, 306 are received at transceivers 326 of the first network layer 320. The transceivers 326 provide the received data signals to the switches 324. The transceivers 322 transmit the data signals from the switches 324 as data signals 303, 304, which are received at the transceivers 316 of the application layer 310. The transceivers 316 provide the received data signals 303, 304 to the network devices 314 as electrical data signals 301, 302. The network devices 314 provide the electrical data signals 301, 302 to the server devices 312 as network communications. In the embodiment described, transceivers 326 may correspond, for example, to the transceiver of FIG. 5 described below. The use of transceivers such as those described herein below in combination with the optical shuffle box 330A can reduce the optical loss of optical data signals transmitted in the system 300A.

In alternative embodiments, for server devices 312 to receive network communications, in one embodiment, the transceivers 342 may transmit the electrical data signals received from the switches 344 as corresponding optical data signals (not illustrated), similar to how transceivers 326 transmit electrical data signals as optical data signals 305, 306, as described above. The optical data signals sent from the transceivers 342 are received at second optical input ports of a second optical shuffle box, which is the same as or similar to the optical shuffle box 330A described above, but flipped vertically. The second optical input ports are optically coupled to second multiplexers (as similarly described above), which each produce second multiplexed optical data signals at second output ports of the second optical shuffle box. The second multiplexed optical data signals are received at the transceivers 326, which transmit the second multiplexed optical data signals as electrical signals for the switches 324. The electrical data signals received from the switches 324 are transmitted by the transceivers 322 to the transceivers 316, where the electrical data signals are processed by the network devices 314 and subsequently the server devices 312. In some embodiments, the optical data signals received as input to the second multiplexers each have a distinct wavelength or groups of wavelengths (e.g., respective wavelengths) around a particular range. In some implementations, the second optical shuffle box includes second optical routing components that distribute the optical data signals received from the second network layer 340 to the second multiplexers of the second optical shuffle box.

In some embodiments, transceivers 342 may transmit the electrical data signals from the switches 344 as separate optical data signals (not shown) that are not multiplexed. These optical data signals may be received at additional optical ports (not shown) of the optical shuffle box 330A. The optical shuffle box 330A may send each of the optical data signals to a different multiplexer of a plurality of additional multiplexers (not shown) configured to multiplex returning optical data signals. In alternative embodiments, the electrical data signals are separated into optical signals that carry groups of wavelengths (i.e., as a wavelength super channel). As used herein, a “wavelength super-channel” can refer to a group of wavelengths that are routed as a single entity (e.g., treated as if a single wavelength). A different multiplexed optical data signal is sent to each of transceiver 326a and transceiver 326b. The transceivers 326 demultiplex the optical data signals, and transmit the separate optical data signals as electrical signals for processing by a switch 324. The transceivers 322 transmit the electrical signals from the switches 324 as data signals 303, 304, which may or may not be multiplexed, and which are received at the transceivers 316 of the application layer 310. The transceivers 316 provide the received optical data signals as electrical data signals 301, 302 to the network devices 314. The network devices 314 provide the received electrical data signals 301, 302 to the server devices 312 as network communications.

The system 300A (and the network architecture that system 300A is a part of) allows the server devices 312 to transmit and receive data signals from each other via the communication network provided by the system 300A. In some embodiments, the communication network can include one or more PCIe interconnects. In some embodiments, the communication network include one or more a high-speed interconnects, such as an interconnect that deploys the NVLink technology provided by Nvidia. The NVLink interconnect can be a GPU-GPU interconnect used between GPUs or NVLINK switches, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks.

The network devices 314 of the application layer 310 may be, for example, a NIC in embodiments. In some embodiments, the network device 314 is a smart NIC. As used herein, “smart NIC” can refer to an NIC that includes additional processing capabilities that may otherwise be handled by other processing components of the network device 314. A smart NIC can include one or more processing devices, memory, field-programmable gate arrays (FPGAs), application-specific integrated circuits (ASICs), etc., that may be used to handle networking tasks such as packet processing, encryption, compression, storage management, or the like. For example, a smart NIC may manage software-defined networking (SDN) functions for the network device 314. In another example, a smart NIC may perform encryption or decryption tasks for the network device 314. Each network device 314 may be connected to a server device 312, which may include one or more central processing units (CPUs), graphical processing units (CPUs), and so on. In one embodiment, network device 314 is connected to server device 312 via a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In one embodiment, network device 314 is connected to server device 312 using an interconnect that deploys the NVLink technology provided by NVIDIA, as described further below.

Transceivers 316 are coupled to network device 314, and may receive multiple electrical data signals 301 from network device 314 in the application layer 310. In one embodiment, a transceiver 316 is plugged into a port of network device 314. In embodiments, the transceiver 316 is an electrical to optical transceiver, which communicates with network device 314 via electrical data signals and which communicates with one or more switches 324 of the first network layer 320 via transceivers 322 by an optical data signal. In some embodiments, the transceiver 316 is an electrical to electrical transceiver which communications with network device 314 via electrical data signals and which communicates with switches 324 via transceivers 322 by an electrical data signal.

The transceiver 316 can receive electrical data signals 301, 302, from the server devices 312 and output data signals 303, 304. Similarly, transceiver 322 can receive data signals 303, 304 and output the electrical data signals 301, 302. In some embodiments, the data signals 303, 304 are separated for parallel processing (e.g., to expedite the processing of the data signals). In alternative embodiments, the data signals 303, 304 are separated to be sent to specific destinations for wider fanout or radix. For example, the transceiver 322 can include specific instructions that a particular data signal 303a-b (corresponding to an electrical data signal 301a-b), is to be sent to a particular destination for processing. In some embodiments, the electrical data signals 301 are directed to destinations based on operating loads of one or more components in the system 300A. For example, if a server device 312 has a long queue of operations, the network device 314 can cause the electrical data signals 303 to be directed to a different server device 312 to avoid sending portions of the electrical data signals 301 to be queued at the congested server device 312.

The first network layer 320 receives data signals 303, 304 at the transceivers 322. The transceivers 322 can be electro-optical transceivers that convert electrical data signals into optical data signals and vice versa. Alternatively, one or more transceivers 322 can be optical transceivers. In an alternative embodiment, one or more transceivers 322 can be electrical transceivers. The transceivers 322 are coupled to switches 324.

In some embodiments, the first network layer 320 is a first switching layer. The first network layer 320 includes switches 324. In embodiments, switch 324a receives the data signals 303, and switch 324b receives the data signal 304. Each of data signals 303a-b may correspond to a different wavelength in embodiments (e.g., respective wavelengths). Similarly, each of data signals 304a-b may correspond to a different wavelength in embodiments. The switches 324 of the first network layer 320 cause received data signals to be sent to intended destinations in the system 300A. In some embodiments, the intended destination for a received data signal is determined based on one or more of the contents of the received data signal, preprogrammed algorithms of the switches 324, or the like. In some embodiments, the switches 324 are electrical switches. As illustrated, and in some embodiments, the switches 324 can receive multiple signals (e.g., data signals 303, 304) and forward each signal to an intended destination (e.g., as the optical data signals 305a-b, or the optical data signals 306a-b). In alternative embodiments, the switches 324 can receive a single multiplexed signal that includes data of data signals 303a-b, and can demultiplex the signal and forward each respective signal to an intended destination (not illustrated).

In embodiments, switches 324 of the first network layer 320 are each a high-speed, scalable switch, such as a switch using the NVSwitch technology. An NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that may interconnect all the GPUs (e.g., server devices 312) in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, and a network interface comprising a receiver or transceiver with the control logic, as described herein. Other examples for the communication network connected by the system 300A can include other chip-to-chip or die-to-die interconnects, such as GRS, LPI (low power interface) or LLI (low latency interface).

In some embodiments, switches 324 are each connected to additional signal processing devices, such as optical data signal generators. As illustrated, each switch is coupled to a transceiver 326a-b. The transceivers 326 can receive one or more electrical data signals from each respective switch 324, and generate one or more respective optical data signals corresponding to the electrical data signals. In an alternative embodiment, the switch 324 is an optical switch that receives an optical data signal from the transceiver 322 and outputs an optical data signal to the transceiver 326. Each signal output by a transceiver 326 can have a distinct wavelength. For example, and as illustrated, the transceiver 326a outputs the optical data signal 305a corresponding to the wavelength λ₁, and the optical data signal 305b corresponding to the wavelength λ₂. Similarly, and as illustrated, the transceiver 326b outputs the optical data signal 306a corresponding to the wavelength λ₁, and the optical data signal 306b corresponding to the wavelength λ₂. Each of the outputs of the transceivers 326 are received at respective optical ports, such as optical ports 332 of the optical shuffle box 330A.

The optical shuffle box 330A is coupled to the first network layer 320 at the optical ports 332. The optical shuffle box 330A is coupled to the second network layer 340 by multiplexers 334 (which may also include or be connected to further optical ports of the shuffle box that are not shown for clarity). The optical shuffle box 330A includes optical routing components configured to route optical data signals from the first network layer 320 to the second network layer 340. The optical routing components connect the optical ports 332 (e.g., optical inputs) to respective multiplexers 334 and associated optical ports (e.g., optical outputs). As used herein, an “optical routing component” can refer to a device, component, or system that is used to direct optical data signals through an optical communication network (e.g., within the optical shuffle box 330A). Examples of optical routing components can include optical fibers, waveguides, mirrors, optical splitters, optical switches (including wavelength selective switches), or the like. Additional details regarding alternative designs for an optical shuffle box and optical network are described below with reference to FIG. 3C and FIG. 3E.

The optical ports 332 of the optical shuffle box 330A can include groups of optical ports, such as optical groups 332a-b. Each optical group can receive optical data signals of distinct wavelengths, as denoted in FIG. 3A by λ₁ and λ₂. As illustrated in FIG. 3A, the optical group 332a receives the optical data signal 305a corresponding to the wavelength λ₁ and the optical data signal 305b corresponding to the wavelength λ₂. Similarly, the optical group 332b receives the optical data signal 306a corresponding to the wavelength λ₁ and the optical data signal 306b corresponding to the wavelength λ₂. The optical ports 332 can forward the received signals to respective multiplexers 334.

Multiplexers 334 can receive signals of distinct wavelengths (e.g., can be wavelength multiplexers). Each multiplexer 334 can multiplex the received signals into a multiplexed signal, such as multiplexed optical data signal 307 or multiplexed optical data signal 308. As illustrated, multiplexer 334a receives the optical data signal 331a corresponding to the optical data signal 305a and wavelength λ₁ and the optical data signal 333b corresponding to the optical data signal 305b and the wavelength λ₂, which are multiplexed into the multiplexed optical data signal 307. Similarly, the multiplexer 334b receives the optical data signal 333a corresponding to the optical data signal 306a and the wavelength λ₁ and the optical data signal 331b corresponding to the optical data signal 305b and the wavelength λ₂, which are similarly multiplexed into the multiplexed optical data signal 308. In some embodiments, the multiplexers 334 are combination devices that can perform the function of a multiplexer in one direction and the function of a demultiplexer in the opposite direction (e.g., as a wavelength demultiplexer). For example, and in some embodiments, the passive components of each multiplexer 334 are bidirectional, allowing for use in either direction (e.g., as a wavelength multiplexer or as a wavelength demultiplexer). That is, wavelength multiplexers can combine optical signals of distinct wavelengths into respective multiplexed optical signals, and wavelength demultiplexers can separate multiplexed optical data signals into multiple respective optical data signals of distinct wavelengths.

Optical shuffle box 330A may include optical ports 336a-b that may receive optical connections such as to fiber optic cables that also connect to transceivers 342 connected to switches 324. Accordingly, the second network layer 340 is coupled to the optical shuffle box 330A by optical ports 336a-b of the optical shuffle box 330A. In some embodiments, the second network layer 340 is a second switching layer. As illustrated, and in some embodiments, transceivers 342 of the second network layer 340 receive multiplexed optical data signals (e.g., multiplexed optical data signal 307 and multiplexed optical data signal 308) originating from multiplexers of the optical shuffle box 330A. The transceivers 342 separate the multiplexed optical data signal into separate optical data signals, and transmits each of the optical data signals as corresponding electrical data signals which are processed by the switches 344. The switches 344 of the second network layer 340 can be the same as or similar to the switches 324 of the first network layer. In some embodiments, the switches 344 are connected to one or more additional devices that are not shown. In some embodiments, the switches 344 send data back down the system 300A to devices connected to the first network layer 320 (e.g., a server device 312 via the a corresponding network device 314, and the like). Similar to the switches 324 described above, the switches 344 can send data signals to an intended destination of the system. In some embodiments, the intended destination for a received data signal is determined based on one or more of the contents of the received data signal, preprogrammed algorithms of the switches 344, or the like. In some embodiments, the switches 344 are electrical switches.

In some embodiments, data is sent from the second network layer 340 to the first network layer 320 in a similar way that data is sent from the first network layer 320 to the second network layer 340 as described above, albeit in reverse. The switches 324 perform one or more processing operations to switch received data signals (or portions of data signals) based on intended destinations of each received data signal (or each portion of each received data signal). In one embodiment, the switches 344 provide these switched data signals to the transceivers 342, which transmit the switched data signals as a multiplexed optical data signal (e.g., multiplexed optical data signal 307 or multiplexed optical data signal 308, respectively). The multiplexed optical data signals are received at the optical shuffle box 330A, where multiplexers separate the multiplexed optical data signals based on one or more wavelengths of the multiplexed optical data signal. Each signal output by the multiplexers 334 may have a distinct wavelength, and be sent to a respective optical port 332. In similar fashion, each optical port 332 of a group of optical ports (e.g., optical port group 332a, optical port group 332b, etc.) receives an optical data signal having a distinct wavelength. The optical shuffle box 330A provides each optical data signal having the distinct wavelength to the first network layer 320. Transceivers 326 of the first network layer transmit the received optical data signals as electrical data signals, and switches 324 switch the electrical data signals to an intended destination. At the intended destination (illustrated here as server device 312 via the transceiver 316 and network device 314), the electrical data signals can be processed. It can be appreciated that additional devices can be connected to the system 300A via the optical shuffle box 330A. In such embodiments, the transceivers 326 of the first network layer 320 can generate non-multiplexed optical data signals of different wavelengths as optical outputs, and similarly receive non-multiplexed optical data signals of different wavelengths as optical inputs. In such embodiments, the transceivers 342 of the second network layer 340 can receive multiplexed optical inputs (e.g., multiplexed optical data signal 307 or multiplexed optical data signal 308) and can generate multiplexed optical outputs for the switches 344.

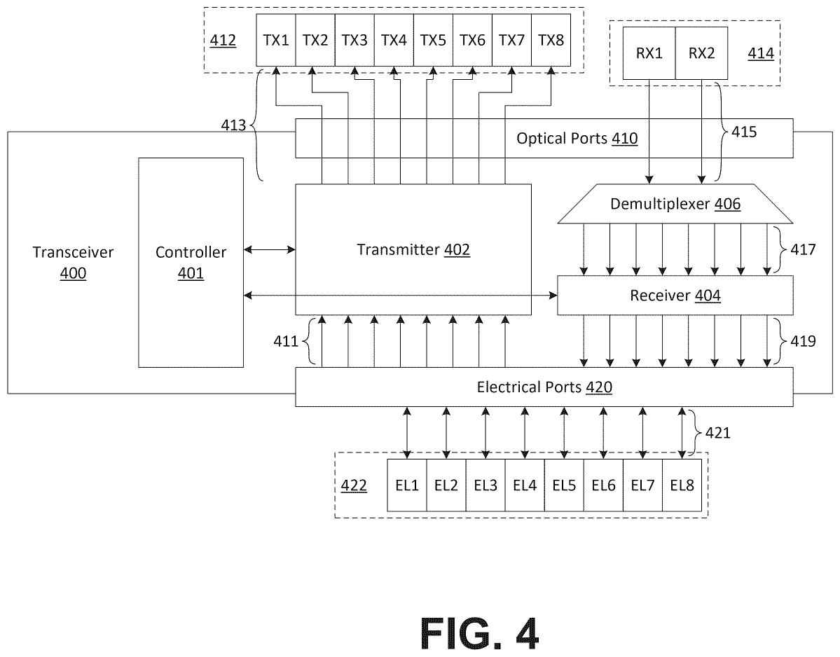

In some embodiments, the optical shuffle box 330A can include additional hardware components to send data from the second network layer 340 to the first network layer 320. The optical shuffle box 330A can include second optical ports coupled to the second network layer 340 (not illustrated) similar to the illustrated connection between the optical ports 332 and the first network layer 320. These second optical ports can be connected to second multiplexers of the optical shuffle box 330A (not illustrated) similar to the illustrated connection between the optical ports 332 and the multiplexers 334. The second multiplexers can in turn be connected to the first network layer 320 (not illustrated) similar to the illustrated connection between the multiplexers 334 and the second network layer 340. Thus, in some embodiments, the second network layer 340 can send data signals through the optical shuffle box 330A in the same way as is described for sending signals from first network layer 320 to second network layer 340, using a similar hardware configuration as is illustrated in system 300A (but flipped with respect to the first network layer 320 and the second network layer 340). In such embodiments, the transceivers 326 of the first network layer 320 and the transceivers 342 of the second network layer 340 can generate non-multiplexed optical data signals of different wavelengths as optical outputs, and receive multiplexed optical data signals as an optical input. Additional details regarding this type of transceiver are described below with reference to FIG. 4.

System 300A is illustrated showing only two server devices 312a-b, two switches 324a-b, two multiplexers 334a-b, two wavelengths, and two switches 324a-b. However, it should be understood that two of each of these components and wavelengths are shown for clarity, and that more than two of each of these components may be used and that more than two wavelengths may be used. For example, in one embodiment each transceiver 326 outputs four optical data signals, each having a different wavelength, and the optical shuffle box receives four different signals from each of four different transceivers, and distributes these signals to four multiplexers of the optical shuffle box, each of which outputs a multiplexed optical data signal to a different switch of second network layer 340. Additionally, the network architecture may include multiple parallel planes, and each parallel plane may include its own set of switches 324, optical shuffle box 330A and switches 344.

FIG. 3B illustrates an example system 300B, according to some aspects of the disclosure. Similar to the system 300A, described above, the system 300B includes the application layer 310 connected to the first network layer 320, which is connected to the second network layer 340 via the optical shuffle box 330B. The optical shuffle box 330B is wavelength-selective can be connected properly in the network infrastructure to allow shuffling of FR4 transceivers. The system 300B can be an expansion of the system 300A. The system 300B illustrates multiple planes (e.g., four planes) as plane 351a-b, plane 352a-b, plane 353a-b, and plane 354a-b. In some embodiments, the system 300B can include any number of planes. Each portion of each plane, although not illustrated, includes the respective networking components, such as network devices, switches, transceivers, and the like, as described with reference to plane 351a and plane 351b in FIG. 3A. In embodiments, data may be sent via multiple planes in parallel. The second network layer 340 comprise a separate set of electrical packet switches (EPSs). The depicted network includes an application layer 310 of four NICs interconnected through four parallel planes. Traffic generated from the NICs is sprayed across four lanes, with each lane connected to a corresponding plane. Each plane is then served by a separate set of EPSs. In case of network architectures with parallel rails, shuffling can be done across all planes within a rail, or across rails. In the figure we show shuffling across planes, but the exact same concept applies to shuffling across rails. The implemented functionality for shuffling between different planes is shown in the figure. The fiber connected to the transmission side of the WDM transceiver enters a WDM demultiplexer that splits the 4 wavelengths into 4 separate fibers. The demultiplexed fibers are shuffled according to the target connectivity and enter a WDM multiplexer, combining wavelengths coming from different transceivers into a single fiber. The fiber then enters the Rx port of the destination WDM transceiver. This configuration reduces the overall insertion loss in the link, as it saves one demultiplexer from the WDM shuffle box and one multiplexer from the transmitter module.

FIG. 3C illustrates an example system 300C, according to some aspects of the disclosure. The system 300C includes an application layer 310 connected to a first network layer 320, which is connected to a second network layer 340 via an optical shuffle box 330C. Due to inclusion of the optical shuffle box 330C, which is described in greater detail below, a large number of server devices 312 and associated network devices 314 can be connected using fewer layers of network components, such as shown in FIG. 1B.

The application layer 310 can include multiple server devices 312 that are respectively coupled to network devices 314, which are respectively coupled to transceivers 316, as described above with reference to FIG. 3A.

The first network layer 320 can include transceivers 322 respectively coupled to the input of switches 324, whose outputs are coupled to transceivers 326, as described above with reference to FIG. 3A.

The optical shuffle box 330C can include groups of optical ports 332 which are respectively coupled to multiplexers 334. The outputs from the multiplexers 334 are respectively coupled to optical ports 336, as described above with reference to FIG. 3A.

The second network layer 340 can include one or more optical switches, such as optical switch 346. Additional details regarding the optical switch 346 are described herein, below.

When server devices 312 send network communications in the system 300C, the network devices 314 convert the network communications into one or more electrical data signals 301, 302. Transceivers 316 of the application layer 310 transmit the electrical data signals 301, 302 as data signals 303, 304, which are received at transceivers 322 of the first network layer 320. The transceivers 322 receive the data signals 303, 304 which are processed by the switches 324. The transceivers 326 send data signals from the switches 324 as optical data signals 305, 306. The optical data signals 305, 306 are received at optical input ports 332 of the optical shuffle box 330C. The optical input ports 332 are optically coupled to the multiplexers 334, which produce multiplexed optical data signals 307, 308 at the optical ports 336 of the optical shuffle box 330C. The multiplexed optical data signals 307, 308 are received at the optical switches 346, at which point, the network communications (represented as data signals) are sent back down the network layers to the server devices 312 of the application layer 310. Notably, with an optical switch 346 there is no optical data signal termination at an optical transceiver. Rather the optical switch 346 redirects the received optical data signals according to the intended destinations of the received optical data signals back down through the system 300C.

The numbered components of the system 300C can be the same as or similar to the numbered components of the system 300A, and the functionality of each component are described above. Insofar as the functionality of respective components is not described with reference to system 300A of FIG. 3A, the functionality is described below. In particular, the optical switch 346 of the second network layer 340 is further described below.

The optical switch 346, is coupled to the optical shuffle box 330C. As illustrated, and in some embodiments, the optical switch 346 receives multiplexed optical data signals from the optical shuffle box 330C. The optical switch 346 can operate similarly to the switches described herein, albeit as an optical switch. That is, the optical switch 346 can be configured to route the incoming optical data signal to a path such that the incoming optical data signal can reach the intended destination. Unlike the system 300A or the system 300B, the optical data signals that exit the optical shuffle box 330C (e.g., those optical data signals sent to the optical switch 346) do not terminate at an electro-optical component of second network layer 340 (e.g., a transceiver 342 of FIG. 3A). Rather, the optical data signals are redirected according to an intended destination of the optical data signal without being converted into electrical signals. It can be appreciated that in some embodiments, this approach may reduce the power consumption for operating the system 300C in comparison to the system 300A or the system 300B. It can also be appreciated that in some embodiments, this approach may increase unwanted optical artifacts or optical noise in optical data signals that pass through the optical shuffle box 330C. In some embodiments, one or more optical amplifiers may be used at output of the optical shuffle box 330C coupled to the optical switch 346, or at the input of the optical shuffle box 330C coupled to the optical switch 346. In alternative embodiments, the same components of the optical shuffle box 330C may be used when optical data signals travel in both directions (i.e., from the application layer 310 to the optical switch 346 of the second network layer 340, or from the optical switch 346 back to the application layer 310).

System 300C is illustrated showing only two server devices 312a-b, two switches 324a-b, two multiplexers 334a-b, two wavelengths, and two switches 324a-b. However, it should be understood that two of each of these components and wavelengths are shown for clarity, and that more than two of each of these components may be used and that more than two wavelengths may be used.

FIG. 3D illustrates an example system 300D, according to some aspects of the disclosure. Similar to the system 300C, described above, the system 300D includes the application layer 310 connected to the first network layer 320, which is connected to an optical switch 346 in the second network layer 340 forming an upper switching layer via the optical shuffle box 330D. In contrast to the electrical processing switch (EPS) configurations described above, optical circuit switch (OCS) do not terminate the link (i.e., no transceiver modules are connected to the OCS). Each link now passes through two shuffle boxes, because the OCS does not terminate the link (path: transmitter->shuffle box->OCS->shuffle box->receiver). The OCS or a group of OCSs working in parallel replaces layer of switches steering the traffic (collection of EPS) defining OCS hundreds of ports. The system 300D can be an expansion of the system 300C. While the system 300C illustrates a single plane, the system 300D illustrates multiple planes (e.g., four planes) as plane 351a-b, plane 352a-b, plane 353a-b, and plane 354a-b, similar to the system 300B of FIG. 3B. In some embodiments, the system 300D can include any number of planes. Each portion of each plane, although not illustrated, includes the respective networking components, such as network devices, switches, transceivers, and the like, as described with reference to a single plane in FIG. 3C.

An example of the fiber shuffling and wavelength multiplexing rules are shown below for NICs that each have a single FR4 transceiver generating four wavelengths, where each wavelength is transmitted through the corresponding fiber port:
Multiplexer(1): NIC(1)_port(1), NIC(2)_port(2), NIC(3)_port(3), NIC(4)_port(4)
Multiplexer(2): NIC(2)_port(1), NIC(3)_port(2), NIC(4)_port(3), NIC(1)_port(4)
Multiplexer(3): NIC(3)_port(1), NIC(4)_port(2), NIC(1)_port(3), NIC(2)_port(4)
Multiplexer(4): NIC(4)_port(1), NIC(1)_port(2), NIC(2)_port(3), NIC(3)_port(4)

FIG. 3E illustrates an example system 300E, according to some aspects of the disclosure. The system 300E includes an application layer 310 connected to a first network layer 320, which is connected to a second network layer 340 via an optical shuffle box 330E. In contrast to previously described optical shuffle boxes, optical shuffle box 330E lacks multiplexers. Due to inclusion of the optical shuffle box 330E, which is described in greater detail below, a large number of server devices 312 and associated network devices 314 can be connected using fewer layers of network components, such as shown in FIG. 1B.

The application layer 310 can include server devices 312 that are respectively coupled to network devices 314, which are respectively coupled to transceivers 316, as described above with reference to FIG. 3A.

The first network layer 320 can include transceivers 322 respectively coupled to the input of switches 324, whose outputs are coupled to transceivers 326, as described above with reference to FIG. 3A.

The optical shuffle box 330E can include groups of optical ports 332 which are respectively coupled to optical ports 336 via one or more optical shuffling components. Additional details regarding the components of the optical shuffle box 330E are described herein, below.

The second network layer 340 can include transceivers 342 respectively coupled to switches 344, as described above with reference to FIG. 3A. In some embodiments, the second network layer 340 can include one or more optical switches 346, as described above with reference to FIG. 3C.

When server devices 312 send network communications in the system 300E, the network devices 314 convert the network communications into one or more electrical data signals 301, 302. Transceivers 316 of the application layer 310 transmit the electrical data signals 301, 302 into optical data signals 311, which are received at transceivers 322 of the first network layer 320. The transceivers 322 receive the optical data signals 311 which are processed by the switches 324. The transceivers 326 receive the data signals from the switches 324 and transmit the optical data signals 321, which in embodiments are not multiplexed. The optical data signals 321 are received at optical input ports 332 of the optical shuffle box 330E. The optical ports 332 are optically coupled the optical ports 336 of the optical shuffle box 330E. Each optical data signal 331 have a distinct wavelength, and are received at the transceivers 342 of the second network layer 340. The transceivers 342 may receive the optical data signals 331 for the switches 344, at which point the network communications (represented as data signals) are sent back down the network layers to the server devices 312 of the application layer 310. Notably, in embodiments with an optical switch 346 in the second network layer 340, such as is described with reference to FIG. 3C, there is no optical data signal termination at an electro-optical transceiver. Rather the optical switch 346 redirects the received optical data signals according to the intended destinations of the received optical data signals back down through the system 300E.

In order for server devices 312 to receive network communications via the second network layer 340 in the system 300C, the transceivers 342 may transmit the electrical data signals from the switches 344 as the optical data signals 331, which are received at optical ports 336 of the optical shuffle box 330E. The optical data signals 331 pass through the optical shuffle box 330E to the optical ports 332 and are output as optical data signals 321, which are received at transceivers 326 of the first network layer 320. The transceivers 326 of the first network layer 320 receive the optical data signals 321 for the switches 324. The transceivers 322 transmit data optical data signals 311 based on data signals from the switches 324, which are received at the transceivers 316 of the application layer 310. The transceivers 316 receive the optical data signal 311 for the network devices 314. The network devices 314 convert the received electrical data signals into network communications for the server devices 312.

The numbered components of the system 300E can be the same as or similar to the numbered components of the system 300A, and the functionality of each component are described above. Insofar as the functionality of respective components is not described with reference to system 300E of FIG. 3E, the functionality is described below.

As described above with reference to FIG. 3A, the first optical ports 332 can include groups of optical ports. In system 300E each group of optical ports receives a distinct wavelength as denoted in system 300E by λ₁, λ₂, λ₃, and λ₄. Each group of optical ports 332 can be connected to different groups of optical ports 336 by optical routing components, as illustrated and described above. For example, the first optical port 332 that receives the wavelength λ₁ can be connected to a first group optical ports 336, the second optical port 332 that receives the wavelength λ₂ can be connected to a second group of optical ports 336, the third optical port 332 that receives the wavelength λ₃ can be connected to a third group of optical ports 336, and the fourth optical port 332 that receives the wavelength λ₄ can be connected to a fourth group of optical ports 336 (as illustrated).

Similarly, the optical ports 336 include groups of optical ports, where each group of optical ports receives a distinct wavelength. For example, the first optical port 336 that receives the wavelength λ₁ can be connected to a first group of optical ports 332, the second optical port 336 that receives the wavelength λ₂ can be connected to a group of first optical ports 332, the third optical port 336 that receives the wavelength λ₃ can be connected to a third group of optical ports 332, and the fourth optical port 336 that receives the wavelength λ₄ can be connected to a fourth group of optical ports 332 (as illustrated).

The second network layer 340E is coupled to the optical shuffle box 330E by the optical ports 336. The second network layer 340E can be the same as or similar to the second network layer 340A described with reference to FIG. 3A, as illustrated. In some embodiments, the second network layer 340E can be the same as or similar to the second network layer 340C described with reference to FIG. 3C.

It can be noted that the optical shuffle box 330E does not include multiplexers, in contrast to the optical shuffle box 330A of FIG. 3A, or the optical shuffle box 330C of FIG. 3C, which do include multiplexers 334 on at least one side of the optical shuffle box. The optical shuffle box 330E can use one or more transceivers that do not multiplex generated signals having distinct wavelengths. Rather, the optical shuffle box 330E can be used in combination with transceivers that receive and/or transmit non-multiplexed distinct-wavelength signals, such as the transceiver described below with reference to FIG. 5.

FIG. 3F illustrates an example system 300F, according to some aspects of the disclosure. The system 300F can be the same as or similar to the system 300A. In some embodiments, the system 300F can be the same as or similar to the system 300C (not illustrated), or the system 300E (not illustrated).

The Application layer 310F can include network elements 314 respectively coupled between the server device 312a and the transceiver 316a, and between the server device 312b and the transceiver 316b. The network elements 314 can include one or more of a GPU, CPU, DPU, NIC, network switch, or the like. As used herein, a network element can also be described as a network device.

The first network layer 320F can include network elements 325 respectively coupled between the transceiver 322a and the transceiver 326a, and between the transceiver 322b and the transceiver 326b. The network elements 325 can include one or more of a GPU, CPU, DPU, NIC, network switch, or the like.

The second network layer 340F can include network elements 345 respectively coupled to the transceiver 342a and the transceiver 342b. The network elements 345 can include one or more of a GPU, CPU, DPU, NIC, network switch, or the like.

FIG. 3G illustrates an example system 300G, according to some aspects of the disclosure. The system 300G can include the same or similar components as the system 300A, the system 300C, the system 300E, and/or the system 300F. The system 300G illustrates that this network hierarchy is functional in multi-tiered networks, as the FIGS. 3A-3F primarily describe a two-tier network hierarchy. In some embodiments, a third network layer (e.g., third network layer 360) may be implemented to increase the radix of a system, such as the system 300A, the system 300C, the system 300E, and/or the system 300F.

The system 300G includes an application layer 310, a first network layer 320, an first optical shuffle box 330, a second network layer 340, a second optical shuffle box 350, and a third network layer 360. The application layer 310, first network layer 320, and optical shuffle box 330 can be the same as or similar to application layers 310, first network layers 320 and optical shuffleboxes 330 as described herein above.

The second network layer 340G can be similar to the first network layer, in that the network devices 345 are configured to receive inputs from the optical shuffle box 330 and provide outputs to a higher layer. This is in contrast to other second network layers 340 described herein, which receive signals from a device (e.g., the optical shuffle box 330) and transmit signals back to the same device (e.g., the optical shuffle box 330).

The second optical shuffle box 350 can be the same as or similar to any of the optical shuffle boxes 330 described herein. As illustrated, the second optical shuffle box 350 is the same as the optical shuffle box 330C, described with reference to FIG. 3C, however, other optical shuffle box designs are considered.

The third network layer 360 can be a top network layer similar to other second network layers 340 described herein. As illustrated, the third network layer 360 includes a network device 364 (such as an optical switch 346 as described with reference to FIG. 3C), which receives signals from the optical shuffle box 350, and provides signals back to the optical shuffle box 350. In some embodiments, the illustrated network device 364 can represent a grouping of multiple network devices.

FIG. 4 is an example block diagram of a transceiver 400, according to some aspects of the disclosure. In embodiments, transceiver 400 is a specially designed electro-optical transceiver configured to operate in one or more of the systems 300A-G of FIGS. 3A-G. The transceiver 400 includes a controller 401 coupled to a transmitter 402 and a receiver 404. The transmitter 402 is coupled between optical ports 410 and electrical ports 420. The receiver 404 is coupled between electrical ports 420 and a demultiplexer 406, which is coupled to the optical ports 410. In some embodiments, the transceiver 400 is an optical transceiver that sends and receives electrical data signals 421 via the electrical ports 420 and that sends and receives optical data signals 413 via the optical ports 410. Additional optical transceivers may be used together in an optical system, such as system 300A-E as described with reference to FIG. 3A-E. In some embodiments, the transceiver 400 is an electro-optical transceiver that receives multiplexed optical data signals 415 via the optical ports 410 (e.g. via parallel fiber connectors) and sends electrical data signals 421 via the electrical ports 420 to electrical connectors (e.g., Multi-Fiber Push-On (MPO), Multi-Fiber Termination Push-On (MTP), etc.) 422. As illustrated, the electrical ports 420 send and receive the electrical data signals 421 on behalf of the transmitter 402 and the receiver 404, depending on the operation of the transceiver 400 at a given time. In alternative embodiments, the electrical ports 420 can have dedicated electrical input ports for the transmitter 402 and dedicated electrical output ports for the receiver 404 (not illustrated).

The optical ports 410 include transmitter (TX) ports, such as transmitter ports 412 and receiver (RX) ports, such as receiver ports 414. Each optical port of the optical ports 410 can be dedicated to either transmit or receive optical data signals in some embodiments. Notably, and in some embodiments, the transceiver 400 includes more transmitter ports 412 than receiver ports 414. In some embodiments, the number of transmitter ports 412 is a multiple of the number of receiver ports 414 and the number of wavelengths in a multiplexed optical data signal received at a respective receiver port. For example, a receiver port 414 may receive a multiplexed optical data signal having four distinct wavelength division multiplexed signals (e.g., separate multiplexed signals). In such an example, the transceiver having a single receiver port can have four corresponding transmitter ports (i.e., four wavelengths*one receiver port=four transmitter ports).

The transmitter ports 412 are coupled to the transmitter 402. The transmitter 402 receives electrical data signals 411 from electrical connectors (EL), such as electrical connectors 422 of the electrical ports 420. The transmitter converts the electrical data signals 411 into optical data signals 413 using one or more optical data signal generators (not illustrated). Each optical data signal 413 generated by the transmitter 402 has a distinct wavelength or wavelength range (e.g., multiple wavelengths within a band of wavelengths). In alternative embodiments, the transmitter 402 generates pairs of optical data signals 413 having the same wavelength or wavelength range. For purposes of discussion, the term wavelength is applied herein to an optical data signal. One skilled in the art would understand that the optical data signal would include modulated light of multiple wavelengths, where the modulation of the light carries data. Accordingly, the term wavelength applied to an optical data signal should be interpreted as a range of wavelengths in embodiments. In an example, the optical data signal 413 connected to the optical port TX1 may have the same wavelength as the optical data signal 413 connected to the optical port TX5. In some embodiments, the transmitter 402 includes an optical data signal generator (e.g., a light emitting diode (LED), a laser, a laser diode, etc.) for each wavelength (λ) or wavelength range generated by the transmitter 402. The optical data signal generators can include, or interact with, one or more light sources. In alternative embodiments, one or more optical data signal generators in the transmitter are configured to generate two or more wavelengths. The transmitter 402 provides the optical data signals 413 at the transmitter ports 412 as respective outputs of the transceiver 400. Since the transceiver 400 does not include a multiplexer on the optical output (e.g., from the transmitter 402), there is no additional optical loss introduced into the optical data signals 413, which can be independently received at an external optical networking component. This is in contrast to transceivers which multiplex optical output signals into a single multiplexed optical signal which is received at a demultiplexer and separated for processing. Thus, by removing the multiplexer and demultiplexer by integrating the transceiver 400 into a network architecture as described herein, the optical loss introduced by the optical multiplexer paired to the optical demultiplexer is removed.

The receiver ports 414 are coupled to the demultiplexer 406. The demultiplexer 406 receives multiplexed optical data signals 415 via the receiver ports 414. The demultiplexer 406 separates the multiplexed optical data signals 415 into demultiplexed optical data signals 417. Each demultiplexed optical data signal can have a distinct wavelength or wavelength range. That is, the demultiplexer 406 can separate the multiplexed optical data signals 415 by wavelength. In alternative embodiments, pairs of the demultiplexed optical data signals 417 can have the same wavelength or wavelength range, as similarly described above with reference to optical data signals 413 generated by the transmitter 402. The demultiplexed optical data signals 417 are converted into electrical data signals 419 at the receiver 404. In embodiments, the receiver 404 includes multiple photodetectors, such as photo diodes. The optical detectors may receive optical data signals and convert the optical data signals into electrical data signals. The electrical data signals 419 are provided as output electrical data signals at the electrical ports 420.

In some embodiments, the electrical ports 420 are coupled to electrical connectors 422. The electrical ports 420 can send and receive electrical data signals 421. In some embodiments, the electrical data signals 421 are sent from the electrical ports 420 to the electrical connectors 422 as electrical data signals 419 generated by the receiver 404. In some embodiments, the electrical data signals 421 are sent from the electrical connectors 422 to the electrical ports 420 as electrical data signals 411 to be transmitted by the transceiver 400.

The controller 401 can cause the transmitter 402 to receive electrical data signals 411 and generate corresponding optical data signals (e.g., the optical data signals 413). Similarly, the controller 401 can cause the receiver 404 coupled to the demultiplexer 406 to receive multiplexed optical data signals 415 and generate corresponding electrical data signals (e.g., the electrical data signals 419). The controller 401 can include suitable software, firmware, and/or hardware to perform the functions of the transmitter 402 and the receiver 404. In some embodiments, the controller 401 can include control logic that causes transmitter logic of the transmitter 402 and/or receiver logic of the receiver 404 to perform one or more operations. For example, the controller 401 may include components for storing one or more data signals in memory. In some embodiments, the controller 401 can cause the transceiver 400 to receive and process electrical and/or optical data signals. In some embodiments, the controller 401 causes the transceiver 400 to receive an incoming data signal and samples the incoming signal to generate samples, such as using an analog-to-digital converter (ADC).

The controller 401 can include multiple processing elements, such as one or more of a transaction layer, a datalink layer, or a physical layer. In one embodiment, the controller 401 may include a memory including executable instructions that is operatively coupled to one or more processing devices (e.g., microprocessors) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally, or alternatively, the controller 401 may comprise hardware, such as an Application-Specific Integrated circuit (ASIC). Other non-limiting examples of the controller 401 include an Integrated Circuit (IC) chip, a CPU, a GPU, a DPU, a microprocessor, a Field-Programmable Gate Array (FPGA), a collection of logic gates or transistors, resistors, capacitors, inductors, diodes, or the like. Some or all of the controller 401 may be provided on a Printed Circuit Board (PCB) or collection of PCBs. It should be appreciated that any appropriate type of electrical component or collection of electrical components may be suitable for inclusion in the controller 401. The controller 401 may send and/or receive signals to and/or from other elements of the transceiver 400 to control the overall operation of the transceiver 400.

In some embodiments, the transceiver 400 can be used in the application layer 310 of FIGS. 3A-G as the transceivers 316, in the first network layer as the transceivers 322 or the transceivers 326, or in the second network layer 340 as the transceivers 342.

FIG. 5 is an example block diagram of a transceiver, according to some aspects of the disclosure. The transceiver 500 includes a controller 501 coupled to a transmitter 502 and a receiver 504. The transmitter 502 and the receiver 504 are respectively coupled between optical ports 510 and electrical ports 520. In some embodiments, the transceiver 500 is a WDM optical transceiver that receives electrical data signals 521 via the electrical ports 520 and transmits non-multiplexed optical data signals 513 via the optical ports 510. The WDM optical transceiver may rely on separate fibers/wavelength at the transmitter and a single fiber with multiplexed wavelengths at the receiver. The transceiver 500 as illustrated, works for network elements with electrical processing, such as electrical switches. In some embodiments, the transceiver 500 is a WDM optical transceiver that receives non-multiplexed optical data signals 517 via the optical ports 510 and sends electrical data signals 521 via the electrical ports 520 to electrical connectors 522. As illustrated, the electrical ports 520 send and receive the electrical data signals 521 on behalf of the transmitter 502 and the receiver 504, depending on the operation of the transceiver 500 at a given time. In alternative embodiments, the electrical ports 520 can have dedicated electrical input ports for the transmitter 502 and dedicated electrical output ports for the receiver 504 (not illustrated). This second type of transceiver uses separate fibers/wavelength at the transmitter and receiver sides, and is used with optical switches.

The optical ports 510 include transmitter (TX) ports, such as transmitter ports 512 and receiver (RX) ports, such as receiver ports 514. Each optical port of the optical ports 510 can be dedicated to either transmit or receive optical data signals. Notably, and in some embodiments, the transceiver 500 includes more transmitter ports 512 than receiver ports 514.

The transmitter ports 512 are coupled to the transmitter 502. The transmitter 502 receives electrical data signals 511 from electrical connectors (EL), such as electrical connectors 522 of the electrical ports 520. The transmitter converts the electrical data signals 511 into non-multiplexed optical data signals 513 using one or more optical data signal generators (not illustrated). Each non-multiplexed optical data signal 513 generated by the transmitter 502 has a distinct wavelength, as similarly described above with reference to FIGS. 3A-G. Since the transceiver 500 does not include a multiplexer on the optical output (e.g., from the transmitter 502), there is no additional optical loss introduced into the optical data signals 513, which can be independently received at an external optical networking component. This is in contrast to transceivers which multiplex optical output signals into a single multiplexed optical signal which is received at a demultiplexer and separated for processing. Thus, by removing the multiplexer and demultiplexer by integrating the transceiver 500 into a network architecture as described herein, the optical loss introduced by the optical multiplexer paired to the optical demultiplexer is removed.

The receiver ports 514 are coupled to the receiver 504. The receiver 504 receives non-multiplexed optical data signals 517 from the receiver ports 514. The receiver converts the non-multiplexed optical data signals 517 into electrical data signals 519 using one or more photodetector diodes (not illustrated), or the like. For example, the receiver 504 can use photodetector diodes or the like to detect an optical data signal of a particular wavelength. Each electrical data signal 519 generated by the receiver 504 corresponds to a distinct wavelength of the non-multiplexed optical data signals 517, as similarly described above with reference to FIGS. 3A-G.

In some embodiments, the electrical ports 520 are coupled to electrical connectors 522. The electrical ports 520 and the electrical data signals can send and receive electrical data signals 521. In some embodiments, the electrical data signals 521 are sent from the electrical ports 520 to the electrical connectors 522 as electrical data signals 519 generated by the receiver 504. In some embodiments, the electrical data signals 521 are sent from the electrical connectors 522 to the electrical ports 520 as electrical data signals 511 to be transmitted by the transceiver 500.

The controller 501 is coupled to the transmitter 502 and the receiver 504, respectively. The controller 501 can cause the transmitter 502 to receive electrical data signals 511 and generate corresponding optical data signals (e.g., the non-multiplexed optical data signals 513). Similarly, the controller 501 can cause the receiver 504 to receive non-multiplexed optical data signals 517 and generate corresponding electrical data signals (e.g., the electrical data signals 519). The controller 501 can include suitable software, firmware, and/or hardware to perform the functions of the transmitter 502 and the receiver 504. In some embodiments, the controller 501 can include control logic that causes transmitter logic of the transmitter 502 and/or receiver logic of the receiver 504 to perform one or more operations. For example, the controller 501 may include components for storing one or more data signals in memory. In some embodiments, the controller 501 can cause the transceiver 500 to receive and process electrical and/or optical data signals..

In some embodiments, the transceiver 500 can be used in the application layer 310 of FIGS. 3A-G as the transceiver 316, in the first network layer 320 as the transceiver 322 or the transceiver 326, or in the second network layer 340 as the transceiver 342.

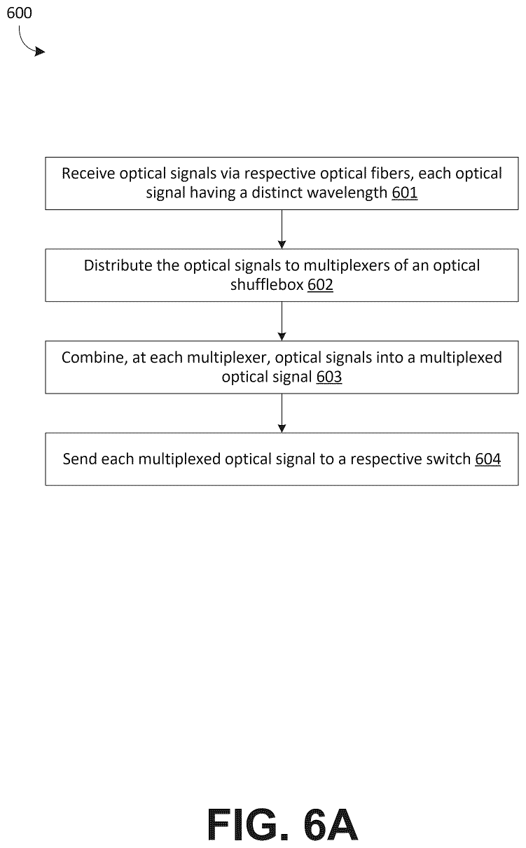

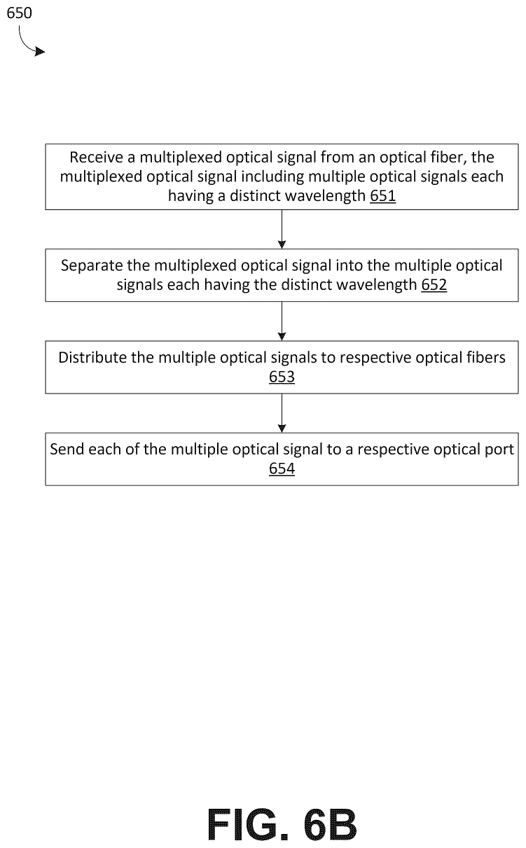

FIG. 6A is a flow diagram of an example method 600A for wavelength division multiplexing (WDM) optical shuffle box, according to aspects of the disclosure. The method 600A can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, a portion of the method 600 is performed by the optical shuffle box 330A-G, other elements of the system 300A-G, or control logic of one or more components of the system 300A-G of the FIGS. 3A-3G. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 601, the control logic receives an optical data signal via respective optical fibers. In some embodiments, each optical fiber carries an optical data signal having a distinct wavelength. The optical data signals can be one or more of a plurality of optical data signals and the optical fibers can similarly be a respective one or more of a plurality of optical fibers. In some embodiments, an optical data signal of a distinct wavelength is received via a single optical fiber.

At operation 602, the control logic distributes the optical data signals to multiplexers of an optical shuffle box. In some embodiments, each multiplexer is to receive an optical data signal originating from a first layer of switches (e.g., first network layer 320 as described with reference to FIG. 1).

At operation 603, the control logic combines, at each multiplexer, optical data signals into a multiplexed optical data signal. Optical data signals received at a particular multiplexer can be combined into a respective multiplexed optical data signal by the particular multiplexer. In some embodiments, a respective multiplexed optical data signal is to be generated by a plurality of multiplexers (e.g., a plurality of multiplexed optical data signals).

At operation 604, the control logic sends each multiplexed optical data signal to a respective switch (e.g., a second layer of switches, such as second network layer 340 140 as described with reference to FIG. 1). In some embodiments, as described above, the second network layer 340 are electrical switches, and the optical data signals are converted to electrical data signals in between the multiplexers and the respective switches. In alternative embodiments, as described above, the second network layer 340 are optical switches, and the optical data signals received at the optical switch are sent back to other second network layer 340, based on the configuration of the optical switch.

FIG. 6B is a flow diagram of an example method 650 for wavelength division multiplexing (WDM) optical shuffle box, according to aspects of the disclosure. The method 650 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, a portion of the method 650 is performed by the optical shuffle box 330A-G, other elements of the system 300A-G, or control logic of one or more components of the system 300A-G of the FIGS. 3A-3G. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 651, the control logic receives a multiplexed optical signal from an optical fiber. The multiplexed optical signal includes multiple optical signals each having a distinct wavelength. In some embodiments, the optical signal is received at a multiplex optical port.

At operation 652, the control logic separates the multiplexed optical signal into the multiple optical signals each having the distinct wavelength. In some embodiments, a multiplexer or demultiplexer can perform this operation.

At operation 653, the control logic distributes the multiple optical signals to respective optical fibers.

At operation 654, the control logic sends the multiple optical signals to a respective optical port.

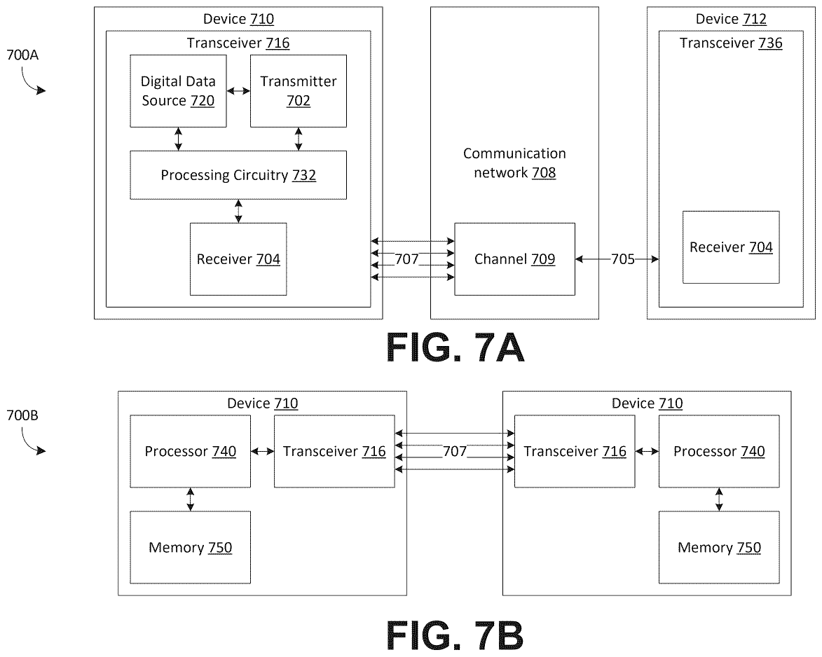

FIG. 7A illustrates an example communication system 700A, according to some aspects of the disclosure. The system 700A includes a device 710, a communication network 708 including a communication channel 709, and a device 712. In at least one embodiment, devices 710 and 712 are two end-point devices in a computing system, such as a central processing unit (CPU) or graphics processing unit (GPU).

In at least one embodiment, devices 710 and 712 are two servers. In at least one example embodiment, devices 710 and 712 correspond to one or more of a Personal Computer (PC), a laptop, a tablet, a smartphone, a server, a collection of servers, or the like. In some embodiments, the devices 710 and 712 may correspond to any appropriate type of device that communicates with other devices connected to a common type of communication network 108. In embodiments, the transmitter 702 of the device 710 can correspond to transmitters of a graphics processing unit (GPU), a switch (e.g., a high-speed network switch), a network adapter, a central processing unit (CPU), a data processing unit (DPU), etc. In embodiments, each of devices 710 and 712 may comprise one or more processing circuits, as detailed above; the processing circuits may comprise firmware that is loaded onto the processing circuits during production of the device 710 and 712.

According to embodiments, the receiver 704 of devices 710 or 712 may correspond to a GPU, a switch (e.g., a high-speed network switch), a network adapter, a CPU, a memory device, an input/output (I/O) device, other peripheral devices or components on a system-on-chip (SoC), or other devices and components at which a signal is received or measured, etc. As another specific but non-limiting example, the devices 710 and 712 may correspond to servers offering information resources, services, and/or applications to user devices, client devices, or other hosts in the system 700A.

In one example, devices 710 and 712 may correspond to network devices such as switches, network adapters, or data processing units (DPUs). The device 710 includes a transceiver 716 for sending and receiving signals, for example, data signals. The data signals may be digital or optical signals modulated with data or other suitable signals for carrying data.

The transceiver 716 may include a digital data source 720, a transmitter 702, a receiver 704, and processing circuitry 732 that controls the transceiver 716. The digital data source 720 may include suitable hardware and/or software for outputting data in a digital format (e.g., in binary code and/or thermometer code). The digital data output by the digital data source 720 may be retrieved from memory (not illustrated) or generated according to input (e.g., user input).

The transmitter 702 includes suitable software and/or hardware for receiving digital data from the digital data source 720 and outputting data signals according to the digital data for transmission over the communication network 708 to a receiver 704 of device 712.

The receiver 704 of devices 710 and 712 may include suitable hardware and/or software for receiving signals, such as data signals from the communication network 708. For example, the receiver 704 may include components for receiving optical signals.

The processing circuitry 732 may comprise software, hardware, or a combination thereof. For example, the processing circuitry 732 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally, or alternatively, the processing circuitry 732 may comprise hardware, such as an application-specific integrated circuit (ASIC). Other non-limiting examples of the processing circuitry 732 include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like.

Some or all of the processing circuitry 732 may be provided on a Printed Circuit Board (PCB) or collection of PCBs. It should be appreciated that any appropriate type of electrical component or collection of electrical components may be suitable for inclusion in the processing circuitry 732. The processing circuitry 732 may send and/or receive signals to and/or from other elements of the transceiver 716 to control the overall operation of the transceiver.

In embodiments, each of devices 710 and 712 may comprise one or more processing circuits, as detailed above; the processing circuits may comprise FW, that is loaded according to the techniques described above.

In embodiments, the devices 710 can be connected via a parallel fiber interface 707 to a channel 709 of the communication network. That is, the transmitter 702 can output multiple optical signals on a parallel fiber interface 707. The channel 709 can include an optical shuffle box as described herein above, and can be received by the transceiver 736 via a single optical fiber 705, as illustrated.

FIG. 7B is a block diagram that schematically illustrates a communication system 700B, according to some aspects of the disclosure. The communication system 700B comprises two devices 710 that are configured to exchange electronic communications (e.g., packet-based communications) with one another over a parallel fiber interface 707. The parallel fiber interface 707 may include or be part of a communication network 708. In some embodiments, signals are sent via the parallel fiber interface 707 by a transceiver (e.g., transceiver 716 or transceiver 736) into an optical shuffle box, which provides an output of a single optical fiber, such as single optical fiber 705 of FIG. 7A.

Illustratively, but without limitation, the communication devices 710 may correspond to network devices, such as network device 104 or network device 112 of FIG. 1. As such, the communication devices 710 may correspond to any type of device that becomes part of or is connected with a communication network. Examples of suitable devices that may act or operate like a device 710 as described herein include, without limitation, one or more of a Personal Computer (PC), a laptop, a tablet, a smartphone, a server, a collection of servers, a networking card, an edge router, a switch, Network Interface Cards, a Top of Rack (ToR) switch, a server blade, or the like. As will be described in further detail herein, the device 710 may include a transceiver 716, a processor 740, and memory 750. The transceiver 716 may include hardware that enables communications over the parallel fiber interface 707 whereas the processor 740 and memory 750 may include components that enable the device 710 to provide a desired functionality or perform certain functions.

The parallel fiber interface 707 may traverse a datacenter or any type of communication network (whether trusted or untrusted). Examples of a communication network that may be used to connect communication devices 710 and support the parallel fiber interface 707 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the communication devices 710 using optical signals. In this case, the communication devices 710 and the communication network may include waveguides (e.g., optical fibers) that carry the optical signals.

The transceiver 716 may include electrical components, optical components, or combinations thereof that facilitate communications over the parallel fiber interface 707. The components of the transceiver 716 may be coupled to the processor 740. Data, electrical signals, or the like may be exchanged between the transceiver 716 and processor 740. In some embodiments, the processor 740 may utilize the transceiver 716 to transmit data packets to a remote device 710 via the parallel fiber interface 707. Similarly, data packets received at a transceiver 716 may be decoded by the transceiver 716 and provided to the processor 740 coupled therewith. In some embodiments, the processor 740 may utilize instructions stored in memory 750 to facilitate operations of the device 710.

The processor 740 may be or include one or more of an Integrated Circuit (IC) chip, a microprocessor, a Central Processing Unit (CPU), a Graphics Processing Unit (GPU), a Data Processing Unit (DPU), a Field Programmable Gate Array (FPGA), an Application Specific Integrated Circuit (ASIC), combinations thereof, and the like.

The memory 750 may include any number of memory devices, any type of memory device, any combination of different types of memory devices, etc. As an example, the memory 750 may include Random Access Memory (RAM), Read Only Memory (ROM), flash memory, Electronically-Erasable Programmable ROM (EEPROM), Dynamic RAM (DRAM), buffer memory, combinations thereof, and the like.

In embodiments, each of communication devices 710 may comprise one or more processing circuits, as detailed above; the processing circuits may comprise FW, that is loaded according to the techniques described above.

### Computing Systems

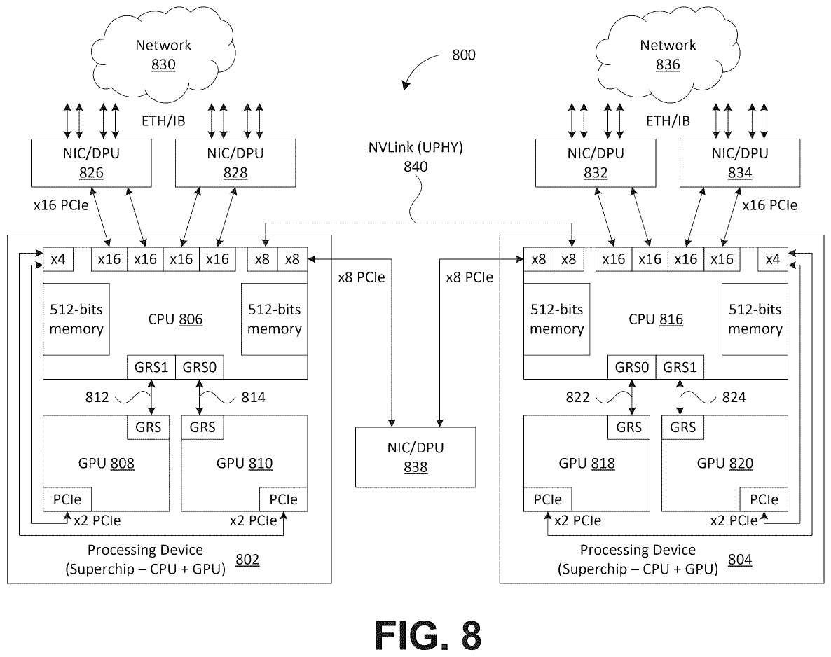

FIG. 8 is a block diagram of a computing system 800 having two processing devices coupled to each other and multiple networks according to some aspects of the disclosure. The computing system 800 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a NIC or DPU to ensure efficient data transfer across the computing system 800.

The coupling of processing devices through NVLink allows for seamless data exchange and parallel processing, enhancing overall computational performance. Additionally, these processing devices are connected to multiple networks through one or more NICs or DPUs, enabling the system to handle complex, multi-network tasks with high bandwidth and low latency. This configuration makes the computing system 800 highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs. An example architecture of a multi-GPU architecture is illustrated in FIG. 8.

As illustrated in FIG. 8, the computing system 800 includes a processing device 802 with a multi-GPU architecture. In particular, the processing device 802 includes a CPU 806, a GPU 808, and a GPU 810. The CPU 806 can be coupled to the GPU 808 via an die-to-die (D2D) or chip-to-chip (C2C) interconnect 812, such as a Ground-Referenced Signaling interconnect (GRS interconnect). The CPU 806 can be coupled to the GPU 810 via a D2D or C2C interconnect 814. The CPU 806 can also couple to the GPU 808 and GPU 810 via PCIe interconnects. The CPU 806 can be coupled to one or more NICs or DPUs, which are coupled to one or more networks. For example, as illustrated in FIG. 8, the CPU 806 is coupled to a first NIC/DPU 826, which is coupled to a network 830. The CPU 806 is also coupled to a second NIC/DPU 828, which is coupled to the network 830. The NIC/DPU 826 and NIC/DPU 828 can be coupled to the network 830 over Ethernet (ETH) or InfiniBand (IB) connections.

The computing system 800 also includes a processing device 804 with a multi-GPU architecture. In particular, the processing device 804 includes a CPU 816, a GPU 818, and a GPU 820. The CPU 816 can be coupled to the GPU 818 via an D2D or C2C interconnect 822. The CPU 816 can be coupled to the GPU 820 via a D2D or C2C interconnect 824. The CPU 816 can also couple to the GPU 818 and GPU 820 via PCIe interconnects. The CPU 816 can be coupled to one or more NICs or DPUs, which are coupled to one or more networks. For example, as illustrated in FIG. 8, the CPU 816 is coupled to a first NIC/DPU 832, which is coupled to a network 836. The CPU 816 is also coupled to a second NIC/DPU 834, which is coupled to the network 836. The NIC/DPU 832 and NIC/DPU 834 can be coupled to the network 836 over Ethernet (ETH) or InfiniBand (IB) connections.

In at least one embodiment, the processing device 802 and the processing device 804 can communication with each other via a NIC/DPU 838, such as over PCIe interconnects. The processing device 802 and processing device 804 can also communicate with each other over a high-bandwidth communication interconnects 840, such as an NVLink interconnect or other high-speed interconnects.

The computing system 800 includes various types of interconnects. In some embodiments, one or more of the interconnects includes one or more of the transceiver 400 or the transceiver 500 described above with reference to FIG. 4 or FIG. 5, respectively, and/or an optical shuffle box 330A-E as described above with reference to FIGS. 3A-G.

In at least one embodiment, the computing system 800 is used for high-speed network communication and includes a processing unit (e.g., CPU 806, GPU 808, GPU 808, CPU 816, GPU 818, GPU 820, NIC/DPU 826, NIC/DPU 828, NIC/DPU 832, NIC/DPU 834, or NIC/DPU 838), and a network interface coupled to the processing unit. The network interface includes a transceiver circuit operatively coupled to a controller.

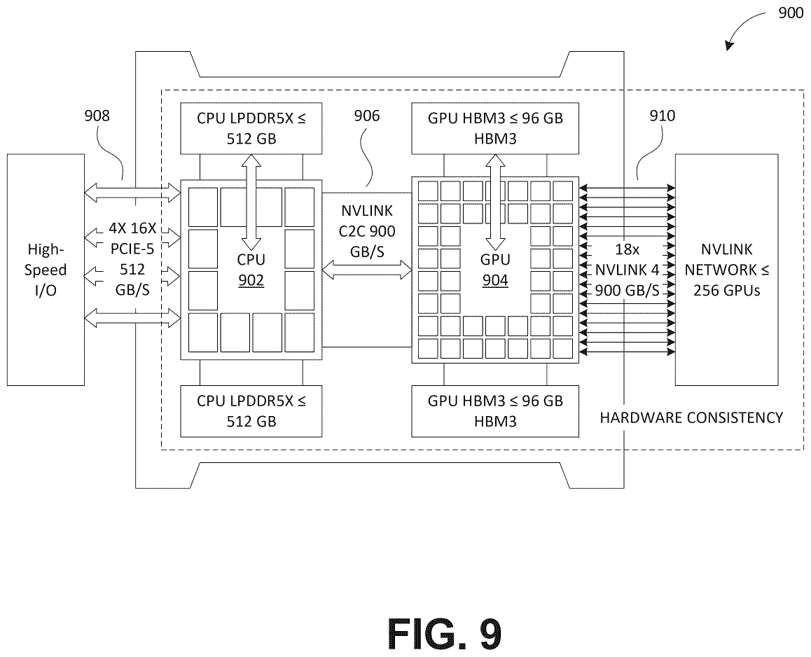

FIG. 9 is a block diagram of a computing system 900 having a CPU 902 and a GPU 904 in a single integrated circuit according to at least one embodiment. The computing system 900 can be a highly integrated design where a CPU 902 and GPU 904 are connected on a single integrated circuit, utilizing an NVLink C2C (Chip-to-Chip) interconnect 906 to enable fast, low-latency communication between the two processing units. This close integration allows for efficient data transfer and parallel processing between the CPU 902 and GPU 904, optimizing performance for complex computational tasks. The GPU elements within the computing system 900 can be interconnected using an NVLink network, allowing for scalability to include multiple GPU elements (e.g., up to 256 as illustrated), creating a powerful, unified processing environment ideal for large-scale AI, ML, and high-performance computing applications. The NVLink network can be a GPU fabric of high-bandwidth communication interconnects 910. Additionally, the computing system 900 can be designed to interface with a high-speed I/O through PCIe interconnects 908, ensuring rapid data transfer to and from external devices, further enhancing the system's capabilities in handling data-intensive tasks and providing robust connectivity to peripheral components. It should be noted that the C2C interconnects 906 can be considered D2D interconnects since the CPU 902 and the GPU 904 are located on the same integrated circuit. The integrated circuit can include CPU memory (also referred to as main memory) and GPU memory, which are accessible by the CPU 902 and the GPU 904, respectively, over high-speed interconnects. The computing system 900 can bring together performance of the GPU 904 with the versatility of the CPU 902. The CPU 902 can be connected with a high-bandwidth and memory coherent C2C interconnects 906 in a single integrated circuit. The computing system 900 can support a link switch system.

The computing system 900 includes various types of interconnects. Each of the interconnects includes one or more of the transceiver 400 or the transceiver 500 described above with reference to FIG. 4 or FIG. 5, respectively, or an optical shuffle box 330A-E as described above with reference to FIGS. 3A-G.

In at least one embodiment, the computing system 900 is used for high-speed network communication and includes a processing unit (e.g., CPU 902, GPU 904, NVLink network), and a network interface coupled to the processing unit. The network interface can include the controller as described above with respect to FIG. 8.

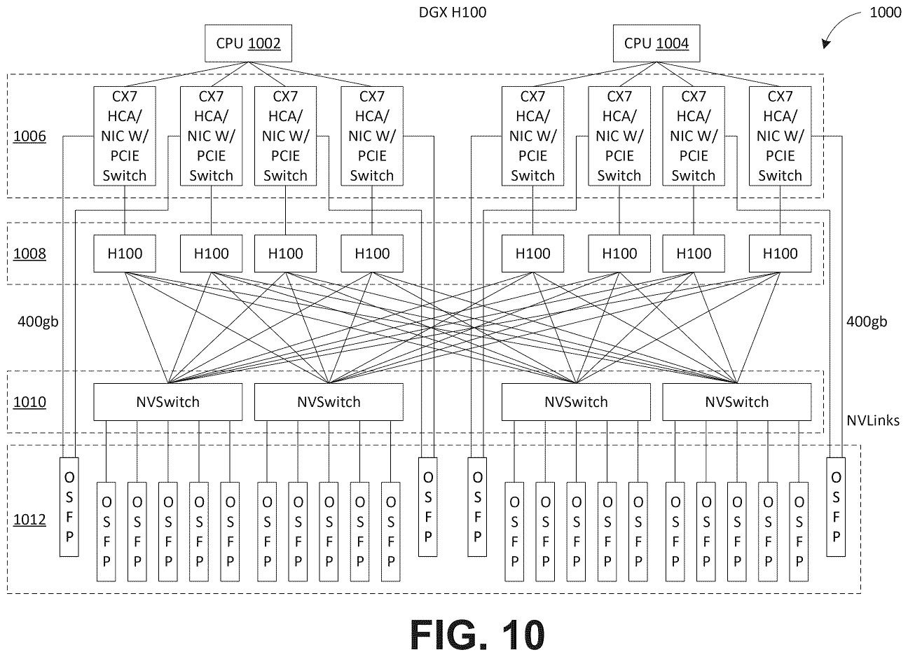

FIG. 10 is a block diagram of a computing system 1000 having tensor core GPUs 1008 according to at least one embodiment. The computing system 1000 can be an NVIDIA© DGX H100 system which is a high-performance computing platform designed to meet the demands of AI, ML, and deep learning (DL) workloads. The computing system 1000 can include multiple tensor core GPUs 1008 (e.g., NVIDIA H100 Tensor Core GPUs). The tensor core GPUs 1008 can each be one of the integrated circuits described above with respect to FIG. 8. The tensor core GPUs 1008 can be optimized for AI/ML/DL applications, offering exceptional performance for deep learning training, inference, and high-performance computing tasks. The tensor core GPUs 1008 within the computing system 1000 are interconnected using high-speed communication interfaces like NVLinks, enabling rapid data transfer between them, which is crucial for handling large-scale AI models and datasets with low latency. This computing system 1000 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1008, the computing system 1000 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1008 for their specific applications. The computing system 1000 is ideally suited for large-scale AI model training, real-time inference, scientific simulations, data analytics, and other compute-intensive tasks that require massive parallel processing power.

The tensor core GPUs 1008 can be coupled to multiple CPUs, such as CPU 1002 and CPU 1004, using switches 1006 (e.g., CX7 HCA/NIC with PCIe switch). The tensor core GPUs 1008 can be coupled to each other via switches 1010 (e.g., NV-Switches). The switches 1006 and switches 1010 can be coupled to high-speed transceiver modules 1012. The high-speed transceiver modules 1012 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 800 Gbps per module, with future capabilities extending to 1600 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1000 remains capable of meeting increasing data demands and can be upgraded to support future advancements in network speeds, thus contributing to the system's overall performance and scalability.

In at least one embodiment, the computing system 1000 can be considered a data-network configuration with full-bandwidth intra-server NVLinks. In this example, all eight tensor core GPUs 1008 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1008 can half-subscribe eighteen NVLinks to GPUs in other servers. Four tensor core GPUs 1008 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1008 can independently transfer data, using Remote Direct Memory Access (RDMA) protocol, over its own dedicated switch (e.g., 400 Gb/s HCA/NIC) in an multi-rail InfiniBand/Ethernet configuration. In this example, 1000 GBps of aggregate full-duplex to non-NVLink network devices.

The computing system 1000 includes various types of interconnects. One or more of the interconnects may include one or more of the transceiver 400 or the transceiver 500 described above with reference to FIG. 4 or FIG. 5, respectively, and/or an optical shuffle box 330A-E as described above with reference to FIGS. 3A-G. Accordingly, in embodiments optical shuffle boxes as described herein may be used to connect GPUs 1008 and switches 1010, for example.

In at least one embodiment, the computing system 1000 is used for high-speed network communication and includes a processing unit (e.g., CPU 1002, CPU 1002, switches 1006, tensor core GPUs 1008, switches 1010, high-speed transceiver modules 1012), and a network interface coupled to the processing unit. The network interface can the controller as described above with respect to FIG. 8.

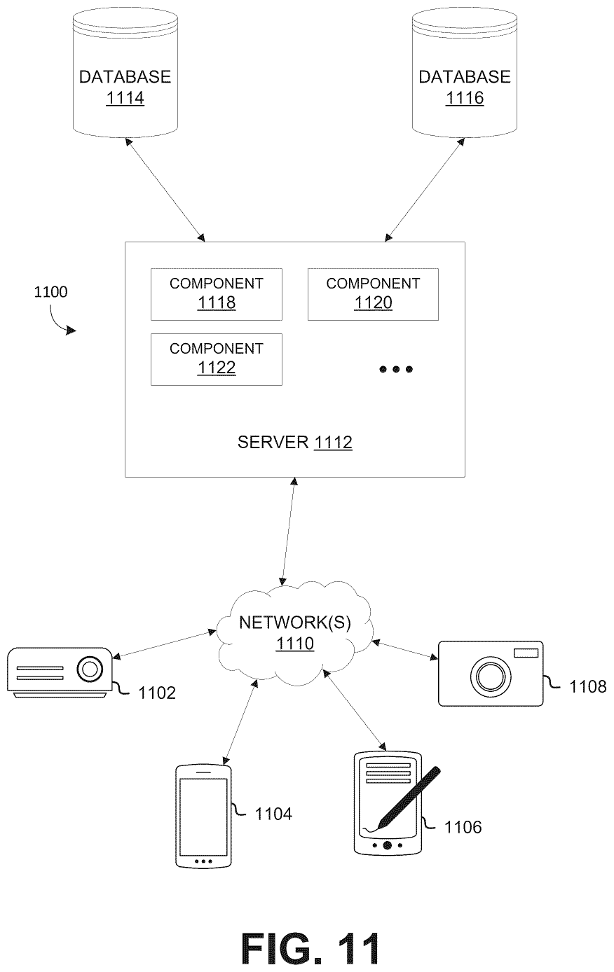

FIG. 11 illustrates a distributed system 1100, in accordance with at least some embodiments. In at least one embodiment, distributed system 1100 includes one or more client computing devices 1102, 1104, 1106, and 1108, which are configured to execute and operate a client application such as a web browser, proprietary client, and/or variations thereof over one or more networks 1110. In at least one embodiment, server 1112 may be communicatively coupled with remote client computing devices 1102, 1104, 1106, and 1108 via network 1110. In some embodiments, server 1112 includes a PCB having one or more power connectors as described herein above. In some embodiments, server 1112 receives electrical power via a power delivery system as described herein above.

In at least one embodiment, server 1112 may be adapted to run one or more services or software applications such as services and applications that may manage session activity of single sign-on (SSO) access across multiple data centers. In at least one embodiment, server 1112 may also provide other services or software applications can include non-virtual and virtual environments. In at least one embodiment, these services may be offered as web-based or cloud services or under a Software as a Service (SaaS) model to users of client computing devices 1102, 1104, 1106, and/or 1108. In at least one embodiment, users operating client computing devices 1102, 1104, 1106, and/or 1108 may in turn utilize one or more client applications to interact with server 1112 to utilize services provided by these components.

In at least one embodiment, software components 1118, 1120 and 1122 of system 1100 are implemented on server 1112. In at least one embodiment, one or more components of system 1100 and/or services provided by these components may also be implemented by one or more of client computing devices 1102, 1104, 1106, and/or 1108. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 1100. The embodiment shown in FIG. 11 is thus one example of a distributed system for implementing an embodiment system and is not intended to be limiting.

In at least one embodiment, client computing devices 1102, 1104, 1106, and/or 1108 may include various types of computing systems. In at least one embodiment, a client computing device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially-available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (e.g., a Microsoft Xbox gaming console with or without a Kinect® gesture input device), and/or a personal messaging device, capable of communicating over networks 1110. Although distributed system 1100 in FIG. 11 is shown with four client computing devices, any number of client computing devices may be supported. Other devices, such as devices with sensors, etc., may interact with server 1112.

In at least one embodiment, networks 1110 in distributed system 1100 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, networks 1110 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

In at least one embodiment, server 1112 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 1112 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 1112 using software defined networking. In at least one embodiment, server 1112 may be adapted to run one or more services or software applications.

In at least one embodiment, server 1112 may run any operating system, as well as any commercially available server operating system. In at least one embodiment, server 1112 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 1112 may include one or more applications to analyze and consolidate data feeds and/or event updates received from users of client computing devices 1102, 1104, 1106, and 1108. In at least one embodiment, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and/or variations thereof. In at least one embodiment, server 1112 may also include one or more applications to display data feeds and/or real-time events via one or more display devices of client computing devices 1102, 1104, 1106, and 1108.

In at least one embodiment, distributed system 1100 may also include one or more databases 1114 and 1116. In at least one embodiment, databases may provide a mechanism for storing information such as user interactions information, usage patterns information, adaptation rules information, and other information. In at least one embodiment, databases 1114 and 1116 may reside in a variety of locations. In at least one embodiment, one or more of databases 1114 and 1116 may reside on a non-transitory storage medium local to (and/or resident in) server 1112. In at least one embodiment, databases 1114 and 1116 may be remote from server 1112 and in communication with server 1112 via a network-based or dedicated connection. In at least one embodiment, databases 1114 and 1116 may reside in a storage-area network (SAN). In at least one embodiment, any necessary files for performing functions attributed to server 1112 may be stored locally on server 1112 and/or remotely, as appropriate. In at least one embodiment, databases 1114 and 1116 may include relational databases, such as databases that are adapted to store, update, and retrieve data in response to SQL-formatted commands.

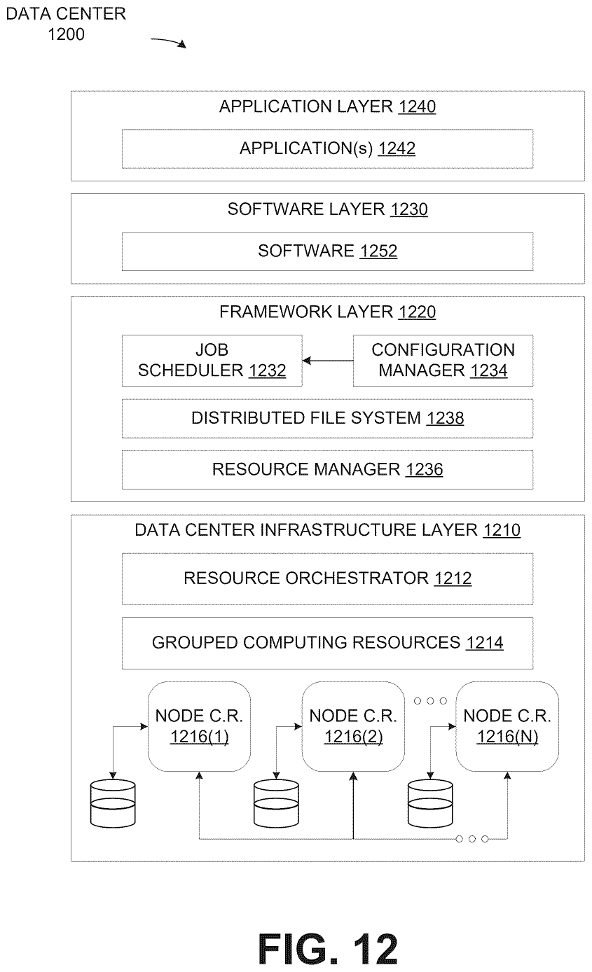

FIG. 12 illustrates an exemplary data center 1200, in accordance with at least some embodiments. In at least one embodiment, data center 1200 includes, without limitation, a data center infrastructure layer 1210, a framework layer 1220, a software layer 1230 and an application layer 1240.

In at least one embodiment, as shown in FIG. 12, data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R. s 1216(1)-216(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1216(1)-1216(N) may be a server having one or more of above-mentioned computing resources.

In at least one embodiment, grouped computing resources 1214 may include separate groupings of node C.R.s housed within one or more racks (not shown), or many racks housed in data centers at various geographical locations (also not shown). Separate groupings of node C.R.s within grouped computing resources 1214 may include grouped compute, network, memory or storage resources that may be configured or allocated to support one or more workloads. In at least one embodiment, several node C.R. s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 1212 may configure or otherwise control one or more node C.R.s 1216(1)-1216(N) and/or grouped computing resources 1214. In at least one embodiment, resource orchestrator 1212 may include a software design infrastructure (“SDI”) management entity for data center 1200. In at least one embodiment, resource orchestrator 1212 may include hardware, software or some combination thereof.

In at least one embodiment, as shown in FIG. 12, framework layer 1220 includes, without limitation, a job scheduler 1232, a configuration manager 1234, a resource manager 1236 and a distributed file system 1238. In at least one embodiment, framework layer 1220 may include a framework to support software 1252 of software layer 1230 and/or one or more applications 1242 of application layer 1240. In at least one embodiment, software 1252 or applications 1242 may respectively include web-based service software or applications, such as those provided by Amazon Web Services, Google Cloud and Microsoft Azure. In at least one embodiment, framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1232 may include a Spark driver to facilitate scheduling of workloads supported by various layers of data center 1200. In at least one embodiment, configuration manager 1234 may be capable of configuring different layers such as software layer 1230 and framework layer 1220, including Spark and distributed file system 1238 for supporting large-scale data processing. In at least one embodiment, resource manager 1236 may be capable of managing clustered or grouped computing resources mapped to or allocated for support of distributed file system 1238 and job scheduler 1232. In at least one embodiment, clustered or grouped computing resources may include grouped computing resource 1214 at data center infrastructure layer 1210. In at least one embodiment, resource manager 1236 may coordinate with resource orchestrator 1212 to manage these mapped or allocated computing resources.

In at least one embodiment, software 1252 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, applications 1242 included in application layer 1240 may include one or more types of applications used by at least portions of node C.R.s 1216(1)-1216(N), grouped computing resources 1214, and/or distributed file system 1238 of framework layer 1220. In at least one or more types of applications may include, without limitation, CUDA applications, 5G network applications, artificial intelligence application, data center applications, and/or variations thereof.

In at least one embodiment, any of configuration manager 1234, resource manager 1236, and resource orchestrator 1212 may implement any number and type of self-modifying actions based on any amount and type of data acquired in any technically feasible fashion. In at least one embodiment, self-modifying actions may relieve a data center operator of data center 1200 from making possibly bad configuration decisions and possibly avoiding underutilized and/or poor performing portions of a data center.

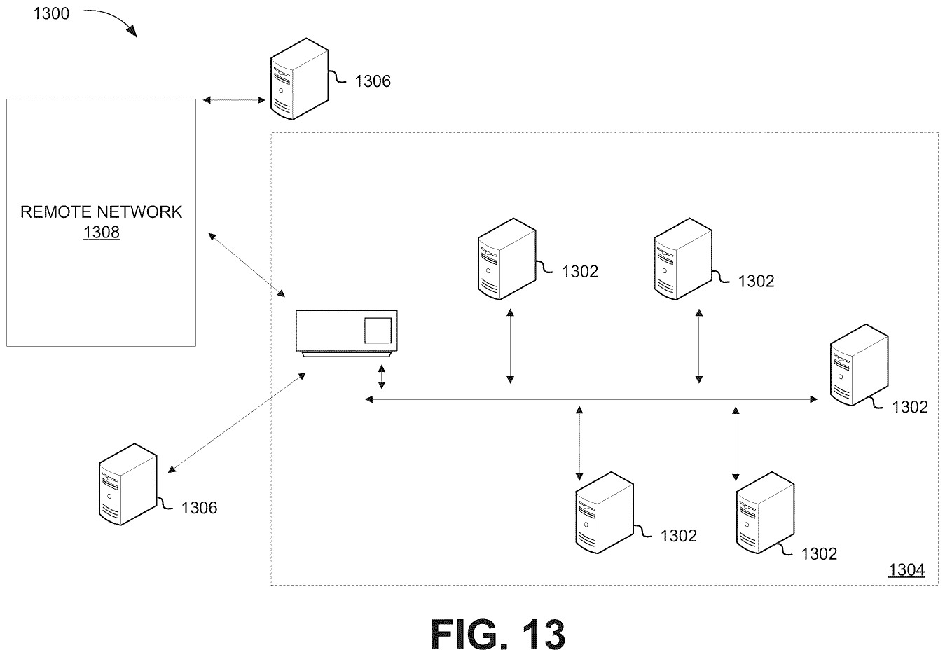

FIG. 13 illustrates a system 1300 that includes client-server network 1304 formed by a plurality of network server computers 1302 which are interlinked, in accordance with at least one embodiment. In at least one embodiment, each network server computer 1302 stores data accessible to other network server computers 1302 and to client computers 1306 and networks 1308 which link into a wide area network 1304. In at least one embodiment, configuration of a client-server network 1304 may change over time as client computers 1306 and one or more networks 1308 connect and disconnect from a network 1304, and as one or more trunk line server computers 1302 are added or removed from a network 1304. In at least one embodiment, when a client computer 1306 and a network 1308 are connected with network server computers 1302, client-server network includes such client computer 1306 and network 1308. In at least one embodiment, the term computer includes any device or machine capable of accepting data, applying prescribed processes to data, and supplying results of processes.

In at least one embodiment, client-server network 1304 stores information which is accessible to network server computers 1302, remote networks 1308 and client computers 1306. In at least one embodiment, network server computers 1302 are formed by main frame computers minicomputers, and/or microcomputers having one or more processors each. In at least one embodiment, server computers 1302 are linked together by wired and/or wireless transfer media, such as conductive wire, fiber optic cable, and/or microwave transmission media, satellite transmission media or other conductive, optic or electromagnetic wave transmission media. In at least one embodiment, client computers 1306 access a network server computer 1302 by a similar wired or a wireless transfer medium. In at least one embodiment, a client computer 1306 may link into a client-server network 1304 using a modem and a standard telephone communication network. In at least one embodiment, alternative carrier systems such as cable and satellite communication systems also may be used to link into client-server network 1304. In at least one embodiment, other private or time-shared carrier systems may be used. In at least one embodiment, network 1304 is a global information network, such as the Internet. In at least one embodiment, network is a private intranet using similar protocols as the Internet, but with added security measures and restricted access controls. In at least one embodiment, network 1304 is a private, or semi-private network using proprietary communication protocols.

In at least one embodiment, client computer 1306 is any end user computer, and may also be a mainframe computer, mini-computer or microcomputer having one or more microprocessors. In at least one embodiment, server computer 1302 may at times function as a client computer accessing another server computer 1302. In at least one embodiment, remote network 1308 may be a local area network, a network added into a wide area network through an independent service provider (ISP) for the Internet, or another group of computers interconnected by wired or wireless transfer media having a configuration which is either fixed or changing over time. In at least one embodiment, client computers 1306 may link into and access a network 1304 independently or through a remote network 1308.

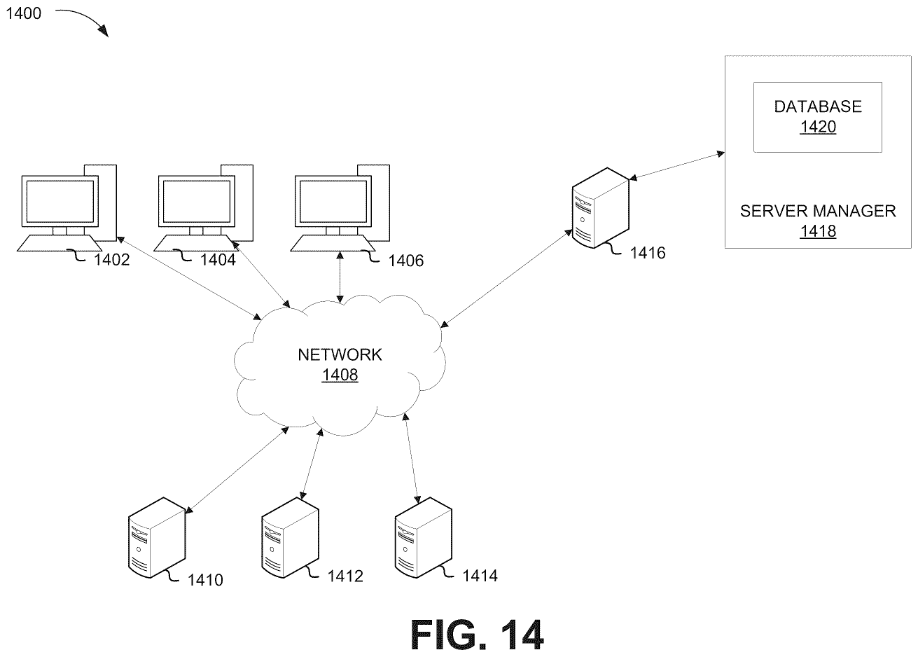

FIG. 14 illustrates a system 1400 including a computer network 1408 connecting one or more computing machines, in accordance with at least some embodiments. In at least one embodiment, network 1408 may be any type of electronically connected group of computers including, for instance, the following networks: Internet, Intranet, Local Area Networks (LAN), Wide Area Networks (WAN) or an interconnected combination of these network types. In at least one embodiment, connectivity within a network 1408 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 1408 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 1408 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (e.g. www. site. com) which maps to an IP address of a network server.

In at least one embodiment, a plurality of clients 1402, 1404, and 1406 are connected to a network 1408 via respective communication links. In at least one embodiment, each of these clients may access a network 1408 via any desired form of communication, such as via a dial-up modem connection, cable link, a digital subscriber line (DSL), wireless or satellite link, or any other form of communication. In at least one embodiment, each client may communicate using any machine that is compatible with a network 1408, such as a personal computer (PC), work station, dedicated terminal, personal data assistant (PDA), or other similar equipment. In at least one embodiment, clients 1402, 1404, and 1406 may or may not be located in a same geographical area.

In at least one embodiment, a plurality of servers 1410, 1412, and 1414 are connected to a network 1408 to serve clients that are in communication with a network 1408. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 1410, 1412, 1414 run application programs that respond to client commands. In at least one embodiment, server 1410 may run a web server application for responding to client requests for HTML pages and may also run a mail server application for receiving and routing electronic mail. In at least one embodiment, other application programs, such as an FTP server or a media server for streaming audio/video data to clients may also be running on a server 1410. In at least one embodiment, different servers may be dedicated to performing different tasks. In at least one embodiment, server 1410 may be a dedicated web server that manages resources relating to web sites for various users, whereas a server 1412 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 1410, 1412, 1414 are under control of a web hosting provider in a business of maintaining and delivering third party content over a network 1408.

In at least one embodiment, web hosting providers deliver services to two different types of clients. In at least one embodiment, one type, which may be referred to as a browser, requests content from servers 1410, 1412, 1414 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 1416 is in communication with a network 1408 via a communication link. In at least one embodiment, intranet server 1416 is in communication with a server manager 1418. In at least one embodiment, server manager 1418 comprises a database of an application program configuration parameters which are being utilized in servers 1410, 1412, 1414. In at least one embodiment, users modify a database 1420 via an intranet 1416, and a server manager 1418 interacts with servers 1410, 1412, 1414 to modify application program parameters so that they match a content of a database. In at least one embodiment, a user logs onto an intranet server 1416 by connecting to an intranet 1416 via client 1402 and entering authentication information, such as a username and password.

In at least one embodiment, when a user wishes to sign up for new service or modify an existing service, an intranet server 1416 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 1416 updates a database 1420. In at least one embodiment, server manager 1418 forwards this information to an appropriate server, and a new parameter is used during application program operation. In at least one embodiment, an intranet server 1416 is configured to provide users with access to configuration parameters of hosted network resources (e.g., web pages, email, FTP sites, media sites, etc.), for which a user has contracted with a web hosting service provider.

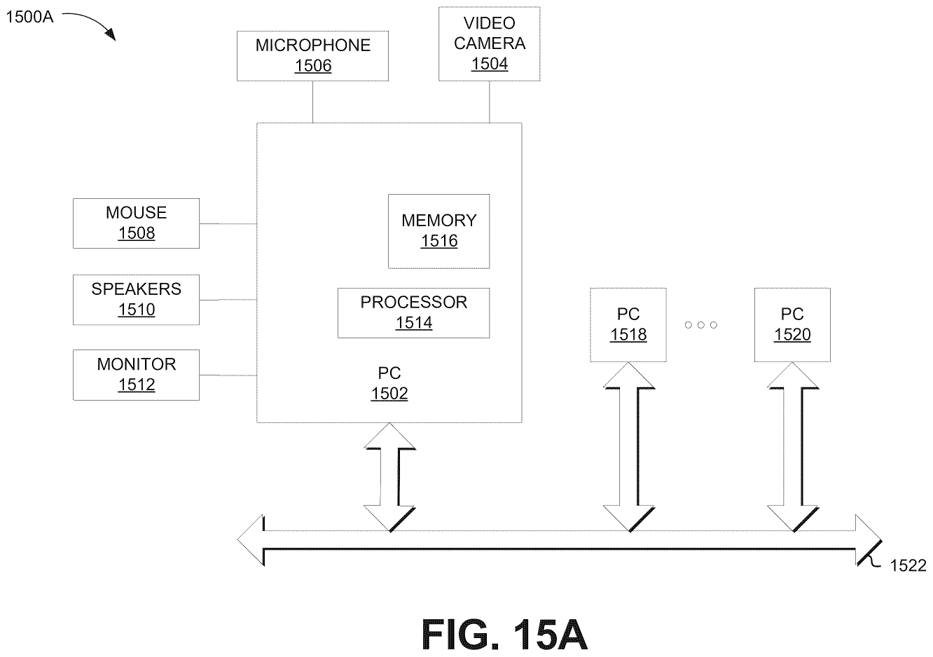

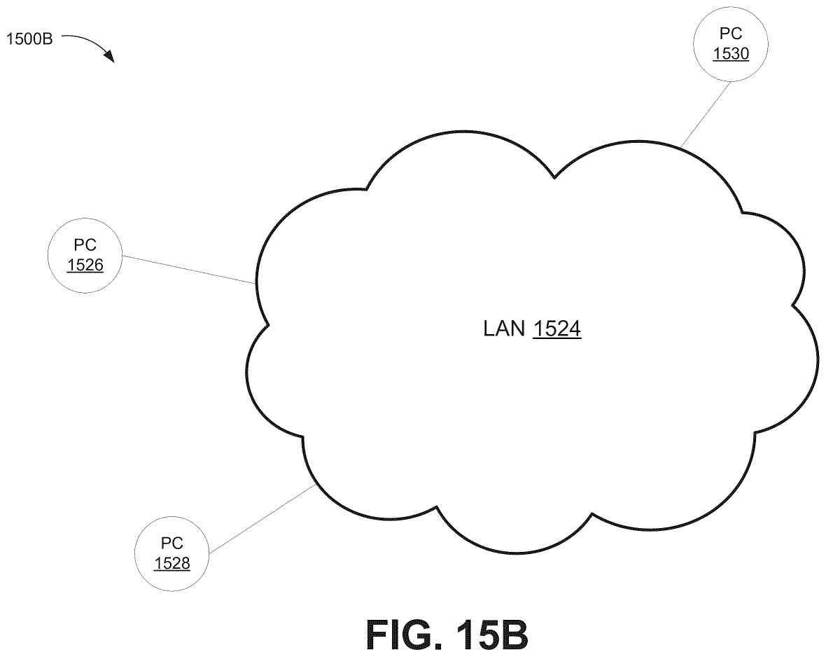

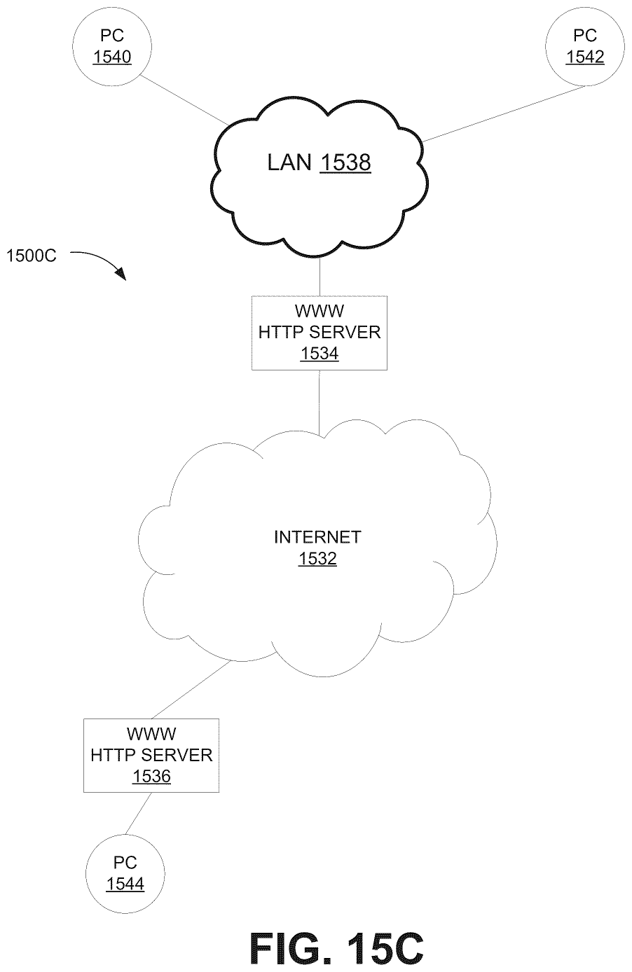

FIG. 15A illustrates a networked computer system 1500A, in accordance with at least some embodiments. In at least one embodiment, networked computer system 1500A comprises a plurality of personal computers (“PCs”) or nodes 1502, 1518, 1520. In at least one embodiment, personal computer or node 1502 comprises a processor 1514, memory 1516, video camera 1504, microphone 1506, mouse 1508, speakers 1510, and monitor 1512. In at least one embodiment, nodes 1502, 1518, 1520 may each run one or more desktop servers of an internal network within a given company, for instance, or may be servers of a general network not limited to a specific environment. In at least one embodiment, there is one server per PC node of a network, so that each PC node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 1502, 1518, 1520 and other nodes of a network are interconnected via medium 1522. In at least one embodiment, medium 1522 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of an URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 1514 is a general-purpose programmable processor. In at least one embodiment, processors of nodes of networked computer system 1500A may also be special-purpose video processors. In at least one embodiment, various peripherals and components of a node such as those of node 1502 may vary from those of other nodes. In at least one embodiment, node 1518 and node 1520 may be configured identically to or differently than node 1502. In at least one embodiment, a node may be implemented on any suitable computer system in addition to PC systems.

FIG. 15B illustrates a networked computer system 1500B, in accordance with at least some embodiments. In at least one embodiment, system 1500B illustrates a network such as LAN 1524, which may be used to interconnect a variety of nodes that may communicate with each other. In at least one embodiment, attached to LAN 1524 are a plurality of nodes such as PC nodes 1526, 1528, 1530. In at least one embodiment, a node may also be connected to the LAN via a network server or other means. In at least one embodiment, system 1500B comprises other types of nodes or elements, for example including routers, servers, and nodes.

FIG. 15C illustrates a networked computer system 1500C, in accordance with at least some embodiments. In at least one embodiment, system 1500C illustrates a WWW system having communications across a backbone communications network such as Network 1532, which may be used to interconnect a variety of nodes of a network. In at least one embodiment, WWW is a set of protocols operating on top of the Internet, and allows a graphical interface system to operate thereon for accessing information through the Internet. In at least one embodiment, attached to Network 1532 in WWW are a plurality of nodes such as PCs 1540, 1542, 1544. In at least one embodiment, a node is interfaced to other nodes of WWW through a WWW HTTP server such as servers 1534, 1536. In at least one embodiment, PC 1544 may be a PC forming a node of network 1532 and itself running its server 1536, although PC 1544 and server 1536 are illustrated separately in FIG. 15C for illustrative purposes.

In at least one embodiment, WWW is a distributed type of application, characterized by WWW HTTP, WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 1538 as illustrated with respect to WWW HTTP server 1534. In at least one embodiment, system 1500C may also comprise other types of nodes or elements. In at least one embodiment, a WWW HTTP server is an application running on a machine, such as a PC. In at least one embodiment, each user may be considered to have a unique “server,” as illustrated with respect to PC 1544. In at least one embodiment, a server may be considered to be a server such as WWW HTTP server 1534, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

### Computer Networks

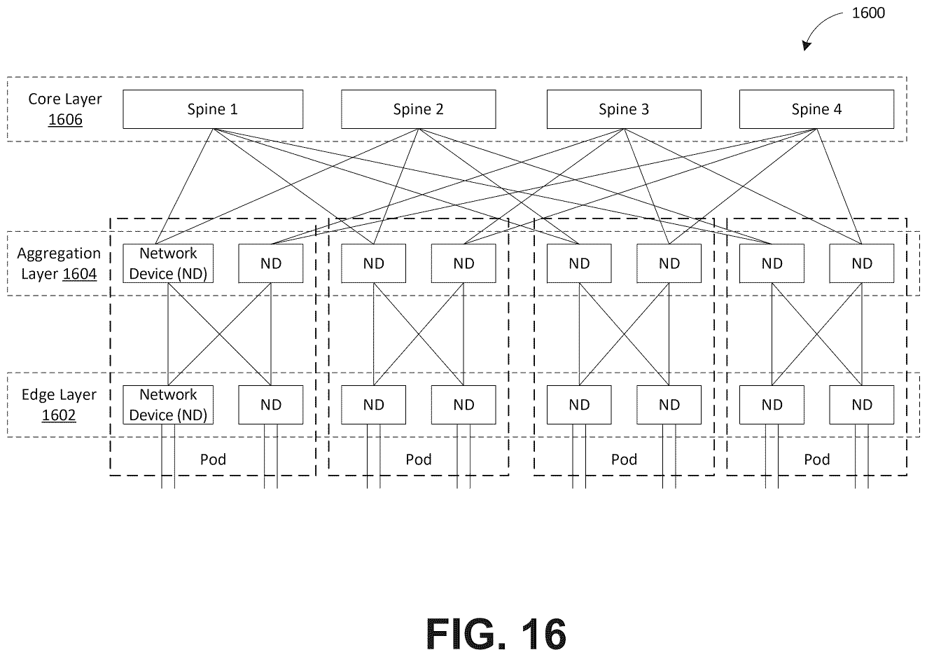

FIG. 16 illustrates a fat tree topology 1600 for a datacenter, according to some aspects of the disclosure. However, it is to be understood that the present disclosure is not limited to a fat tree topology. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure. In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links using active optical cables and optical transceivers implemented in a pluggable form factor (also referred to as “pluggables”).

As shown in FIG. 16, the fat tree topology may include three distinct layers: the edge layer 1602, the aggregation layer 1604, and the core layer 1606. The edge layer 1602, located at the bottom of the hierarchy, incorporates Top-of-Rack (ToR) network devices, such as network switches. In an alternative embodiment, the edge layer can incorporate an End-of-Row (EoR) or Middle-of-Row (MoR) network devices, such as network switches. The edge layer 1602 may serve as the initial point of aggregation for traffic originating from the servers. The servers and server racks are generally connected to the edge layer 1602, although they are not illustrated in the figure. The edge layer 1602 may include multiple network devices, designated as ELS1, ELS2, ..., ELSn, as shown in FIG. 16. In some embodiments, the network devices in the edge layer are network switches, such as electrical network switches. The aggregation layer 1604 may be positioned above the edge layer 1602 and may further consolidate traffic from multiple edge layer network devices ELS1, ELS2, ..., ELSn. The aggregation layer 1604 may be composed of network devices ALS1, ALS2, ..., ALSo. In some embodiments, the network devices of the aggregation layer 1604 are network switches, such as optical network switches. The aggregation layer devices may be configured to aggregate data traffic from the edge layer 1602, ensuring efficient load balancing and data flow management. At the top of the hierarchy is the core layer 1606, which may provide high-speed interconnectivity and enables communication among different racks within the datacenter. The core layer 1606 may include a series of network devices labeled as CLS1, CLS2, ..., CLSm. These core layer network devices (e.g., network switches) may be configured to ensure that data can traverse the network quickly and efficiently, minimizing latency and maximizing bandwidth.

As described herein, a high-capacity optical switch assemblies switch multiple channels of data at high data rates, with the number of channels reaching several hundreds and data rates reaching hundreds of Gb/s (Gb/s=10⁹ bits per second). In order to save power, it is desirable to co-package the switch itself with “optical engines,” which typically are small, high-density optical transceivers located within an application-specific integrated circuit (ASIC) or within an ASIC package together with the switch. The switch assembly is contained in a rack-mounted case, with optical receptacles on its front panel for ease of access. The signals from and to the ASIC are conveyed to and from the optical receptacles using optical fibers.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

Optical switches are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in the most common datacenter interconnection topologies, e.g., fat trees, Slim Fly, and Dragonfly+).

An optical switch may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. An optical switch may include one or more devices for amplifying light in order to compensate for propagation and scattering losses introduced by the optical switch. In at least one example embodiment, signals input and output to an ASIC are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch may include electrical to optical to electrical conversion hardware and/or software if desired (e.g., if the input signal and/or output signal is an electrical signal).

In some embodiments, the optical switch(es) may include an arrayed waveguide grating router (AWGR), which is a passive switch fabric. In some embodiments, the optical switch(es) may correspond to a passive element that operates as a wavelength router that uses multiple wavelengths to interconnect outputs and inputs by following a specific cyclic wavelength routing pattern.

In alternative embodiments, an optical switch may function by directly routing optical signals without converting them to electrical signals. Each optical switch may include optical receivers, such as photodetectors and wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths. The optical switch may also include optical transmitters, such as laser diodes and modulators, which transmit the routed optical signals to the next switch in the network. A hybrid electro-optical switch (e.g., a “pod” as illustrated in FIG. 16) may combine both electrical and optical components to route signals. Such a switch may include receivers that convert optical signals into electrical signals using TIAs and photodetectors, similar to those in electrical switches. These electrical signals can then be routed within the switch using internal electrical switching circuitry. Additionally, the hybrid switch may contain optical switching components, such as WDM multiplexers and MEMS devices, to route optical signals directly. The transmitters in a hybrid switch may include both electrical-to-optical converters and direct optical transmitters, enabling the hybrid switch to interface with both electrical and optical networks. For example, a hybrid switch's transmitter may include a light source, a modulator for optical signals, and traditional electrical signal transmitters, providing routing capabilities across different signal domains.

The interconnections between the switches within the network topology 1600 may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication. FIG. 16 illustrates a computer network topology that may be used in a data center. The illustrated computer network shows a multi-root tree topology, but it should be understood that other types of network topology are also contemplated, including fat tree and DCell network topologies.

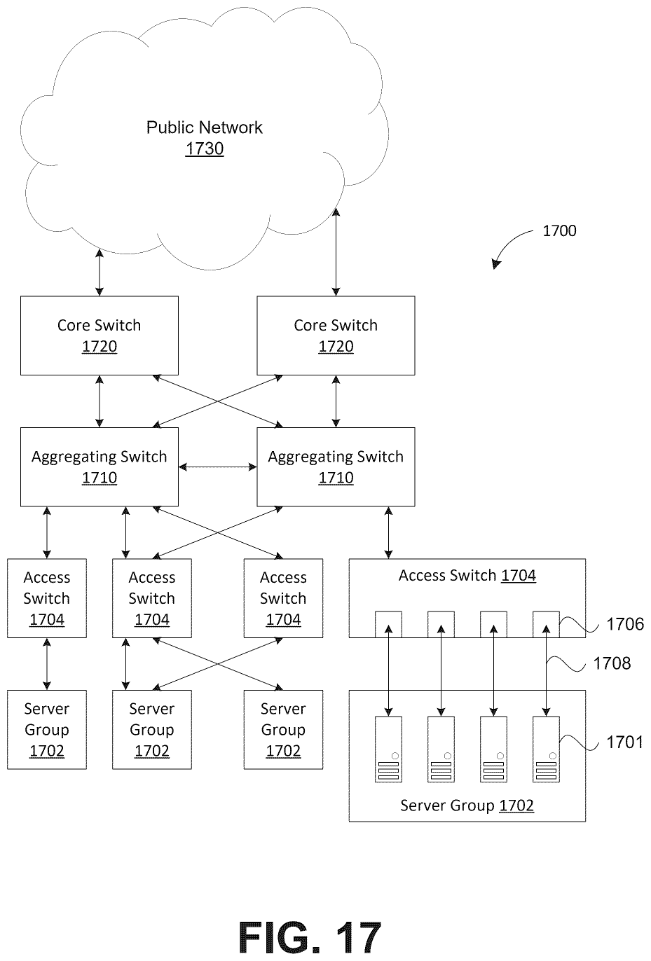

FIG. 17 illustrates an example datacenter 1700, according to some aspects of the disclosure. In a datacenter that includes a variety of computing resources, there may be a number of distinct servers that perform data processing workloads. For example, the data center may include a number of racks, and each rack may include a number of distinct servers 1701. Each server 1701 may have a connection to a data center network, which may provide communication links between the servers 1701 and between individual servers 1701 and a central coordinating server. The servers 1701 may be organized into server groups 1702, for example with all of the servers in a single rack being in a single group. Any appropriate grouping of servers 1701 may be used.

Each of the server groups 1702 may be connected to the data center network by an access switch 1704. The access switch 1704 includes ports 1706, by which a physical medium 1708 connects respective servers 1701 to the access switch 1704. The physical medium 1708 may be any appropriate medium, such as twisted pair cables, coaxial cables, and optical fiber cables. The physical media 1708 provide bidirectional communications, so that the servers 1702 can send data to, and receive data from, the access switch 1704. Any appropriate number of servers 1701 may connect to a single access switch 1704, limited by the number of physical ports 1706 that the access switch 1704. Additionally, individual servers 1701 may be connected to multiple access switches 1704 for redundancy.

In at least some embodiments, the access switches 1704 may receive information on any of its physical ports 1706 and may direct that information to one or more of its physical ports 1706 in accordance with an intended destination of that information. For example, a first server in the network may transmit data intended for a second server in the network, with both the first server and the second server being connected by a physical medium 1708 to a same access switch 1704. The access switch 1704 may identify the destination for the data and may transmit that data on the physical medium 1708 corresponding to the second server, without retransmitting the data to other servers that may be connected to the access switch 1704.

Multiple access switches 1704 may, in turn, be connected to aggregating switches 1710 on an aggregating layer of the network topology. The aggregating switches 1710 may have a similar structure to the access switches 1704, with physical media connecting a port 1706 of each access switch 1704 to a port of a respective aggregating switch 1710. In at least some embodiments, the aggregating switches 1710 may connect to one another as well. Additionally, multiple access switches 1704 may be connected to multiple aggregating switches 1710 for redundancy.

During operation, the aggregating switches 1710 may transmit information between different access switches 1704. For example, if a first server 1701 is connected to a first access switch 1704 and transmits information that is destined for a second server 1701 on a second access switch 1704, then the first access switch may transmit the information to an aggregating switch 1710 that is connected to both access switches 1704. The second access switch 1704 then identifies the port belonging to the second server 1701 and transmits the information to its destination.

In at least some embodiments, the access switches 1704 and the aggregating switches 1710 establish a hierarchical structure that provides network connectivity to all of the servers 1701 within a data center. In at least some embodiments, a layer of core switches 1720 may be used to provide an interface between the data center network and a public network 1730. The core switches 1720 may operate as switches that connect the aggregating switches 1710 to one another and may also route information to and from the Internet.

Each of the switches described herein, including the access switches 1704, the aggregating switches 1710, and the core switches 1720, may be managed switches. A managed switch provides the network administrator with tools to control the operation of the switch, including changing the settings of individual ports 1706. For example, the administrator may use the managed switch to control quality of service settings by ensuring that certain ports have access to a specified amount of bandwidth. In another example, the administrator may configure ports to provide link aggregation, whereby a single device may connect to a switch by multiple ports 1706 to multiply its bandwidth.

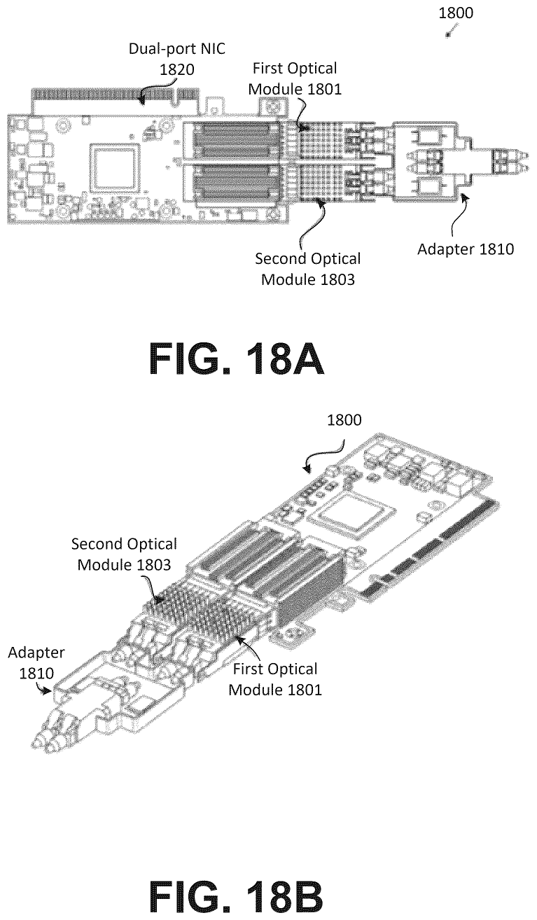

FIG. 18A and FIG. 18B illustrate a top view and a perspective view, respectively, of a transceiver module operatively coupled to a network adapter, in the present example a Network Interface Controller (NIC), according to some aspects of the disclosure. As shown in FIG. 18A and FIG. 18B, the transceiver module 1800 may include a first optical module 1801, a second optical module 1803, an adapter 1810, and a dual-port NIC 1820 of a server. Both the first optical module 1801 and the second optical module 1803 may be dual-fiber transceivers that are configured for duplex communication that allows the source (e.g., server) to communicate with the target (e.g., leaf switch) in both directions. The adapter 1810 may be a ganged physical component configured to link the first optical module 1801 and the second optical module 1803 for the purpose of transmitting and receiving data to and from the leaf switch.

In some embodiments, the adapter 1810 may be configured to operate in two configurations, such as a first configuration and a second configuration. In one aspect, the first configuration may be a default configuration of operation, where the first optical module 1801 may be operationally active. The second configuration may be a contingent configuration that is implemented when the first optical module 1801 operationally fails. When such a failure is detected, the second optical module 1803, which is otherwise operationally inactive or idle, may be engaged become operationally active and handle all network traffic that was initially handled by the first optical module 1801.

In Some embodiments, the transceiver module 1800 may be configured to operate in a leaf-spine architecture. A leaf-spine architecture is a data center network topology that may include two switching layers—a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic. As such, in one embodiment, to ensure reliable operation of downlinks, the transceiver module 1800 may be configured to operate between the server and the leaf layer. In particular, as shown in FIG. 18A and FIG. 18B, the adapter 1810 may be operatively coupled to the first optical module 1801 and the second optical module 1803, while the first optical module 1801 and the second optical module 1803 may be operatively coupled to a dual-port NIC 1820 of a server.

In embodiments, transceiver module 1800 may comprise one or more processing circuits, as detailed above; the processing circuits may comprise FW, that is loaded according to the techniques described above.

### Systems

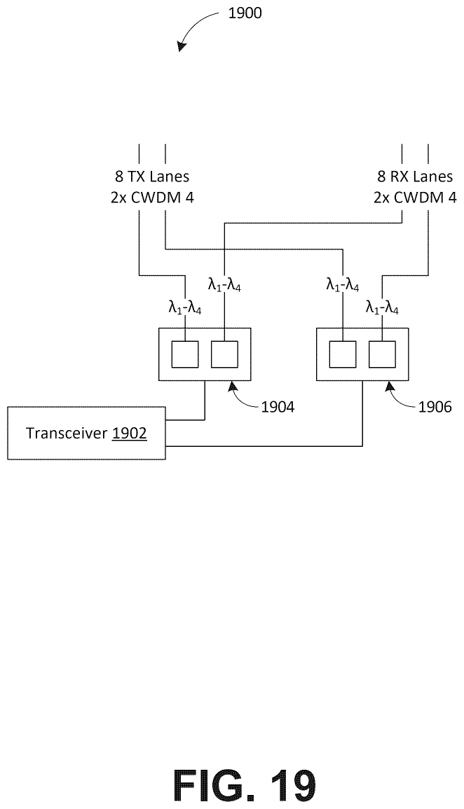

FIG. 19 is an example of a standard fiber connection configuration 1900 including a 2×FR4 (forward reach 4) type transceiver. The standard fiber connection configuration 1900 includes a transceiver 1902 with two FR4 interfaces 1904, 1906. Two fiber pairs are used for the FR4 interface 1904, 1906. That is, one fiber pair is used for the FR4 interface 1904 and another fiber pair is used for the FR4 interface 1906. Each FR4 interface 1904, 1906 of the transceiver 1902 uses 1 transmitter (TX) and 1 receiver (RX) fiber. Each TX fiber and each RX fiber can each carry four wavelengths (e.g., λ₁-λ₄ as a multiplexed signal). Thus, two FR4 interfaces 1904, 1906 together can transmit eight wavelengths and receive eight wavelengths.

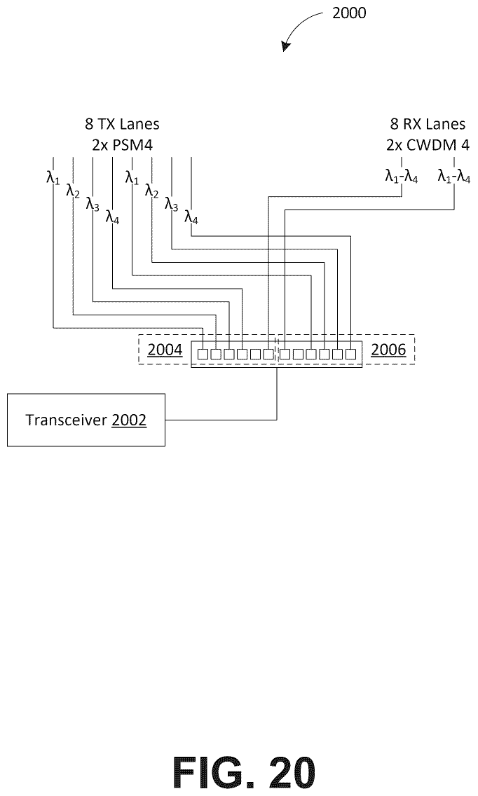

FIG. 20 is an example of a custom fiber connection configuration 2000 including a custom transceiver, according to some aspects of the disclosure. The custom fiber connection configuration 2000 includes a transceiver 2002 with two sets of parallel fiber interfaces 2004, 2006. Each parallel fiber interface 2004, 2006 includes four parallel TX fibers and one RX fiber (e.g., five fibers for each fiber interface). In the illustrated example, the parallel fiber interfaces 2004, 2006 are included in the same fiber port (e.g., optical connector). In alternative embodiments, the parallel fiber interfaces 2004, 2006 can each be included in separate fiber ports. Each of the four parallel TX fibers can carry a single wavelength. In some embodiments, the two sets of four parallel TX fibers can be in a platform-specific module 4 (PSM4) configuration (e.g., a 2×PSM4 configuration, as illustrated). In some embodiments, each of the four parallel TX fibers can carry multiple wavelengths as a wavelength super channel. The one RX fiber can carry four wavelengths. In some embodiments, the four wavelengths carried by the RX fiber can be multiplexed. In some embodiments, the four TX fibers and/or the one RX fiber can connect to the transceiver 2002 using a multi-fiber connector, such a multi-fiber push on (MPO) connector, or a mechanical transfer push on (MTP) connector. In some embodiments, the transceiver 2002 can be the same as the transceiver 400 described above with reference to FIG. 4.

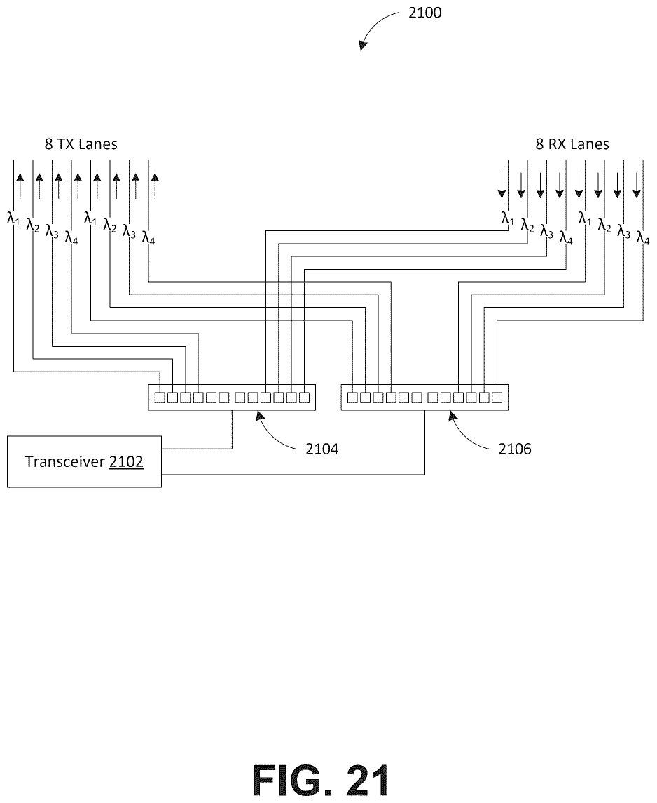

FIG. 21 is an example of a custom fiber connection configuration 2100 including a custom transceiver, according to some aspects of the disclosure. The custom fiber connection configuration 2100 includes a transceiver 2102 with two sets of parallel fiber interfaces 2104, 2106. In the illustrated example, each parallel fiber interface 2104 is included in a respective fiber port. In alternative embodiments, the parallel fiber interfaces 2104, 2106 can be included in the same fiber port. Each parallel fiber interface 2104, 2106 can include four TX fibers and four RX fibers, for a total of eight TX fibers and eight RX fibers across the two parallel fiber interfaces 2104, 2106. Each of the TX fibers or RX fibers can carry a single wavelength. In some embodiments, each of the TX fibers or RX fibers can carry multiple wavelengths as a wavelength super channel. In some embodiments, the four TX fibers and/or the four RX fiber can connect to the transceiver 2102 using a multi-fiber connector, such a multi-fiber push on (MPO) connector, or a mechanical transfer push on (MTP) connector. In some embodiments, the transceiver 2102 can be the same as the transceiver 500 described above with reference to FIG. 5.

In some embodiments, the transmission lanes (e.g., the TX fibers) can each carry multiple sets of wavelengths (e.g., two sets of λ₁-λ₄ as illustrated). In some embodiments, the receiver lanes (e.g., the RX fibers) can carry multiple sets of wavelengths (e.g., two sets of λ₁-λ₄ as illustrated).

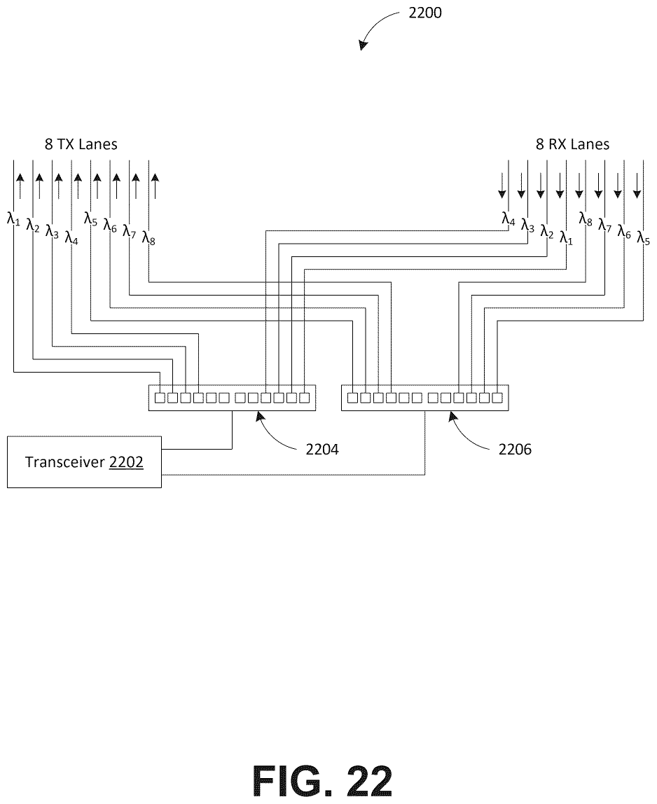

FIG. 22 is an example of a custom fiber connection configuration 2200 including a custom transceiver, according to some aspects of the disclosure. The custom fiber connection configuration 2200 includes a transceiver 2202 with two sets of parallel fiber interfaces 2204, 2206. In the illustrated example, each parallel fiber interface 2204 is included in a respective fiber port. In alternative embodiments, the parallel fiber interfaces 2204, 2206 can be included in the same fiber port. Each parallel fiber interface 2204, 2206 can include four TX fibers and four RX fibers, for a total of eight TX fibers and eight RX fibers across the two parallel fiber interfaces 2204, 2206. Each of the TX fibers or RX fibers can carry a single wavelength. In some embodiments, each of the TX fibers or RX fibers can carry multiple wavelengths as a wavelength super channel. In some embodiments, the four TX fibers and/or the four RX fiber can connect to the transceiver 2202 using a multi-fiber connector, such a multi-fiber push on (MPO) connector, or a mechanical transfer push on (MTP) connector. In some embodiments, the transceiver 2202 can be the same as the transceiver 500 described above with reference to FIG. 5.

In some embodiments, the transmitter lanes (e.g., the TX fibers) can each carry distinct wavelengths (e.g., λ₁-λ₈ as illustrated). In some embodiments, the receiver lanes (e.g., the RX fibers) can carry multiple sets of wavelengths (e.g., λ₁-λ₈ as illustrated).

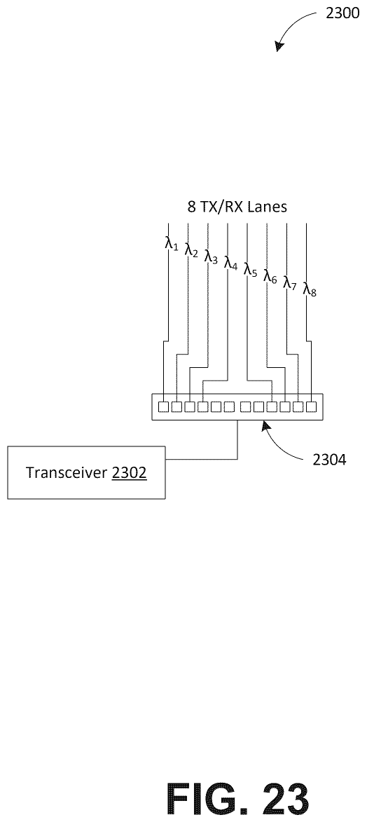

FIG. 23 is an example of a custom fiber connection configuration 2300 including a custom transceiver, according to some aspects of the disclosure. The custom fiber connection configuration 2300 includes a transceiver 2302 with a parallel fiber interface 2304. In the illustrated example, the parallel fiber interface 2304 is included in a respective fiber port. In alternative embodiments, the parallel fiber interfaces 2304 can be included in the same fiber port. The parallel fiber interface 2304 can include eight TX/RX fibers. In some embodiments, the TX/RX lanes (e.g., the TX/RX fibers) can each carry distinct wavelengths (e.g., λ₁-λ₈ as illustrated). In some embodiments, each of the TX/RX fibers can carry multiple wavelengths as a wavelength super channel. In some embodiments, the TX/RX fibers connect to the transceiver 2302 using a multi-fiber connector, such a multi-fiber push on (MPO) connector, or a mechanical transfer push on (MTP) connector. In some embodiments, the transceiver 2302 can include an optical circulator, which allows for the same optical fibers to be used as TX fibers and RX fibers. For example, the transceiver 2302 can be a Bidi Transceiver developed and implemented by Google® for use in the Lightwave Fabrics technology. In such embodiments, bidirectional communication can be achieved through the optical shuffle box (e.g., the optical shuffle box 330 of FIGS. 3A-3G). The multiplexers of the optical shuffle box can operate bidirectionally to either multiplex or demultiplex optical signals based on the input port, as described above. In some embodiments, the transceiver 2302 is a bi-directional optical transceiver.

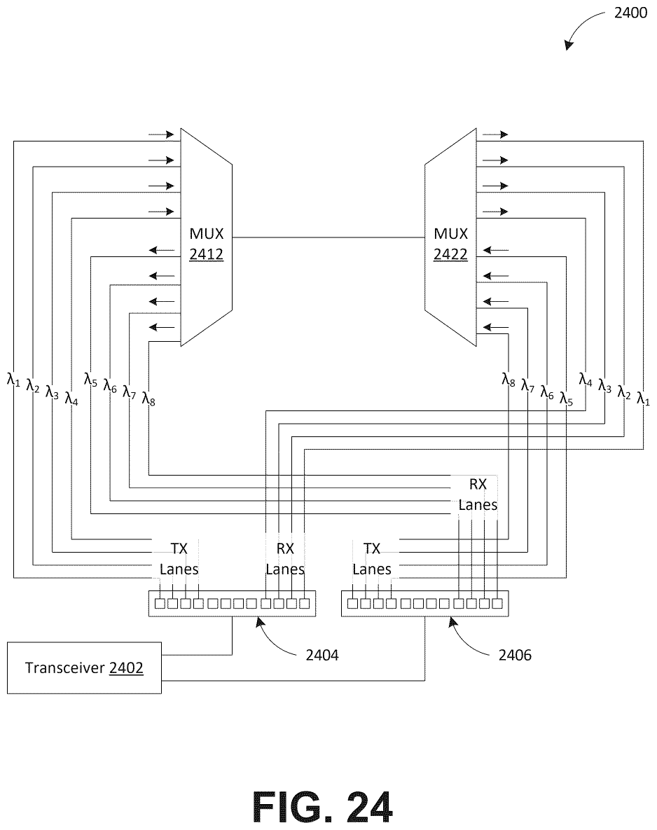

FIG. 24 is an example of a custom fiber connection configuration 2400 including a custom transceiver, according to some aspects of the disclosure. The custom fiber connection configuration 2400 includes a transceiver 2402 with two sets of parallel fiber interfaces 2404, 2406. In the illustrated example, each parallel fiber interface 2404 is included in a respective fiber port (e.g., optical connector). In alternative embodiments, the parallel fiber interfaces 2404, 2406 can be included in the same fiber port. Each parallel fiber interface 2404, 2406 can include four TX fibers (e.g., four optical ports for TX) and four RX fibers (e.g., four optical ports for RX), for a total of eight TX fibers and eight RX fibers across the two parallel fiber interfaces 2404, 2406 (e.g., eight optical ports for each of TX and RX to transmit eight optical data signals). Each of the TX fibers or RX fibers can carry a single wavelength. In some embodiments, each of the TX fibers or RX fibers can carry multiple wavelengths as a wavelength super channel. In some embodiments, the four TX fibers and/or the four RX fiber can connect to the transceiver 2402 using a multi-fiber connector, such a multi-fiber push on (MPO) connector, or a mechanical transfer push on (MTP) connector. In some embodiments, the transceiver 2402 can be the same as the transceiver 500 described above with reference to FIG. 5.

In some embodiments, the transmitter lanes (e.g., the TX fibers) can each carry distinct wavelengths (e.g., λ₁-λ₈ as illustrated). In some embodiments, the receiver lanes (e.g., the RX fibers) can carry multiple sets of wavelengths (e.g., two sets of λ₁-λ₄ as illustrated).

The multiplexer 2412 can multiplex transmit lanes from the fiber interface 2404 and receiver lanes from the fiber interface 2406. In some embodiments, the optical signals input to the multiplexer 2412 an all be distinct. For example, and as illustrated, the multiplexer 2412 can multiplex transmit lanes (e.g., transmitted optical signals) from the fiber interface 2404, with each transmit lane corresponding to a different wavelength, such as λ₁-λ₄. The multiplexer can demultiplex receive lanes (e.g., from a received multiplexed optical signal) that are sent to the fiber interface 2406, with each receiver lane corresponding to a different wavelength, such as λ₅-λ₈. In some embodiments, and as illustrated, the wavelengths that are multiplexed and/or demultiplexed by the multiplexer 2412 can all be distinct (e.g., λ₁-λ₈, where λ₁-λ₄ are multiplexed for transmission and λ₅-λ₈ are demultiplexed from a multiplexed optical signal). The multiplexer 2422 can similarly multiplex transmit lanes from the fiber interface 2406 and receiver lanes from the fiber interface 2404.

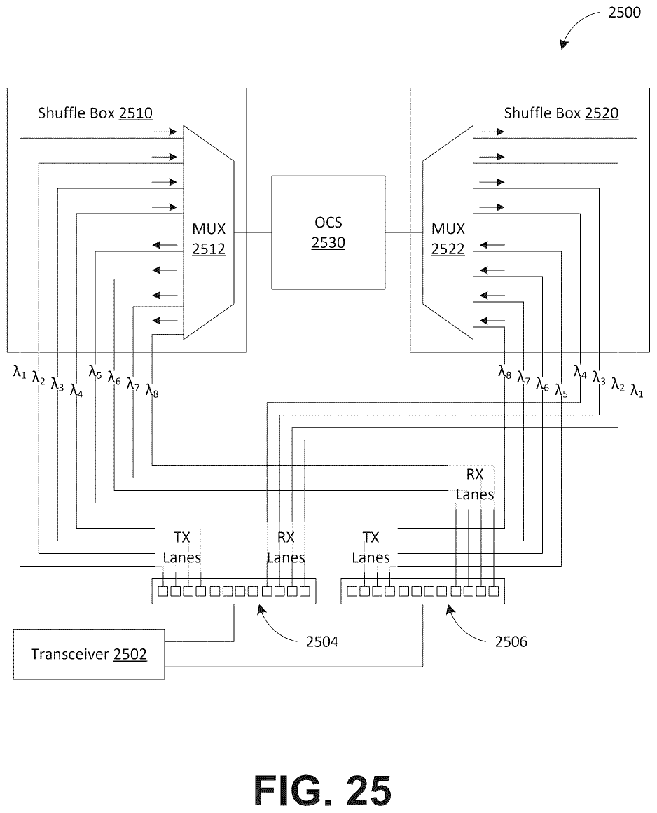

In some embodiments, the multiplexers 2412, 2422 can each receive and/or output a multiplexed optical signal. As illustrated and in some embodiments, the multiplexed optical signal input/output of the multiplexer 2412 and the multiplexed optical signal input/output of the multiplexer 2422 can be connected. In some embodiments, each multiplexer can be a part of a respective optical shuffle box (as illustrated in FIG. 25).

In operation, the transceiver 2402 can send a subset of TX signals to the multiplexer 2412 (e.g., with wavelengths λ₁-λ₄) and another subset of TX signals to the multiplexer 2422 (e.g., with wavelengths λ₅-λ₈). Each subset of TX signals can be multiplexed into a respective multiplexed optical signal, which can be sent between the multiplexers 2412, 2422.

The transceiver 2402 can receive a subset of RX signals from the multiplexer 2412 (e.g., with wavelengths λ₁-λ₄) at the fiber interface 2404 and another subset of RX signals from the multiplexer 2422 (e.g., with wavelengths λ₅-λ₈) at the fiber interface 2406.

FIG. 25 is an example of a custom fiber connection configuration 2500 including a custom transceiver, according to some aspects of the disclosure. The custom fiber connection configuration 2500 includes a transceiver 2502 with two sets of parallel fiber interfaces 2504, 2506. In the illustrated example, each parallel fiber interface 2504 is included in a respective fiber port. In alternative embodiments, the parallel fiber interfaces 2504, 2506 can be included in the same fiber port. Each parallel fiber interface 2504, 2506 can include four TX fibers and four RX fibers, for a total of eight TX fibers and eight RX fibers across the two parallel fiber interfaces 2504, 2506. Each of the TX fibers or RX fibers can carry a single wavelength. In some embodiments, each of the TX fibers or RX fibers can carry multiple wavelengths as a wavelength super channel. In some embodiments, the four TX fibers and/or the four RX fiber can connect to the transceiver 2502 using a multi-fiber connector, such a multi-fiber push on (MPO) connector, or a mechanical transfer push on (MTP) connector. In some embodiments, the transceiver 2502 can be the same as the transceiver 500 described above with reference to FIG. 5.

In some embodiments, the transmitter lanes (e.g., the TX fibers) can each carry distinct wavelengths (e.g., λ₁-λ₈ as illustrated). In some embodiments, the receiver lanes (e.g., the RX fibers) can carry multiple sets of wavelengths (e.g., two sets of λ₁-λ₄ as illustrated).

In some embodiments, the transmitter lanes can be optically coupled into the shuffle box 2510. Similarly, the receiver lanes can be optically coupled into the shuffle box 2520. The shuffle boxes 2510, 2520 can be the same as the shuffle boxes 330 as described herein with reference to FIGS. 3A-3G. Each shuffle box can include a respective multiplexer (also referred to herein as “MUX”), here illustrated as multiplexers 2512, 2522 respectively. The multiplexer 2512 of the shuffle box 2510 can multiplex the transmitter lanes to a single output that is coupled to an optical switch 2530. Similarly, the multiplexer 2522 of the shuffle box 2520 can multiplex the receiver lanes into a single output that is coupled to the optical switch 2530. In some embodiments, the multiplexers 2512, 2522 can be coupled to the optical switch 2530 by multiple fibers (not illustrated).

In operation, the transceiver 2502 can send signals via the TX lanes to the shuffle box 2510. These are multiplexed into a single optical fiber that is connected to the optical switch 2530. The optical switch 2530 performs switching operations and outputs to the multiplexer 2522 of shuffle box 2520. The multiplexer 2522 extracts (e.g., demultiplexes) multiple wavelengths from the input optical fibers (i.e., from the optical switch 2530) which are represented here as the RX lanes coupled to the parallel fiber interface 2506. In this way, the transceiver 2502 functions bidirectionally. In some embodiments, as illustrated, the fiber interface 2504 can transmit a subset of optical signals with a first set of wavelengths (e.g., wavelengths λ₁-λ₄) with a subset of optical ports and receive a subset of optical signals (e.g., wavelengths λ₁-λ₄) with another subset of optical ports. The fiber interface 2506 can similarly transmit a subset of optical signals with a second set of wavelengths (e.g., wavelengths λ₅-λ₈) with a subset of optical ports and receive a subset of optical signals (e.g., wavelengths λ₅-λ₈) with another subset of optical ports.

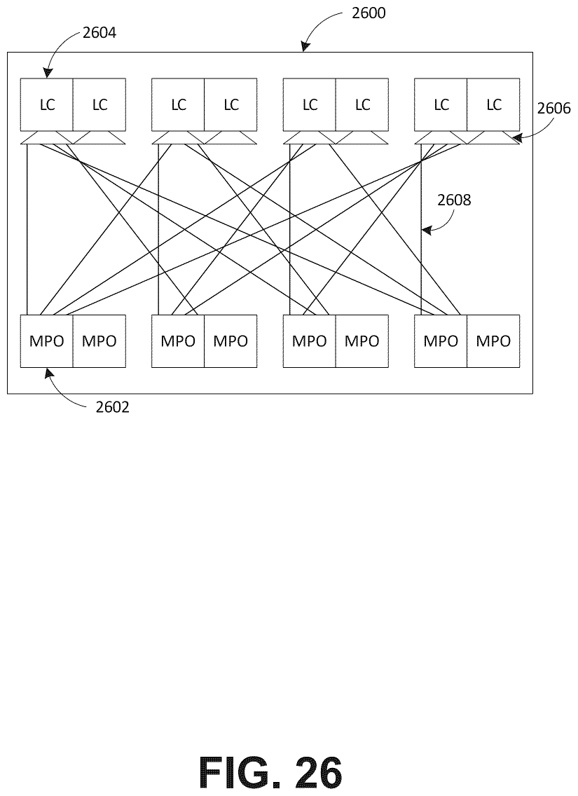

FIG. 26 illustrates an example of an optical shuffle box 2600 according to some aspects of the disclosure. The optical shuffle box 2600 includes optical input/output (I/O) ports 2602 connected by optical routing components 2608 to the optical I/O ports 2604 via multiplexers 2606. As illustrated, the optical I/O ports 2602 can be multi-fiber push on (MPO) connector ports, and the optical I/O ports 2604 can be lucent connector (LC) ports. It can be appreciated that other physical connector ports are also considered, and these specific ports are used only illustratively. In some embodiments, the optical routing components 2608 are optical fibers. In some embodiments, the optical shuffle box 2600 can be the same as or similar to the optical shuffle boxes 330 described above with reference to FIGS. 3A-G.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a”and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal. The use of terms such as “first,” “second,” “third,” “fourth,” “fifth,” “sixth,” “seventh,” “eighth,” “ninth,” etc., are not intended to designate a particular order, unless specified.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some embodiments, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some embodiments, code is stored on a computer-readable storage medium, for example, in form of a computer program comprising a plurality of instructions executable by one or more processors. In some embodiments, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some embodiments, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some embodiments, comprises multiple non-transitory computer-readable storage media and one or more of individual non-transitory storage media of multiple non-transitory computer-readable storage media lacks all of the code while multiple non-transitory computer-readable storage media collectively store all of the code. In some embodiments, executable instructions are executed such that different instructions are executed by different processors -for example, a non-transitory computer-readable storage medium stores instructions, and a main central processing unit (CPU) executes some of the instructions while a graphics processing unit (GPU) executes other instructions. In some embodiments, different components of a computer system have separate processors, and different processors execute different subsets of instructions.

Accordingly, in some embodiments, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A device comprising:
a plurality of optical input ports to receive a plurality of optical data signals via a respective plurality of optical fibers, each optical data signal of the plurality of optical data signals having a distinct wavelength;
a plurality of optical routing components that connect the plurality of optical input ports to a plurality of wavelength multiplexers, wherein the plurality of optical routing components are to distribute the plurality of optical data signals to the plurality of wavelength multiplexers, wherein each multiplexer of the plurality of wavelength multiplexers is to receive an optical data signal originating from each of a first plurality of network elements;
the plurality of wavelength multiplexers, wherein each multiplexer of the plurality of wavelength multiplexers is to combine optical data signals received by the multiplexer into a multiplexed optical data signal, wherein a plurality of multiplexed optical data signals are to be generated; and
a plurality of optical output ports, each connected to a multiplexer of the plurality of wavelength multiplexers, to send a multiplexed optical data signal of the plurality of multiplexed optical data signals to a respective network element of a second plurality of network elements.

2. The device of claim 1, wherein the device is an optical shuffle box.

3. The device of claim 1, wherein the plurality of optical data signals are not multiplexed.

4. The device of claim 1, further comprising:
a second plurality of optical input ports to receive a respective second plurality of optical data signals, each optical data signal of the second plurality of optical data signals having a distinct wavelength;
a second plurality of optical routing components that connect the second plurality of optical input ports to a second plurality of multiplexers, wherein the second plurality of optical routing components are to distribute the second plurality of optical data signals to the second plurality of multiplexers, wherein each multiplexer of the second plurality of multiplexers is to receive an optical data signal originating from each of the second plurality of network elements;
the second plurality of multiplexers, wherein each multiplexer of the second plurality of multiplexers is to combine optical data signals received by the multiplexer into a multiplexed optical data signal, wherein a second plurality of multiplexed optical data signals are to be generated; and
a second plurality of optical output ports, each connected to a multiplexer of the second plurality of multiplexers, to send a multiplexed optical data signal of the second plurality of multiplexed optical data signals to a respective network element of the first plurality of network elements.

5. The device of claim 1, wherein the device is configured to receive a second plurality of multiplexed optical data signals at the plurality of optical output ports, the optical output ports each configured to send the second plurality of multiplexed optical data signals to the plurality of multiplexers, wherein each multiplexer of the plurality of multiplexers is to separate multiplexed optical data signals received at the multiplexer into a second plurality of optical data signals, each optical data signal of the second plurality of optical data signals having a different wavelength; and
the plurality of optical routing components, wherein the plurality of optical routing components are to distribute the second plurality of optical data signals to the plurality of optical input ports, wherein a group of optical input ports corresponding to a respective network element of the first plurality of network elements is to receive optical data signals of the second plurality of optical data signals having distinct wavelengths.

6. A network architecture comprising:
a first network layer comprising a first plurality of network devices;
a second network layer comprising a second plurality of network devices; and
an optical shuffle box that connects the first network layer to the second network layer, the optical shuffle box configured to:
receive, from each network device of the first plurality of network devices, a plurality of optical data signals via a respective plurality of optical fibers, each optical data signal of the plurality of optical data signals having a distinct wavelength;
distribute the plurality of optical data signals received from the plurality of network devices to a plurality of multiplexers of the optical shuffle box, wherein each multiplexer of the plurality of multiplexers is to receive an optical data signal originating from each of the first plurality of network devices;
combine, at each multiplexer of the plurality of multiplexers, optical data signals received by the multiplexer into a multiplexed optical data signal, wherein a plurality of multiplexed optical data signals are to be generated; and
send each multiplexed optical data signal of the plurality of multiplexed optical data signals to a respective network device of the second plurality of network devices.

7. The network architecture of claim 6, wherein the second plurality of network devices comprise a plurality of optical network devices.

8. The network architecture of claim 6, wherein the second plurality of network devices comprise a plurality of electrical network devices.

9. The network architecture of claim 6, wherein the first network layer is a first switching layer, and wherein the second network layer is a second switching layer.

10. The network architecture of claim 6, wherein the second network layer is connected to a third network layer by a second optical shuffle box, the third network layer comprising a third plurality of network devices.

11. The network architecture of claim 6, further comprising:
one or more optical transceivers coupled to each network device of the first plurality of network devices, each optical transceiver of the one or more optical transceivers comprising:
a transmitter to convert a first plurality of electrical data signals into the plurality of optical data signals;
a plurality of optical output ports, each optical output of the plurality of optical output ports to output, to a respective optical fiber of the respective plurality of optical fibers, an optical data signal of the plurality of optical data signals having the distinct wavelength;
an optical input to receive, from the optical shuffle box via a single optical fiber, a second plurality of optical data signals having a plurality of different wavelengths that are multiplexed;
a demultiplexer to separate the second plurality of optical data signals; and
a receiver to convert the separated second plurality of optical data signals into a second plurality of electrical data signals.

12. The network architecture of claim 11, wherein:
the transmitter comprises a plurality of light sources configured to generate the first plurality of optical data signals; and
the receiver comprises a plurality of photodetectors configured to detect the second plurality of optical data signals.

13. The network architecture of claim 6, further comprising:
one or more additional optical transceivers coupled to each network device of the second plurality of network devices, each optical transceiver of the one or more additional optical transceivers comprising:
an optical input to receive, from the optical shuffle box via a single optical fiber, a multiplexed optical data signal of the plurality of multiplexed optical data signals;
a demultiplexer to separate the multiplexed optical data signal into a third plurality of optical data signals;
a receiver to convert the separated third plurality of optical data signals into a third plurality of electrical data signals;
a transmitter to convert a fourth plurality of electrical data signals into a fourth plurality of optical data signals;
a second plurality of optical output ports, each optical output of the second plurality of optical output ports to output, to the optical shuffle box via a respective optical fiber, an optical data signal of the fourth plurality of optical data signals.

14. The network architecture of claim 6, wherein the optical shuffle box comprises:
a plurality of optical input ports to receive a plurality of optical data signals via a respective plurality of optical fibers, each optical data signal of the plurality of optical data signals having a distinct wavelength;
a plurality of optical routing components that connect the plurality of optical input ports to a plurality of multiplexers, wherein the plurality of optical routing components are to distribute the plurality of optical data signals to the plurality of multiplexers, wherein each multiplexer of the plurality of multiplexers is to receive an optical data signal originating from each of a first plurality of network devices;
the plurality of multiplexers, wherein each multiplexer of the plurality of multiplexers is to combine optical data signals received by the multiplexer into a multiplexed optical data signal, wherein a plurality of multiplexed optical data signals are to be generated; and
a plurality of optical output ports, each connected to a multiplexer of the plurality of multiplexers, to send a multiplexed optical data signal of the plurality of multiplexed optical data signals to a respective network device of a second plurality of network devices.

15. The network architecture of claim 14, wherein the optical shuffle box further comprises:
a second plurality of optical input ports to receive a respective second plurality of optical fibers, each optical data signal of the second plurality of optical data signals having a distinct wavelength;
a second plurality of optical routing components that connect the second plurality of optical input ports to a second plurality of multiplexers, wherein the second plurality of optical routing components are to distribute the second plurality of optical data signals to the second plurality of multiplexers, wherein each multiplexer of the second plurality of multiplexers is to receive an optical data signal originating from each of the second plurality of network devices;
the second plurality of multiplexers, wherein each multiplexer of the second plurality of multiplexers is to combine optical data signals received by the multiplexer into a multiplexed optical data signal, wherein a second plurality of multiplexed optical data signals are to be generated; and
a second plurality of optical output ports, each connected to a multiplexer of the second plurality of multiplexers, to send a multiplexed optical data signal of the second plurality of multiplexed optical data signals to a respective network device of the first plurality of network devices.

16. The network architecture of claim 14, wherein the optical shuffle box is configured to receive a second plurality of multiplexed optical data signals at a plurality of optical output ports, the optical output ports each configured to send the second plurality of multiplexed optical data signals to the plurality of multiplexers, wherein each multiplexer of the plurality of multiplexers is to separate multiplexed signals received at the multiplexer into a second plurality of optical data signals, each optical data signal of the second plurality of optical data signals having a different wavelength; and
the plurality of optical routing components, wherein the plurality of optical routing components are to distribute the second plurality of optical data signals to the plurality of optical input ports, wherein a group of optical input ports corresponding to a respective network device of the first plurality of network devices is to receive optical data signals of the second plurality of optical data signals having distinct wavelengths.

17. An optical transceiver comprising:
a transmitter to convert a first plurality of electrical data signals into a first plurality of optical data signals;
a plurality of optical output ports, each optical output of the plurality of optical output ports to output, to a respective optical fiber, an optical data signal of the first plurality of optical data signal having a distinct wavelength;
an optical input to receive, from a single optical fiber, a second plurality of optical data signals having a plurality of different wavelengths that are multiplexed;
a demultiplexer to separate the second plurality of optical data signals; and
a receiver to convert the separated second plurality of optical data signals into a second plurality of electrical data signals.

18. The optical transceiver of claim 17, wherein:
the transmitter comprises a plurality of light sources configured to generate the first plurality of optical data signals; and
the receiver comprises a plurality of photodetectors configured to detect the second plurality of optical data signals.

19. The optical transceiver of claim 17, wherein the plurality of different wavelengths are multiplexed according to wavelength division multiplexing (WDM), and wherein the demultiplexer is to separate the different wavelengths that are multiplexed according to WDM.

20. The optical transceiver of claim 17, wherein a first number of the first plurality of optical data signals generated by the transmitter is greater than a second number of the second plurality of optical data signals received at the optical input.
